(19) United States
(12) Patent Application Publication
(10) Pub. No.: US 2026/0185010 A1
(43) Pub. Date: Jul. 2, 2026

(54) FLUORINE-CONTAINING ETHER COMPOUND, LUBRICANT FOR MAGNETIC RECORDING MEDIUM AND MAGNETIC RECORDING MEDIUM

(71) Applicant: Resonac Corporation, Tokyo (JP)

(72) Inventors: Natsumi YOSHIMURA, Tokyo (JP); Ayano ASANO, Tokyo (JP); Yutaka TANJI, Tokyo (JP); Naoya FUKUMOTO, Tokyo (JP); Tsuyoshi KATO, Tokyo (JP)

(73) Assignee: Resonac Corporation, Tokyo (JP)

(21) Appl. No.: 18/863,796

(22) PCT Filed: May 18, 2023
(86) PCT No.: PCT/JP2023/018594

§ 371 Date: Nov. 7, 2024

(30) Foreign Application Priority Data
May 20, 2022 (JP) 2022-083156

(51) Int. Cl. C10M 107/38; C08G 65/00; C10N 20/04; C10N 40/18; G11B 5/72; G11B 5/725

(52) U.S. Cl. CPC C10M 107/38; C08G 65/007; G11B 5/7257; G11B 5/7266; C10M 2213/0606; C10N 2020/04; C10N 2040/18

(57) ABSTRACT

A fluorine-containing ether compound represented by the following formula R¹—CH₂—R²[—CH₂—R³—CH₂—R²]ₓ—CH₂—R⁴ (R¹ and R⁴ are terminal groups containing two or three polar groups, wherein the polar groups are bonded to different carbon atoms, and carbon atoms to which the polar groups are bonded are bonded via a linking group containing carbon atoms to which no polar group is bonded; x is 1 to 2; R² is a perfluoropolyether chain; R³ is Formula (3-1) or (3-2)).

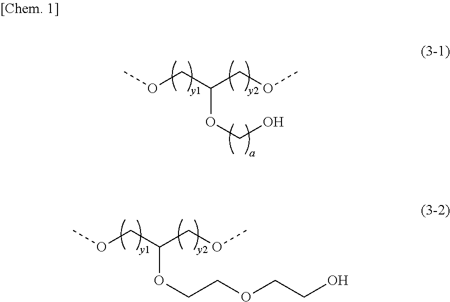

### TECHNICAL FIELD

The present invention relates to a fluorine-containing ether compound, a lubricant for magnetic recording medium and a magnetic recording medium.

Priority is claimed on Japanese Patent Application No, 2022-083156, filed May 20, 2022, the content of which is incorporated herein by reference.

### BACKGROUND ART

The development of magnetic recording media suitable for high recording densities has progressed in order to improve the recording densities of magnetic recording and reproducing devices.

As a conventional magnetic recording medium, there has been a magnetic recording medium in which a recording layer is formed on a substrate and a protective layer made of carbon or the like is formed on the recording layer. The protective layer protects information recorded in the recording layer and enhances the slidability of a magnetic head. In addition, the protective layer covers the recording layer and prevents metals contained in the recording layer from being corroded by environmental substances.

However, sufficient durability of the magnetic recording medium cannot be obtained by simply providing the protective layer on the recording layer. Therefore, a lubricant is applied to the surface of the protective layer to form a lubricating layer having a thickness of about 0.5 to 3 nm. The lubricating layer improves the durability and protective power of the protective layer and prevents contamination substances from intruding into the magnetic recording medium.

As a lubricant used when the lubricating layer of the magnetic recording medium is formed, for example, one containing a compound having a polar group such as a hydroxy group at the terminal of a fluorine-based polymer having a repeating structure including —CF₂— has been proposed.

For example, Patent Document 1, Patent Document 2 and Patent Document 3 disclose a fluorine-containing ether compound which contains two perfluoropolyether chains in the molecule and in which a linking group containing a secondary hydroxy group is arranged between two perfluoroether chains.

Patent Document 4 discloses a fluorine-containing ether compound which contains two perfluoropolyether chains in the molecule and in which a linking group containing a primary hydroxy group and a secondary hydroxy group is arranged between two perfluoroether chains.

Patent Document 5, Patent Document 6 and Patent Document 7 disclose a fluorine-containing ether compound which has a framework in which three perfluoropolyether chains are bonded via a linking group containing a secondary hydroxy group and a terminal group having a polar group is bonded to both sides via a methylene group (—CH₂—).

### CITATION LIST

### Patent Document

Patent Document 1: PCT International Publication No. WO2021/251335
Patent Document 2: U.S. Patent Application Publication No, 2020/0(X)2640
Patent Document 3: PCT International Publication No. WO2016/084781
Patent Document 4: PCT International Publication No. WO2021/019998
Patent Document 5: U.S. Patent Application Publication No, 2016/0260452
Patent Document 6: PCT International Publication No. WO2018/116742
Patent Document 7: KT International Publication No. WO2017/145995

### SUMMARY OF INVENTION

### Technical Problem

There is a demand for a further decrease in a raised amount of a magnetic head in magnetic recording and reproducing devices. This requires a further decrease in the thickness of the protective layer and/or lubricating layer in magnetic recording media. However, when the thickness of the lubricating layer is reduced, the coatability of the lubricating layer deteriorates, and chemical substance resistance and magnetic head flying stability tend to deteriorate. Therefore, there is a demand for a lubricating layer having excellent, chemical substance resistance and favorable magnetic head flying stability even if the thickness is thin.

The present invention has been made in view of the above circumstances, and an object of the present invention is to provide a fluorine-containing ether compound which can form a lubricating layer having excellent chemical substance resistance and favorable magnetic head flying stability even if the thickness is thin, and can be suitably used as a material for a lubricant for magnetic recording medium.

In addition, an object of the present invention is to provide a lubricant for magnetic recording medium which contains the fluorine-containing ether compound of the present invention and can form a lubricating layer having excellent chemical substance resistance and favorable magnetic head flying stability even if the thickness is thin.

In addition, an object of the present invention is to provide a magnetic recording medium which has a lubricating layer containing the fluorine-containing ether compound of the present invention and favorable chemical substance resistance and magnetic head flying stability.

### Solution to Problem

The present invention includes the following aspects.

A first aspect of the present invention provides the following fluorine-containing ether compound.

A fluorine-containing ether compound represented by the following Formula (1):

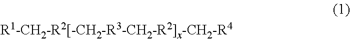

(in Formula (1), R¹ and R⁴ are each independently a terminal group containing two or three polar groups, wherein the polar groups are bonded to different carbon atoms, and carbon atoms to which the polar groups are bonded are bonded via a linking group containing carbon atoms to which no polar group is bonded; x represents an integer of 1 to 2; R² is a perfluoropolyether chain; some or all of two or three R²'s may be the same as or different front each other; R³ is a divalent linking group represented by the following Formula (3-1) or (3-2); and when x is 2, two R³'s may be the same as or different from each other)

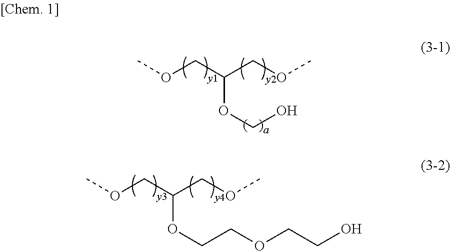

(in Formula (3-1), a represents an integer of 2 to 4; y1 represents an integer of 1 to 3; y2 represents an integer of 1 to 3; at least one of y1 and y2 is 1; and a dotted line bonded to the oxygen atom on the left side indicates a bond that is bonded to the methylene group on the side of R¹, and a dotted line bonded to the oxygen atom on the right side indicates a bond that is bonded to a methylene group on the side of R⁴t (in Formula (3-2), y3 represents an integer of 1 to 3; y4 represents an integer of 1 to 3; at least one of y3 and y4 is 1; and a dotted line bonded to the oxygen atom on the left side indicates a bond that is bonded to the methylene group on the side of R¹, and a dotted line bonded to the oxygen atom on the right side indicates a bond that is bonded to a methylene group on the side of R⁴).

The fluorine-containing ether compound according to the first aspect of the present invention preferably has features described in [2] to [9] below. It is also preferable to arbitrarily combine two or more of the features described in [2] to [9] below.
[2] The fluorine-containing ether compound according to [1],
   wherein, in Formula (1). —R¹ and —R⁴ are each independently any one represented by the following Formulae (4-1) to (4-3):

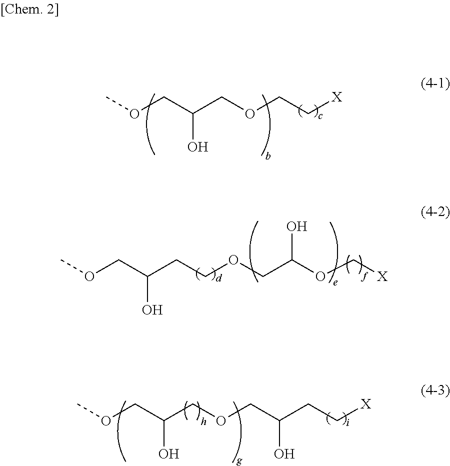

(in Formula (4-1), b is an integer of 1 to 2, and c is an integer of 0 to 3; in Formula (4-1), X is an alkenyl group, an alkynyl group, or a polar group; when b is 1, X is a polar group; and when X is an alkenyl group or an alkynyl group, a carbon atom constituting an unsaturated bond in X is bonded to a methylene group adjacent to X)
(in Formula (4-2), d is an integer of 1 to 3, e is an integer of 0 to 1, and f is an integer of 0 to 3: in Formula (4-2), X is an alkenyl group, an alkynyl group, or a polar group; when e is 0, X is a polar group; and when X is an alkenyl group or an alkynyl group, a carbon atom constituting an unsaturated bond in X is bonded to a methylene group adjacent to X)
(in Formula (4-3), g is an integer of 0 to 1, h is an integer of 1 to 3, and i is an integer of 1 to 3; in Formula (4-3). X is an alkenyl group, an alkynyl group, or a polar group: when g is 0, X is a polar group; and when X is an alkenyl group or an alkynyl group, a carbon atom constituting an unsaturated bond in X is bonded to a methylene group adjacent to X).
[3] The fluorine-containing ether compound according to [2],
   wherein, in Formulae (4-1) to (4-3), X is any of a hydroxy group, a group having an amide bond, a cyano group, and —CH═CH₂.
[4] The fluorine-containing ether compound according to any one of [1] to [3], wherein, in Formula (1), x is 1. R¹ and R⁴ are the same, and two R²'s are the same.
[5] The fluorine-containing ether compound according to any one of [1] to [3],
   wherein, in Formula (1), x is 2, R¹ and R⁴ are the same, three R²'s are the same.
[6] The fluorine-containing ether compound according to [5],
   wherein atoms contained in two R³'s in Formula (1) are arranged symmetrically with respect to R² arranged in the center of a chain structure of a molecule.
[7] The fluorine-containing ether compound according to any one of [1] to [6],
   wherein two or three R²'s in Formula (1) are each independently a perfluoropolyether chain represented by the following Formula (5):

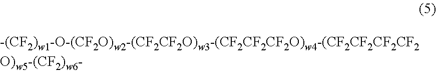

(in Formula (5), w2, w3, w4, and w5 indicate an average degree of polymerization and each independently represent 0 to 20; provided that all of w2, w3, w4, and w5 are not 0 at the same time; w1 and w6 are an average value representing the number of CF₂'s and each independently represent 1 to 3; and the arrangement order of repeating units (CF₂O), (CF₂C₂O), (CF₂CF₂CF₂O), and (CF₂CF₂CF₂CF₂O) in Formula (5) is not particularly limited).
[8] The fluorine-containing ether compound according to any one of [1] to [6],
   wherein two or three R²'s in Formula (1) are each independently any one selected from among perfluoropolyether chains represented by the following Formulae (6-1) to (6-4):

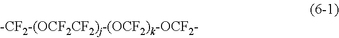

(in Formula (6-1), j and k indicate an average degree of polymerization, j represents 0.1 to 20, and k represents 0 to 20)

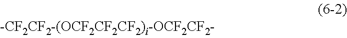

(in Formula (6-2), 1 indicates an average degree of polymerization and represents 0.1 to 15)

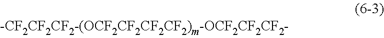

(in Formula (6-3), m indicates an average degree of polymerization and represents 0.1 to 10)

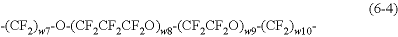

(in Formula (6-4), w8 and w9 indicate an average degree of polymerization and each independently represent 0.1 to 20; and w7 and w10 are an average value representing the number of CF's and each independently represent 1 to 2).
[9] The fluorine-containing ether compound according to any one of [1] to [8],
   wherein the number-average molecular weight is in a range of 500 to 10,000,
   A second aspect of the present invention provides the following lubricant for magnetic recording medium.
[10] A lubricant for magnetic recording medium including the fluorine-containing ether compound according to any one of [1] to [9].
   A third aspect of the present invention provides the following magnetic recording medium.
[11] A magnetic recording medium in which at least a magnetic layer, a protective layer, and a lubricating layer are sequentially provided on a substrate,
   wherein the lubricating layer contains the fluorine-containing ether compound according to any one of [1] to [9],
   The magnetic recording medium according to the third aspect of the present invention preferably has a feature described in [12] below.
[12] The magnetic recording medium according to [11],
   wherein the average film thickness of the lubricating layer is 0.5 nm to 2.0 nm.

### Advantageous Effects of Invention

The fluorine-containing ether compound of the present invention is the compound represented by Formula (1), and is suitable as a material for a lubricant for magnetic recording medium.

Since the lubricant for magnetic recording medium of the present invention contains the fluorine-containing ether compound of the present invention, it is possible to form a lubricating layer having excellent chemical substance resistance and favorable magnetic head flying stability even if the thickness is thin.

Since the magnetic recording medium of the present invention has a lubricating layer containing the fluorine-containing ether compound of the present invention, it has favorable chemical substance resistance and magnetic head flying stability. Therefore, the magnetic recording medium of the present invention has excellent durability and reliability. In addition, since the magnetic recording medium of the present invention has a lubricating layer having excellent chemical substance resistance and favorable magnetic head flying stability, the thickness of the protective layer and/or lubricating layer can be reduced.

### BRIEF DESCRIPTION OF DRAWINGS

FIG. 1 is a schematic cross-sectional view showing a magnetic recording medium according to one embodiment of the present invention.

### DESCRIPTION OF EMBODIMENTS

In order to achieve the above objects, the inventors conducted extensive studies as shown below. In the related art, as a material for a lubricant for magnetic recording medium (hereinafter sometimes abbreviated as a “lubricant”) applied to the surface of a protective layer, a fluorine-containing ether compound having a polar group such as a hydroxy group is preferably used. The polar groups in the fluorine-containing ether compound are bonded to the active sites on the protective layer to improve adhesion of the lubricating layer with respect to the protective layer. In conventional fluorine-containing ether compounds, polar groups are arranged at the terminals of the chain structure. In addition, when the fluorine-containing ether compound has a plurality of perfluoropolyether chains, a polar group is arranged between adjacent perfluoropolyether chains.

However, when a thin lubricating layer is formed on a protective layer using a conventional lubricant, it is difficult to realize a lubricating layer having favorable chemical substance resistance and favorable magnetic head flying stability.

The reason for this, for example, is the presence of polar groups in the fluorine-containing ether compound contained in the lubricating layer, which are not adsorbed to a plurality of active sites present on the protective layer.

When there are polar groups that not adsorbed to the active sites on the protective layer in the fluorine-containing ether compound contained in the lubricating layer, the lubricant in the lubricating layer becomes bulky, and the coating of the lubricating layer with respect to the protective layer becomes non-uniform. Therefore, when there are a plurality of polar groups that not adsorbed to the active sites on the protective layer in the fluorine-containing ether compound contained in the lubricating layer, the chemical substance resistance and magnetic head flying stability of the lubricating layer tend to be insufficient.

Thus, the inventors conducted extensive studies in order to realize a fluorine-containing ether compound in which polar groups that do not participate in bonding with the active sites on the protective layer are less likely to be generated, focusing on the behavior of bonding between the polar groups contained in the fluorine-containing ether compound and the active sites on the protective layer.

As a result, the inventors found that, among polar groups contained in the fluorine-containing ether compound, secondary hydroxy groups contained in the divalent linking group arranged between adjacent perfluoropolyether chains are less likely to participate in bonding with the active sites on the protective layer.

Therefore, the inventors converted secondary hydroxy groups contained in the divalent linking group arranged between adjacent perfluoropolyether chains of the fluorine-containing ether compound into primary hydroxy groups by chemical modification. Then, a lubricating layer was formed using the converted fluorine-containing ether compound. As a result, it was found that the chemical substance resistance and magnetic head flying stability were improved. This was speculated to be because, when the secondary hydroxy groups contained in the divalent linking group were converted into primary hydroxy groups, hydroxy groups that are not bonded to the active sites present on the protective layer are less likely to be generated in the fluorine-containing ether compound.

In addition, the inventor conducted extensive studies and found that it is sufficient to use a fluorine-containing ether compound in which there are two or three perfluoropolyether chains, a specific divalent linking group having only one primary hydroxy group is arranged between adjacent perfluoropolyether chains, and specific terminal groups are arranged at both terminals. The divalent linking group has a side chain moiety branching from the chain structure of the fluorine-containing ether compound and linked by an ether bond. The side chain moiety has a primary hydroxy group arranged at the tip and has a linking group containing a methylene group (—CH₂—) that bonds a carbon atom to which a primary hydroxy group is bonded and an oxygen atom that is bonded to a carbon atom in the chain structure. In addition, the terminal groups include two or three polar groups, wherein the polar groups are bonded to different carbon atoms, and carbon atoms to which the polar groups are bonded are bonded via a linking group containing carbon atoms to which no polar group is bonded.

In such a fluorine-containing ether compound, for the following reason, polar groups that are not bonded to functional groups (active sites) present on the protective layer are less likely to be generated. Therefore, it is speculated that a fluorine-containing ether compound which can form a lubricating layer having excellent chemical substance resistance and magnetic head flying stability is obtained.

That is, the divalent linking group has only one primary hydroxy group and is sterically vacant compared to when it has a secondary hydroxy group in place of the primary hydroxy group. In addition, in the fluorine-containing ether compound, in the side chain moiety of the divalent linking group, a carbon atom to which a primary hydroxy group arranged at the tip is bonded and an oxygen atom that is bonded to a carbon atom in the chain structure are bonded by a linking group containing a methylene group (—CH₂—). Therefore, the distance between the primary hydroxy group of the divalent linking group and the carbon atom in the chain structure is appropriate. Accordingly, the primary hydroxy groups of the divalent linking groups are less likely to be inhibited from bonding to the active sites on the protective layer due to bulky portions in the fluorine-containing ether compound such as an adjacent perfluoropolyether chain, and tertiary carbon to which a side chain moiety of a divalent linking group is bonded. Furthermore, the primary hydroxy group can generally move more freely than the secondary hydroxy group. Therefore, the primary hydroxy groups of the divalent linking groups can each move spontaneously to the active sites on the protective layer. Therefore, the primary hydroxy group of the divalent linking group can easily form bonds with the active sites on the protective layer.

In addition, when the fluorine-containing ether compound has three perfluoropolyether chains, there are two divalent linking groups. In this case, a perfluoropolyether chain is arranged between two adjacent divalent linking groups. Therefore, the distance between primary hydroxy groups of two adjacent divalent linking groups does not become too short. Therefore, in the fluorine-containing ether compound, the primary hydroxy groups of the divalent linking groups are less likely to be inhibited from bonding to the active sites on the protective layer due to the primary hydroxy groups of other divalent linking groups contained in the fluorine-containing ether compound. In addition, in the fluorine-containing ether compound, the primary hydroxy groups of two adjacent divalent linking groups are unlikely to aggregate with each other.

In addition, in the fluorine-containing ether compound, each perfluoropolyether chain is arranged between the divalent linking group and both terminal groups. Therefore, the distance between the primary hydroxy group of the divalent linking group and two or three polar groups of the terminal groups does not become too short. As a result, the primary hydroxy groups of the divalent linking groups are less likely to be inhibited from bonding to the active sites on the protective layer due to the polar group of the terminal group. In addition, since the distance between the primary hydroxy group of the divalent linking group and the polar group of the terminal group is appropriate, the primary hydroxy group of the divalent linking group and the polar group of the terminal group are unlikely to aggregate.

In addition, in the fluorine-containing ether compound, the divalent linking group has only one primary hydroxy group and a side chain moiety branching from the chain structure of the fluorine-containing ether compound and linked by an ether bond. In the fluorine-containing ether compound, since the side chain moiety of the divalent linking group branches from the chain structure and is linked by an ether bond, the flexibility of the side chain moiety is better, for example, compared to when the carbon atom in the side chain moiety and the carbon atom in the chain structure are directly bonded. Therefore, the primary hydroxy group of the side chain moiety of the divalent linking group can easily form bonds with the active sites on the protective layer.

In addition, in the fluorine-containing ether compound, two or three polar groups of the terminal groups are bonded to different carbon atoms, and carbon atoms to which the polar groups are bonded are bonded via a linking group containing carbon atoms to which no polar group is bonded. Therefore, the two or three polar groups of the terminal groups are all oriented so that they can adhere to the protective layer. Accordingly, two or three polar groups of the terminal groups are unlikely to aggregate and can easily form bonds with active sites on the protective layer.

As described above, in the fluorine-containing ether compound, the flexibility of the side chain moiety of the divalent linking group is favorable, the primary hydroxy groups of the side chain moieties can move spontaneously and are unlikely to aggregate, and less likely to be inhibited from bonding to the active sites on the protective layer due to primary hydroxy groups of other divalent linking groups, polar groups of the terminal groups, and bulky portions in the fluorine-containing ether compound. Furthermore, in the fluorine-containing ether compound, all two or three polar groups of the terminal groups are oriented so that they can adhere to the protective layer.

Accordingly, in the fluorine-containing ether compound, polar groups that are not bonded to functional groups (active sites) present on the protective layer are less likely to be generated. As a result, it is speculated that the fluorine-containing ether compound can form a lubricating layer which has favorable adhesion to the protective layer, is unlikely to take in contamination substances, and has excellent chemical substance resistance, and favorable magnetic head flying stability. In addition, the inventors confirmed that, when the lubricant containing the fluorine-containing ether compound is used, it is possible to form a lubricating layer having favorable chemical substance resistance and magnetic head flying stability, and completed the present invention.

Hereinafter, preferable examples of a fluorine-containing ether compound, a lubricant for magnetic recording medium and a magnetic recording medium of the present invention will be described in detail. Here, the present invention is not limited to the following embodiments. In the present invention, numbers, amounts, positions, ratios, materials, configurations and the like can be added, omitted, substituted, and changed without departing from the spirit and scope of the present invention.

### [Fluorine-Containing Ether Compound]

A fluorine-containing ether compound of the present embodiment is represented by the following Formula (1).

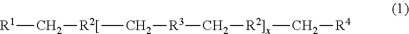

(in Formula (1), R¹ and R⁴ are each independently a terminal group containing two or three polar groups, wherein the polar groups are bonded to different carbon atoms, and carbon atoms to which the polar groups are bonded are bonded via a linking group containing carbon atoms to which no polar group is bonded; x represents an integer of 1 to 2; R² is a perfluoropolyether chain; some or all of two or three R²'s may be the same as or different from each other; R³ is a divalent linking group represented by the following Formula (3-1) or (3-2); and when x is 2, two R³'s may be the same as or different from each other).

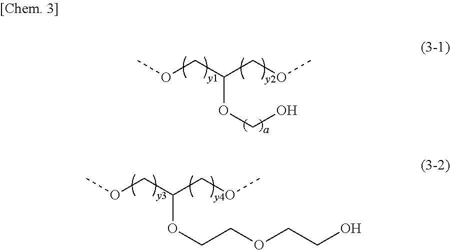

(in Formula (3-1), a represents an integer of 2 to 4, y1 represents an integer of 1 to 3; y2 represents an integer of 1 to 3; at least one of y1 and y2 is 1; and a dotted line bonded to the oxygen atom on the left side indicates a bond that is bonded to the methylene group on the side of R¹, and a dotted line bonded to the oxygen atom on the right side indicates a bond that is bonded to a methylene group on the side of RA), (in Formula (3-2), y3 represents an integer of 1 to 3; y4 represents an integer of 1 to 3; at least one of y3 and y4 is 1; and a dotted line bonded to the oxygen atom on the left side indicates a bond that is bonded to the methylene group on the side of R¹, and a dotted line bonded to the oxygen atom on the right side indicates a bond that is bonded to a methylene group on the side of R⁴).

As shown in Formula (1), the fluorine-containing ether compound of the present embodiment has a chain structure framework in which one or two divalent linking groups having only one primary hydroxy group and represented by R³ and two or three perfluoropolyether chains represented by R² (hereinafter sometimes referred to as PPE chains) are linked via a methylene group. The PFPE chain represented by R¹ is arranged at both ends of the framework, and the terminal groups containing two or three polar groups represented by R¹ and R⁴ are bonded via a methylene group.

In the fluorine-containing ether compound represented by Formula (1), x represents an integer of 1 to 2. In the fluorine-containing ether compound represented by Formula (1), since x is an integer of 1 to 2, the number of polar groups in the molecule is appropriate. That is, the number of polar groups contained in the fluorine-containing ether compound represented by Formula (1) is 5 to. Therefore, for example, compared to when x is 0, the fluorine-containing ether compound represented by Formula (1) can form a lubricating layer having favorable adhesion to the protective layer. In addition, for example, compared to when x is 3 or more, the fluorine-containing ether compound represented by Formula (1) can prevent interaction between the polar groups in the molecule and the polar groups of the fluorine-containing ether compound are unlikely to aggregate with each other.

### (Divalent Linking Group Represented by R³)

In the fluorine-containing ether compound represented by Formula (1), since x is 1 or 2, the PFPE chains represented by R² are bonded to each other via —CH₂—R³—CH₂—, in the fluorine-containing ether compound represented by Formula (1), x R³'s each have no secondary hydroxy group and have only one primary hydroxy group. Therefore, compared to when one or more R³'s among x R³'s have one or more secondary hydroxy groups, the degree of freedom of hydroxy groups contained in R¹ is high, and the hydroxy groups in R¹ easily interact with the active sites on the protective layer. Therefore, when a lubricating layer is formed on the protective layer using the lubricant containing the fluorine-containing ether compound represented by Formula (1), a suitable interaction occurs between the lubricating layer and the protective layer. Therefore, the fluorine-containing ether compound represented by Formula (1) can form a lubricating layer having favorable adhesion to the protective layer and favorable chemical substance resistance at a sufficient coating rate even if the thickness is thin. In addition, in the lubricating layer, the primary hydroxy group contained in R³ in Formula (1) easily interacts with the active sites on the protective layer, and thus the primary hydroxy group contained in R³ and the PIPE chains represented by R² arranged on both sides of R³ are less likely to rise from the protective layer. As a result, the distance to the magnetic head is appropriate, and a lubricating layer having favorable magnetic head flying stability is obtained.

R³ is a divalent linking group represented by Formula (3-1) or 13-2). The both terminals of R³ are oxygen atoms. The both terminals of R³ are bonded to a methylene group that is bonded to R² via an ether bond.

R³ has a main chain moiety that forms the chain structure of the fluorine-containing ether compound (—O(CH₂)_{y}—CH—(CH₂)_{y}—O-(in the formula, y's represent an integer of 1 to 3, and at least one of two y's is 1) and a side chain moiety branching from the main chain moiety and linked by an ether bond. The side chain moiety branches from the main chain moiety at carbon atoms bonded to oxygen atoms arranged at both terminals of the main chain moiety for R³ via 1 to 3 methylene groups. The side chain moiety has a primary hydroxy group arranged at the tip and has a linking group containing a methylene group (—CH₂—) that bonds a carbon atom to which a primary hydroxy group is bonded and an oxygen atom (etheric oxygen atom) that is bonded to a carbon atom in the main chain moiety.

—(CH₂)ₙOH in Formula (3-1) or —CH₂CH₂OCH₂CH₂OH in Formula (3-2) is bonded to the carbon atom that forms the main chain moiety for R³, as a side chain moiety, via an ether bond. In the present embodiment, when the side chain moiety for R¹ is ether-bonded to the carbon atom that forms the main chain moiety for R, the side chain moiety for R¹ has better flexibility, for example, compared to when the carbon atom that forms the main chain moiety for R¹, and the carbon atom in the side chain moiety for R³ are directly bonded. Furthermore, in the present embodiment, the side chain moiety for R³ has a chain structure containing a linking group and having an appropriate length. Therefore, the side chain moiety for R¹ easily interacts with the active sites on the protective layer.

In Formula (3-1), a is an integer of 2 to 4. When a is 2 or more, the distance between the primary hydroxy group contained in R¹ and a bulky portion such as the PFPE chain in the fluorine-containing ether compound or tertiary carbon that is a carbon atom which forms the main chain moiety for R³ and to which the side chain moiety for R³ is ether-bonded becomes sufficiently long, and the primary hydroxy group contained in R³ can easily freely move. Accordingly, the primary hydroxy group in Formula (3-1) easily adheres to the protective layer, and the lubricating layer containing the fluorine-containing ether compound represented by Formula (1) is less likely to rise from the protective layer. In addition, when a is 4 or less, the flexibility of —(CH₂)ₐOH in Formula (3-0 is maintained, a is preferably 2 to 3 and most preferably 2 because —(CH₂)ₐOH can flexibly move.

In Formula (3-1), y1 is an integer of 1 to 3, and y2 is an integer of 1 to 3. At least one of y1 and y2 is 1. Since at least one of y1 and y2 is 1, a fluorine-containing ether compound that is easy to produce is obtained. Since y2 when only y1 between y1 and y2 is 1 (or y1 when only y2 is 1) maintains the flexibility of the entire divalent linking group represented by Formula (3-1), it is 3 or less and preferably 2 or less. Since y1 and y2 maintain the flexibility of the entire divalent linking group represented by Formula (3-1), more preferably, y1 is 1 and y2 is 1.

In Formula (3-2). —CH₂CH₂OCH₂CH₂OH contains an ether bond (—O—). Therefore, —CH₂CH₂CH₂CH₂OH in Formula (3-2) secures flexibility of movement.

In Formula (3-2), y3 is an integer of 1 to 3, and y4 is an integer of 1 to 3. At least one of y3 and y4 is 1. Since at least one of y3 and y4 is 1, a fluorine-containing ether compound that is easy to produce is obtained. Since y4 when only y3 between y3 and y4 is 1 (or y3 when only y4 is 1) maintains the flexibility of the entire divalent linking group represented by Formula (3-2), it is 3 or less and preferably 2 or less. Since y3 and y4 maintain the flexibility of the entire divalent linking group represented by Formula (3-2), more preferably, y3 is 1 and y4 is 1.

In Formula (1), when x is 2, two R³'s may be the same as or different from each other. When two R³'s are the same, this is preferable because a fluorine-containing ether compound that is easy to produce is obtained. “Two R³'s are the same” means that atoms contained in two R³'s are arranged symmetrically with respect to R² arranged in the center of a chain structure of a molecule. That is, when x is 2, the fluorine-containing ether compound represented by Formula (1) is preferably a fluorine-containing ether compound in which two R³'s are Formula (3-1), a's in Formula (3-1) for two R³'s are the same and y1 and y2 in Formula (3-1) for two R³'s are values that are symmetrical with respect to R² arranged in the center of the chain structure or a fluorine-containing ether compound in which two R³'s are Formula (3-2) and y3 and y4 in Formula (3-2) for two R¹'s are values that are symmetrical with respect to R¹ arranged in the center of the chain structure. For example, when R³ on the side of R¹ is represented by Formula (3-1), in Formula (3-1), y1 is 1 and y2 is 2, R³ on the side of R⁴ is represented by Formula (3-1), in Formula (3-1), y1 is 2 and y2 is 1, and the values of a in Formula (3.1) are all the same, two R³'s are the same. In addition, for example, when R¹ on the side of R⁴ is represented by Formula (3-2), in Formula (3-2), y3 is 1 and y4 is 2, R³ on the side of R⁴ is represented by Formula (3-2), and in Formula 3-2), y3 is 2 and y4 is 1, two R³'s are the same.

### (PFPE Chain Represented by R²)

In the fluorine-containing ether compound represented by Formula (1), (x+1) R¹'s are each independently a perfluoropolyether chain. When the lubricant containing the fluorine-containing ether compound of the present embodiment is applied onto the protective layer to form a lubricating layer, the PFPE chain represented by R² covers the surface of the protective layer, imparts lubricity to the lubricating layer, and reduces the frictional force between the magnetic head and the protective layer. The PFPE chain represented by R² is appropriately selected depending on the performance required for the lubricant containing the fluorine-containing ether compound and the like.

In the fluorine-containing ether compound represented by Formula (1), sone or all of two or three R²'s may be the same as or different from each other. All of the (x+1) R²'s is are preferably the same. This is because the coating of the fluorine-containing ether compound on the protective layer becomes uniform, and a lubricating layer having better adhesion is formed. “Two or more. R²'s among (x+1) R²'s are the same” means that, among (x+1) R²'s, two or more R²'s have the same repeating unit structure of the PFPE chain. The same R² includes those having the same repeating unit structure but different average degrees of polymerization.

Examples of PFPE chain represented by R² include those composed of perfluoroalkylene oxide polymers or copolymers. Examples of perfluoroalkylene oxides include perfluoromethylene oxides, perfluoroethylene oxides, perfluoro-n-propylene oxides, perfluoroisopropylene oxides, and perfluorobutylene oxides.

(x+1) R²'s in Formula (1) are each independently preferably a PFPE chain represented by the following Formula (5) derived from a perfluoroalkylene oxide polymer or copolymer.

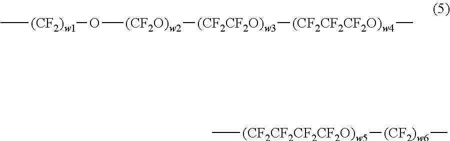

(in Formula (5), w2, w3, w4, and w5 indicate an average degree of polymerization and each independently represent 0 to 20; provided that all of w2, w3, w4, and w5 are not 0 at the same time; w1 and w6 are an average value representing the number of CF₂'s and each independently represent 1 to 3; and the arrangement order of repeating units (CF₂), (CF₂CF₂O), (CF₂CF₂CF₂O), and (CF₂CF₂CF₂CF₂O) in Formula (5) is not particularly limited).

In Formula (5), w2, w3, w4, and w5 indicate an average degree of polymerization and each independently represent 0 to 20, and are preferably 0 to 15 and more preferably 0 to 10. They may be 1 to 8, 2 to 6, 3 to 5 or the like.

In Formula (5), w1 and w6 are an average value indicating the number of CF₂'s, and each independently represent 1 to 3, w1 and w6 are determined according to the structure of repeating units arranged at the ends of the chain structure in the PFPE chain represented by Formula (5).

In Formula (5), (CF₂O), (CF₂CF₂O), (CF₂CF₂CF₂O), and (CF₂CF₂CF₂CF₂O) are repeating units. The arrangement order of repeating units in Formula (5) is not particularly limited. In addition, the number of types of repeating units in Formula (5) is not particularly limited.

(x+1) R²'s in Formula (1) are each independently preferably any one selected from among PFPE chains represented by the following Formulae (6-1) to (6-4). When (x+1) R²'s are each independently any one selected from among PFPE chains represented by Formulae (6-1) to (6-4), a fluorine-containing ether compound which can form a lubricating layer having favorable lubricity is obtained. In addition, when (x+1) R²'s are each independently any one selected from among PFPE chains represented by Formulae (6-1) to (6-4), the ratio of the number of oxygen atoms (the number of ether bonds (—O—)) to the number of carbon atoms in the PFPE chain is appropriate. Therefore, the fluorine-containing ether compound having an appropriate hardness is obtained. Therefore, the fluorine-containing ether compound applied onto the protective layer is unlikely to aggregate on the protective layer, and a thinner lubricating layer can be formed at a sufficient coating rate. In addition, since the fluorine-containing ether compound has appropriate flexibility, a lubricating layer having better chemical substance resistance can be formed.

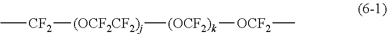

(in Formula (6-1), j and k indicate an average degree of polymerization, j represents 0.1 to 20, and k represents 0 to 20).

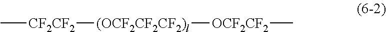

(in Formula (6-2), 1 indicates an average degree of polymerization and represents 0.1 to 15).

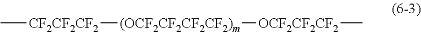

(in Formula (6-3), m indicates an average degree of polymerization and represents 0.1 to 10).

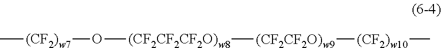

In Formula (6-4), w8 and w9 indicate an average degree of polymerization and each independently represent 0.1 to 20; and w7 and w10 are an average value representing the number of CF₂'s and each independently represent 1 to 2).

In Formula (6-1), the arrangement order of repeating units (OCF₂CF₂) and (OCF₂) is not particularly limited. In Formula (6-1), the number j of (OCF₂CF₂)'s and the number k of ((CF₂)'s may be the same as or different from each other. The PFPE chain represented by Formula (6-1) may be a polymer of (OCF₂CF₂). In addition, the PFPE chain represented by Formula (6-1) may be any of a random copolymer, a block copolymer, and an alternating copolymer composed of (OCF₂CF₂) and (OCF₂).

In Formulae (6-1) to (6-3), since j indicating an average degree of polymerization is 0.1 to 20, k is 0 to 20, 1 is 0.1 to 15, and m is 0.1 to 10, a fluorine-containing ether compound which can form a lubricating layer having favorable lubricity is obtained. In addition, in Formulae (6-1) to (6-3), when j and k indicating an average degree of polymerization are 20 or less, 1 is 15 or less, and nm is 10 or less, this is preferable because the viscosity of the fluorine-containing ether compound does not become too high, and a lubricant containing this is easily applied, j, k, l, and m indicating an average degree of polymerization are preferably 1 to 10, more preferably 1.5 to 8, and still more preferably 2 to 7 because a fluorine-containing ether compound which easily wets and spreads on the protective layer and allows a lubricating layer having a uniform film thickness to be obtained is obtained.

In Formula (6-4), the arrangement order of repeating units (CF₂CF₂CF₂O) and (CF₂CF₂O) is not particularly limited. In Formula (64), the number w8 of (CF₂CF₂CF₂O)'s and the number w9 of (CF₂CF₂O)N, which indicate an average degree of polymerization, may be the same as or different from each other. Formula (6-4) may contain any of a random copolymer, a block copolymer, and an alternating copolymer composed of monomer units (CF₂CF₂CF₂O) and (CF₂CF₂O).

In Formula (6-4), w8 and w9 indicating an average degree of polymerization are each independently 0.1 to 20, preferably 1 to 15, and more preferably 1 to 10. In Formula (6-4), w7 and w10 are an average value indicating the number of CF₂'s, and each independently represent 1 to 2, w7 and w0 are determined according to the structure of repeating units arranged at the ends of the chain structure in the PFPE chain represented by Formula (6-4).

(Terminal Groups Represented by R¹ and R⁴)

In the fluorine-containing ether compound represented by Formula (1), the terminal groups represented by R¹ and R⁴ are each independently a terminal group containing two or three polar groups, wherein the polar groups are bonded to different carbon atoms, and carbon atoms to which the polar groups are bonded are bonded via a linking group containing carbon atoms to which no polar group is bonded. Therefore, all two or three polar groups are oriented so that they can adhere to the protective layer, and when a lubricating layer is formed on the protective layer using the lubricant containing the fluorine-containing ether compound represented by Formula (1), a suitable interaction occurs between the lubricating layer and the protective layer. As a result, high adhesion to the protective layer can be obtained and a lubricating layer having favorable chemical substance resistance and magnetic head flying stability can be formed.

Examples of polar groups include a hydroxy group (—OH), a group having an amide bond (—NR⁵COR⁶ or —CONR⁷R⁸; R⁵, R⁶, R⁷ and R⁸ are each independently a hydrogen atom or an organic group), a cyano group (—CN), an amino group (—NR⁹R¹⁰; R⁹ and R¹⁰ are each independently a hydrogen atom or an organic group), a carboxy group (—COOH), a formyl group (—(C═O)H), a carbonyl group (—CO—), and a sulfo group (—SO₃—H). Here, as shown in the above formula, the “group having an amide bond” includes both a group that, is bonded at, a carbon atom constituting an amide bond (for example, a carboxamide group (—C(═O)NH)) and a group that is bonded at a nitrogen atom constituting an amide bond (for example, an acetamide group (—NHC(═O)CH₃)). In the group having an amide bond. R⁵ and R⁶ may be bonded to each other to form a ring, and R⁷ and R⁸ may be bonded to each other to form a ring. R⁵, R⁶, R⁷ and R⁸ in the group having an amide bond are each independently preferably selected from the group consisting of a hydrogen atom, a methyl group, an ethyl group, a propyl group, and a butyl group.

R¹ and R⁴ preferably contain at least one selected front the group consisting of a hydroxy group, a group having an amide bond, and a cyano group as a polar group. When a lubricating layer is formed on the protective layer using a lubricant containing a fluorine-containing ether compound in which R¹ and R⁴ have at least one selected from the group consisting of a hydroxy group, a group having an amide bond, and a cyano group, a more suitable interaction occurs between the lubricating layer and the protective layer. Some or all of two or three polar groups contained in R¹ and R⁴ may be the same or all of them may be different. In order to obtain a fluorine-containing ether compound which can form a lubricating layer having better adhesion to the protective layer, R¹ and R⁴ each preferably contain at least one hydroxy group as a polar group.

In the fluorine-containing ether compound represented by Formula (1), a total number of polar groups contained in R¹ and polar groups contained in R⁴ is 4 to 6. Since the total number is 4 or more, the lubricating layer containing the fluorine-containing ether compound has high adhesiveness (adhesion) to the protective layer. In addition, since the total number is 6 or less, in the magnetic recording medium having the lubricating layer containing the fluorine-containing ether compound, it is possible to prevent the occurrence of pickup in which the fluorine-containing ether compound has too high polarity and adheres to a magnetic head as a foreign matter (smear).

The number of polar groups contained in R¹ and the number of polar groups contained in R⁴ am preferably the same. That is, preferably, R¹ and R⁴ each contain two polar groups or R¹ and R⁴ each contain three polar groups. In this case, the lubricant containing the fluorine-containing ether compound adheres to the protective layer in a well-balanced manner. Therefore, it is easy to obtain a lubricating layer having a high coating rate and better chemical substance resistance and magnetic head flying stability.

The terminal groups represented by R¹ and R⁴ are preferably a terminal group having 4 to 18 carbon atoms and more preferably a terminal group having 4 to 11 carbon atoms, each having two or three polar groups. When the number of carbon atoms is within the above range, the ratio of the number of carbon atoms to the number of polar groups is appropriate, and a fluorine-containing ether compound with appropriate molecular polarity is obtained, in the terminal groups represented by R¹ and R⁴, the ends bonded to adjacent methylene groups are preferably oxygen atoms. In this case, when R¹ and R⁴ bond to adjacent methylene groups via an ether bond, a fluorine-containing ether compound having an appropriate hardness is obtained. Therefore, the fluorine-containing ether compound applied onto the protective layer is unlikely to aggregate on the protective layer, and a thinner lubricating layer can be formed at a sufficient coating rate.

Specifically, the terminal groups represented by R¹ and R⁴ are each independently preferably any of the following Formulae (4-1) to (4-3)

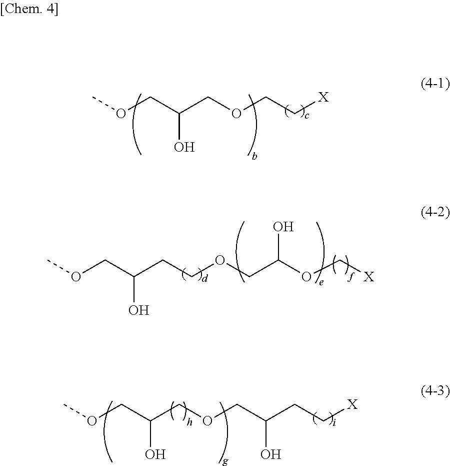

(in Formula (4.1), b is an integer of 1 to 2, and c is an integer of 0 to 3; in Formula (4-1), X is an alkenyl group, an alkynyl group, or a polar group; when b is 1, X is a polar group; and when X is an alkenyl group or an alkynyl group, a carbon atom constituting an unsaturated bond in X is bonded to a methylene group adjacent to X).
(in Formula (4-2), d is an integer of 1 to 3, e is an integer of 0 to 1, and f is an integer of 0 to 3; in Formula (4-2), X is an alkenyl group, an alkynyl group, or a polar group; when e is 0, X is a polar group; and when X is an alkenyl group or an alkynyl group, a carbon atom constituting an unsaturated bond in X is bonded to a methylene group adjacent to X).
(in Formula (4-3), g is an integer of 0 to 1, h is an integer of 1 to 3, and i is an integer of 1 to 3; in Formula (4-3), X is an alkenyl group, an alkynyl group, or a polar group; when g is 0. X is a polar group; and when X is an alkenyl group or an alkynyl group, a carbon atom constituting an unsaturated bond in X is bonded to a methylene group adjacent to X).

In Formulae (4-1) to (4-3), X is an alkenyl group, an alkynyl group, or a polar group. When X is an alkenyl group or an alkynyl group, the π-π interaction with the protective layer occurs. When X is a polar group, its polarity causes interaction with the protective layer. Therefore, the fluorine-containing ether compound having the terminal groups represented by Formulae (4.1) to (4-3) can form a lubricating layer which has favorable adhesion due to interaction with the protective layer and favorable chemical substance resistance and magnetic head flying stability.

Examples of alkenyl groups include —CH═CH₂. —CH═C(HR¹¹(R¹¹ is an organic group). —CR¹²═CHR¹³(R¹² and R¹³ are an organic group), and —CR¹⁴═CR¹⁵R¹⁶ (R¹⁴, R¹⁵, and R¹⁶ are an organic group). The organic groups represented by R¹¹ to R¹⁶ each are preferably a hydrocarbon group having 1 to 3 carbon atoms. In Formulae (4-1) to 14-3), when X is an alkenyl group, it is preferably —CH═CH₂. —CH═CH₂ has appropriate bulkiness. Therefore, in the lubricating layer containing the fluorine-containing ether compound having a terminal group in which X is —CH═CH₂, the height of the fluorine-containing ether compound on the protective layer tends to be low and the magnetic head flying stability is favorable.

Examples of alkynyl groups include —C≡CH. —C≡CR¹⁷ (R¹⁷ is an organic group). The organic group represented by R¹⁷ is preferably a hydrocarbon group having 1 to 3 carbon atoms. In Formulae (4-1) to (4-3), when X is an alkynyl group, it is preferably —C≡CH because the terminal group has appropriate bulkiness.

Examples of polar groups include a hydroxy group (—OH), a group having an amide bond (—NR⁵COR⁶ or —CONR⁷R⁸; R⁵, R⁶, R⁷ and R⁸ and R⁸ are each independently a hydrogen atom or an organic group), a cyano group (—CN), an amino group (—NR⁹R¹⁰; R⁹ and R¹⁰ are each independently a hydrogen atom or an organic group), a carboxy group —C(X)H), a formyl group ((C═O)H), a carbonyl group (—CO—), and a sulfo group (—SO₃H). Here, as shown in the above formula, the “group having an amide bond” includes both a group that is bonded at a carbon atom constituting an amide bond and a group that is bonded at a nitrogen atom constituting an amide bond. Specific examples of the “group having an amide bond” include those exemplified above as the polar groups contained in R¹ and R⁴.

In Formulae (4-1) to (4-3), when X is a polar group, it is preferably any selected from among a hydroxy group, a group having an amide bond, and a cyano group because a fluorine-containing ether compound can form a lubricating layer having favorable adhesion to the protective layer.

Among the above examples, X in Formulae (4-1) to (4-3) is preferably any of a hydroxy group, a group having an amide bond, a cyano group, and —CH═CH₂. This is because a fluorine-containing ether compound that can form a lubricating layer having a higher coating rate and better chemical substance resistance and magnetic head flying stability is obtained.

In the terminal group represented by Formula (4-1), b is an integer of 1 to 2. When b is 1, X is a polar group, and Formula (4-1) has two polar groups. In this case, since Formula (4-1) has two polar groups, a lubricating layer having favorable adhesion to the protective layer can be formed. When b is 2, X may be any of an alkenyl group, an alkynyl group, and a polar group. When X is an alkenyl group or an alkynyl group, a carbon atom constituting an unsaturated bond in X is bonded to a methylene group adjacent to X. When b is 2 and X is an alkenyl group or an alkynyl group, Formula (4-1) has two polar groups. Therefore, a lubricating layer having favorable adhesion to the protective layer can be formed. In addition, since X is an alkenyl group or an alkynyl group, a lubricating layer having favorable chemical substance resistance and magnetic head flying stability can be formed due to the π-π interaction between X and the protective layer without impairing the adhesion of the terminal group to the protective layer. In addition, when b is 2 and X is a polar group, Formula (4-1) had three polar groups. Therefore, a lubricating layer exhibiting excellent adhesion to the protective layer can be formed.

In Formula (4-1), c is an integer of 0 to 3. In the terminal group represented by Formula (4-1), even if X in Formula (4-1) is a polar group, since the distance between X and the secondary hydroxy group in Formula (4-1) is not too close, the polar groups in Formula (4-1) are unlikely to aggregate. When X in Formula (4-1) is a polar group, since the distance between X and the secondary hydroxy group in Formula (4-1) becomes even more appropriate, c is preferably an integer of 1 or more. In the terminal group represented by Formula (4-1), since c is an integer of 3 or less, the movement of X in Formula (4-1) does not become too large, and each polar group of the terminal group can sufficiently adhere to the protective layer, c is more preferably an integer of 2 or less.

In the terminal group represented by Formula (4-2), d is an integer of 1 to 3. When e is 0, X is a polar group. Since d is an integer of 1 or more, when e is 0, the distance between X and the secondary hydroxy group in Formula (4-2) becomes appropriate, and even if X is a polar group, the polar groups in Formula (4-2) are unlikely to aggregate. In addition, when e is 1, since the distance between the secondary hydroxy groups in Formula (4-2) does not become too short, the secondary hydroxy groups in Formula (4-2) are unlikely to aggregate. In the terminal group represented by Formula (4-2), since d is an integer of 3 or less, the movement of the terminal group represented by Formula (4-2) does not become too large, and each polar group of the terminal group can sufficiently adhere to the protective layer, d is preferably an integer of 2 or less.

In the terminal group represented by Formula (4.2), e is an integer of 0 to 1. When e is 0, X is a polar group, and Formula (4-2) has two polar groups. In this case, since Formula (4-2) has two polar groups, a lubricating layer having favorable adhesion to the protective layer can be formed. When e is 1, X may be any of an alkenyl group, an alkynyl group, and a polar group. When X is an alkenyl group or an alkynyl group, a carbon atom constituting an unsaturated bond in X is bonded to a methylene group adjacent to X. When e is 1 and X is an alkenyl group or an alkynyl group, Formula (4-2) has two polar groups. Therefore, a lubricating layer having favorable adhesion to the protective layer can be formed. In addition, since X is an alkenyl group or an alkynyl group, a lubricating layer having favorable chemical substance resistance and magnetic head flying stability can be formed due the x-x interaction between X and the protective layer without impairing the adhesion of the terminal group to the protective layer. In addition, when e is 1 and X is a polar group, Formula (4-2) has three polar groups. Therefore, a lubricating layer exhibiting excellent adhesion to the protective layer can be formed.

In Formula (4-2), f is an integer of 0 to 3. In the terminal group represented by Formula (4-2), even if X in Formula (4-2) is a polar group, since the distance between X and the secondary hydroxy group in Formula (4-2) is not too close, the polar groups in Formula (4-2) are unlikely to aggregate. When X in Formula (4-2) is a polar group, since the distance between X and the secondary hydroxy group in Formula (4-2) becomes even more appropriate, f is preferably 1 or more. In addition, when e is 0, even if f is 0, the distance between the polar group X and the secondary hydroxy group in Formula (4-2) becomes appropriate due to d methylene groups. When e is 0, if f is 1 or more, this is preferable because the distance between the polar group X and the secondary hydroxy group in Formula (4-2) becomes even more appropriate due to d+f methylene groups. In the terminal group represented by Formula (4.2), since f is an integer of 3 or less, the movement of X in Formula (4-2) does not become too large, and each polar group of the terminal group can sufficiently adhere to the protective layer.

In the terminal group represented by Formula (4-3), g is an integer of 0 to 1, When g is 0, X is a polar group, and Formula (4-3) has two polar groups. In this case, since Formula (4-3) has two polar groups, a lubricating layer having favorable adhesion to the protective layer can be formed. When g is 1, X may be any of an alkenyl group, an alkynyl group, and a polar group. When X is an alkenyl group or an alkynyl group, a carbon atom constituting an unsaturated bond in X is bonded to a methylene group adjacent to X. When g is 1 and X is an alkenyl group or an alkynyl group, Formula (4-3) has two polar groups. Therefore, a lubricating layer having favorable adhesion to the protective layer can be formed. In addition, since X is an alkenyl group or an alkynyl group, a lubricating layer having favorable chemical substance resistance and magnetic head flying stability can be formed due to the n-n interaction between X and the protective layer without impairing the adhesion of the terminal group to the protective layer. In addition, when g is 1 and X is a polar group. Formula (4-3) has three polar groups. Therefore, a lubricating layer exhibiting excellent adhesion to the protective layer can be formed.

In the terminal group represented by Formula (4-3), b is an integer of 1 to 3. Since h is 1 or more, when g is 1, the distance between the secondary hydroxy groups in Formula (4-3) does not become too short. Therefore, the secondary hydroxy groups in Formula (4-3) are unlikely to aggregate. In the terminal group represented by Formula (4-3), since h is an integer of 3 or less, the movement of the terminal group represented by Formula (4-3) does not become too large, and each polar group of the terminal group can sufficiently adhere to the protective layer, h is preferably an integer of 2 or less.

In Formula (4-3) i is an integer of 1 to 3. In the terminal group represented by Formula (4-3), since i is 1 or more, even if X in Formula (4-3) is a polar group, the distance between X and the secondary hydroxy group in Formula (4-3) does not become too short. Therefore, the polar groups in Formula (4-3) are unlikely to aggregate. When g is 1, h is 2 or less, and X is a polar group, since the distance between X and the secondary hydroxy group in Formula (4-3) becomes even more appropriate, i is preferably 2 or more, in the terminal group represented by Formula (4-3), since i is an integer of 3 or less, the movement of X in Formula (4-3) does not become too large, and each polar group of the terminal group can sufficiently adhere to the protective layer.

In the fluorine-containing ether compound represented by Formula (1), R¹ and R⁴ may be the same as or different front each other. When R¹ and R⁴ are the same, the coating of the fluorine-containing ether compound on the protective layer becomes more uniform, and a lubricating layer having better adhesion can be formed.

In the fluorine-containing ether compound represented by Formula (1), the types of terminal groups represented by R¹ and R⁴ can be appropriately selected depending on the performance required for the lubricant containing the fluorine-containing ether compound and the like.

In the fluorine-containing ether compound represented by Formula (1), preferably, x is 1. R¹ and R³ are the same, and two R²'s are the same. This is because a fluorine-containing ether compound is easily synthesized.

In the fluorine-containing ether compound represented by Formula (1), preferably, x is 2. R¹ and R⁴ are the same, and three R²'s are the same. This is because a fluorine-containing ether compound is easily synthesized. In addition, when x is 2, atoms contained in two R³'s are preferably arranged symmetrically with respect to R¹ arranged in the center of a chain structure of a molecule. This is because a fluorine-containing ether compound is more easily synthesized. The description “atoms contained in two R³'s are arranged symmetrically with respect to R² arranged in the center of a chain structure of a molecule” is the same as that described for R.

Specifically, the fluorine-containing ether compound represented by Formula (1) is preferably a compound represented by any of the following Formulae (1A) to (1O). (2A) to (2O), (3A), and (3B).

When the compound represented by Formula (1) is a compound represented by any of the following Formulae (1 A) to (1O), (2A) to (2O), (3A), and (3B), raw materials are easily available, and moreover, it is possible to form a lubricating layer having favorable chemical substance resistance and magnetic head flying stability.

In all of the compounds represented by the following Formulae (0A) to (1O), (2A) to (2O), (3A), and (3B), Rf₁ and Rf₂ representing the PFPE chain have the following structures. That is, Rf₁ is the PFPE chain represented by Formula (6-1), and Rf₂ is the PFPE chain represented by Formula (6-2). Here, since j and k in Rf₁ representing the PFPE chain in Formulae (Kr) to (1I), (1L), (1M), (1O), (2G) to (2I). (2L), (2M), and (2O) and 1 in Rf₂ representing the PFPE chain in Formulae (1 A) to (1F). (1J), (1K), (1N), (2A) to (2F), (2J), (2K), (2N), (3A), and (3B) are values indicating an average degree of polymerization, they are not necessarily an integer.

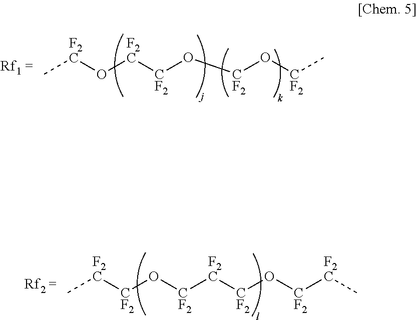

In all of the compounds represented by the following Formulae (1A) to (1O), (2A) to (2O), (3A), and (3B), R¹ and R⁴ are the same.

In all of the compounds represented by the following Formulae (1A) to (1O), (2A) to (2O), (3A), and (3B), two or three R²'s are the same, in all of the compounds represented by the following Formulae (1A) to (1O), (3A), and (3B), x is 1.

In all of the compounds represented by the following Formulae (2A) to (2O), x is 2.

In all of the compounds represented by the following Formulae (2A) to (2O), two R³'s are the same.

In all of the compounds represented by the following Formulae (1A) to (1O). (2A) to (2O), and (3A). R³ is represented by Formula (3-1), and in Formula (3-1), y1 is 1, and y2 is 1. In the compound represented by the following Formula (3B), R³ is represented by Formula (3-2), and in Formula (3-2), y3 is 1 and y4 is 1.

In all of the compounds represented by the following Formulae (1A) to (1O), and (2A) to (2O), R¹ is represented by Formula (3-1), and a is 2.

In all of the compounds represented by the following Formulae (1A) to (1F), (1J), (1K), (1N), (2A) to (2F), (2J), (2K), (2N), (3A), and (3B), the PFPE chain represented by R² is Formula (6-2).

In all of the compounds represented by the following Formulae (1G) to (1I). (1L), (1M), (1O), (2G) to (2I), (2L), (2M), and (2O), the PFPE chain represented by R¹ is Formula (6-1).

In the compound represented by the following Formula (1 A), in Formula (1), R¹ and R³ are the terminal group represented by Formula (4-1), and in Formula (4-1), b is 1, c is 1, and X is a hydroxy group.

In the compound represented by the following Formula (13), in Formula (1), R¹ and R⁴ are the terminal group represented by Formula (4-1), and in Formula (4-1), b is 1, c is 2, and X is a hydroxy group.

In the compound represented by the following Formula (1C), in Formula (1), R¹ and R⁴ are the terminal group represented by Formula (4-1), and in Formula (4-1), b is 2, c is 1, and X is a hydroxy group.

In the compound represented by the following Formula (1D), in Formula (1), R¹ and R⁴ are the terminal group represented by Formula (4-1), and in Formula (4-1), b is 2, c is 2, and X is a hydroxy group.

In the compound represented by the following Formula (1E), in Formula (1), R¹ and R⁴ are the terminal group represented by Formula (4-2), and in Formula (4-2), d is 1, e is 0, f is 1, and X is a hydroxy group.

In the compound represented by the following Formula (1F), in Formula (1), R¹ and R⁴ are the terminal group represented by Formula (4-2), and in Formula (4-2), d is 1, e is 1, f is 1, and X is a hydroxy group.

In the compound represented by the following Formula (1G), in Formula (1), R¹ and R⁴ are the terminal group represented by Formula (4-3), and in Formula (4-3), g is 0, i is 1, and X is a hydroxy group.

In the compound represented by the following Formula (1H), in Formula (1). R¹ and R⁴ are the terminal group represented by Formula (4-3), and in Formula (4-3), g is 0, i is 3, and X is a hydroxy group.

In the compound represented by the following Formula (1I), in Formula (1), R¹ and R⁴ are the terminal group represented by Formula (4-3), and in Formula (4-3), g is 1, h is 1, i is 2, and X is a hydroxy group.

In the compound represented by the following Formula (1J), in Formula (1). R¹ and R⁴ are the terminal group represented by Formula (4-1), and in Formula (4-1), b is 2, c is 0, and X is —CH═CH₂.

In the compound represented by the following Formula (1K), in Formula (1). R¹ and R⁴ are the terminal group represented by Formula (4-2), and in Formula (4-2), d is 1, c is 1, f is 1, and X is —CH═CH₂.

In the compound represented by the following Formula (1L), in Formula (1), R¹ and R⁴ are the terminal group represented by Formula (4-1), and in Formula (4-1), b is 2, c is 2, and X is —CN.

In the compound represented by the following Formula (1M), in Formula (1), R¹ and R⁴ are the terminal group represented by Formula (4-2), and in Formula (4-2), d is 2, e is 1, f is 1, and X is a hydroxy group.

In the compound represented by the following Formula (1N), in Formula (1), R¹ and W are the terminal group represented by Formula (4-3), and in Formula (4-3), g is 1, h is 2, i is 1, and X is a hydroxy group.

In the compound represented by the following Formula (1O), in Formula (1), R⁴ and R¹ are the terminal group represented by Formula (4-1), and in Formula (4-1), b is 2, c is 1, and X is —NHCOCH₃.

In the compound represented by the following Formula (2A), in Formula (1), R¹ and R⁴ are the terminal group represented by Formula (4-1), and in Formula (4-1), b is 1, c is 1, and X is a hydroxy group.

In the compound represented by the following Formula (28), in Formula (1). R¹ and R⁴ are the terminal group represented by Formula (4-1), and in Formula (4-4), b is 1, c is 2, and X is a hydroxy group.

In the compound represented by the following Formula (2C), in Formula (1), R¹ and R⁴ are the terminal group represented by Formula (4-1), and in Formula (4-1), b is 2, c is 1, and X is a hydroxy group.

In the compound represented by the following Formula (2D), in Formula (1). R¹ and R³ are the terminal group represented by Formula (4-1), and in Formula (4-1), b is 2, c is 2, and X is a hydroxy group.

In the compound represented by the following Formula (2E), in Formula (1), R¹ and R⁴ are the terminal group represented by Formula (4-2), and in Formula (4-2), d is 1, e is 0, f is 1, and X is a hydroxy group.

In the compound represented by the following Formula (2F), in Formula (1). R¹ and R⁴ are the terminal group represented by Formula (4-2), and in Formula (4-2), d is 1, e is 1, f is 1, and X is a hydroxy group.

In the compound represented by the following Formula (2O), in Formula (1), R¹ and R⁴ are the terminal group represented by Formula (4-3), and in Formula (4-3), g is 0, i is 1, and X is a hydroxy group.

In the compound represented by the following Formula (2H), in Formula (1), R¹ and R⁴ are the terminal group represented by Formula (4-3), and in Formula (4-3), g is 0, i is 3, and X is a hydroxy group.

In the compound represented by the following Formula (2I), in Formula (1), R¹ and R⁴ are the terminal group represented by Formula (4-3), and in Formula (4-3), g is 1, h is 1, i is 2, and X is a hydroxy group.

In the compound represented by the following Formula (2J), in Formula (1). R¹ and R¹ are the terminal group represented by Formula (4-1), and in Formula (4-1), b is 2, c is 0, and X is —CH═CH₂.

In the compound represented by the following Formula (2K), in Formula (1), R¹ and R⁴ are the terminal group represented by Formula (4.2), and in Formula (4-2), d is 1, e is 1, f is 1, and X is —CH═CH₂.

In the compound represented by the following Formula (2L), in Formula (1), R¹ and R⁴ are the terminal group represented by Formula (4-1), and in Formula (4-1), b is 2, c is 2, and X is —CN. In the compound represented by the following Formula (2M), in Formula (1), R¹ and R¹ are the terminal group represented by Formula (4-2), and in Formula (4-2), d is 1, e is 0, f is 1, and X is —CN.

In the compound represented by the following Formula 2N), in Formula (1). R¹ and R⁴ are the terminal group represented by Formula (4-3), and in Formula (4-3), g is 1, h is 2, i is 1, and X is a hydroxy group.

In the compound represented by the following Formula (2O), in Formula (1). R¹ and R⁴ are the terminal group represented by Formula (4-1), and in Formula (4-1), b is 2, c is 1, and X is —NHCOCH₃.

In the compound represented by the following Formula (3A), in Formula (1), R¹ and R⁴ are the terminal group represented by Formula (4-1), and in Formula (4-1), b is I, c is 2, and X is a hydroxy group. In Formula (1), R³ is a linking group represented by Formula (3-1), and in Formula (3-1), a is 4.

In the compound represented by the following Formula (3B), in Formula (I), R¹ and R⁴ are the terminal group represented by Formula (4-1), and in Formula (4-1), b is 1, c is 2, and X is a hydroxy group. In Formula (1), R³ is a linking group represented by Formula (3-2).

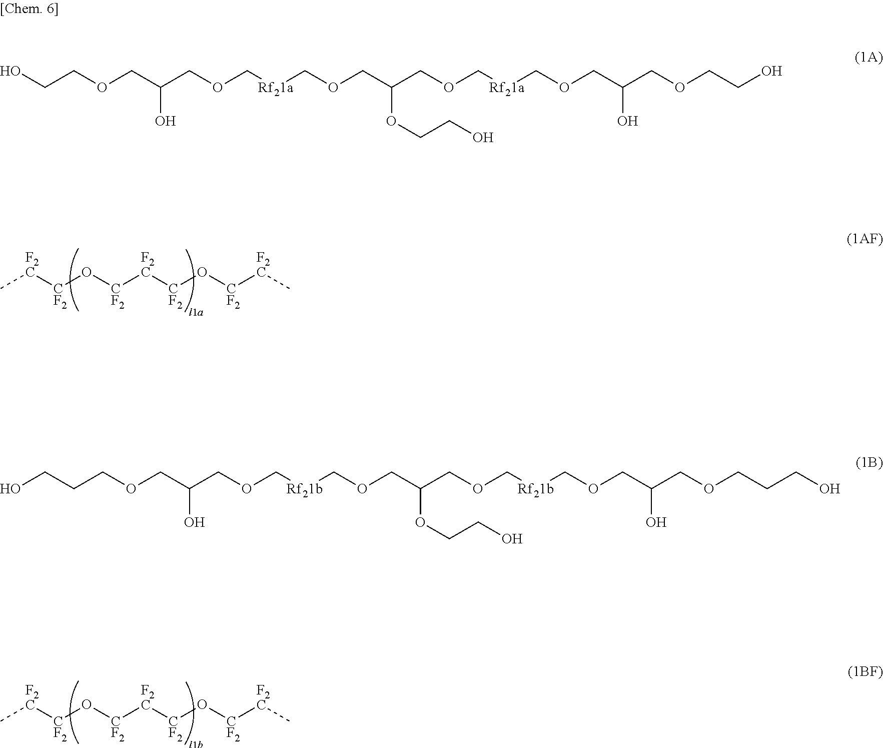

(in formula (1A), Rf₂1a is represented by Formula (1AF); in Rf₂1a, I1a indicates an average degree of polymerization and represents 0.1 to 15; and in Formula (1A), in two Rf₂1a's, I1a's may be the same as or different from each other).
(in Formula (1B), Rf₂1b is represented by Formula (1BF); in Rf₂1b, 11b indicates an average degree of polymerization and represents 0.1 to 15; and in Formula (1B), in two Rf₂1b's, 11b's may be the same as or different from each other).

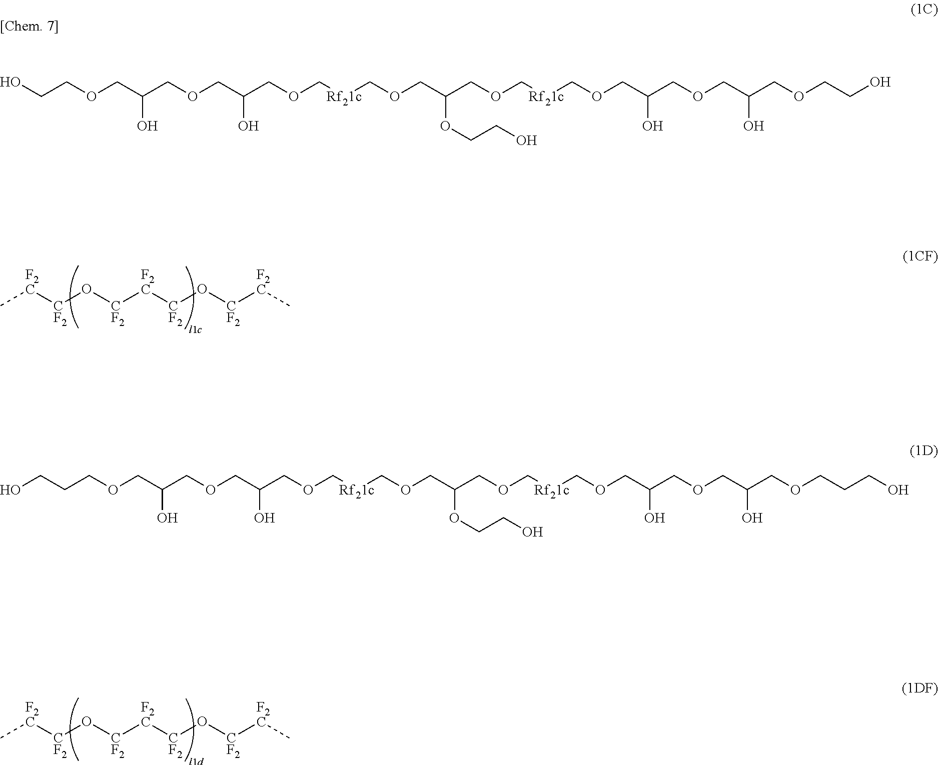

(in Formula (1C), Rf₂1c is represented by Formula (1CF); in Rf₂1c, 11c indicates an average degree of polymerization and represents 0.1 to 15, and in Formula (1C), in two Rf₂1c's, 11e's may be the same as or different from each other).
(in Formula (1 D), Rf₂1d is represented by Formula (1DF): in Rf₂1d, id indicates an average degree of polymerization and represents 0.1 to 15; and in Formula (1D), in two Rf₂1d's, 11d's may be the same as or different from each other).

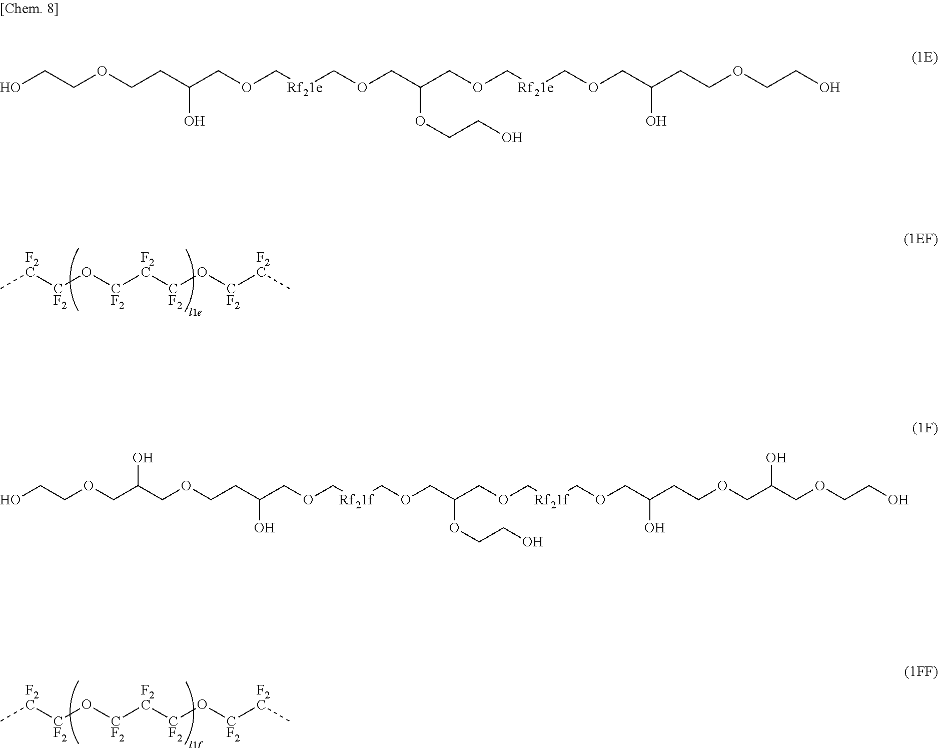

(in Formula (1E), Rf₂1e is represented by Formula (1EF); in Rf₂1e, 11e indicates an average degree of polymerization and represents 0.1 to 15; and in Formula (1E), in two Rf₂1e's, 11e's may be the same as or different from each other).
(in Formula (1F), Rf₂If is represented by Formula (1FF); in Rf₂1f, 11f indicates an average degree of polymerization and represents 0.1 to 15; and in Formula (1F), in two Rf₂1f's, 11f's may be the same as or different from each other).

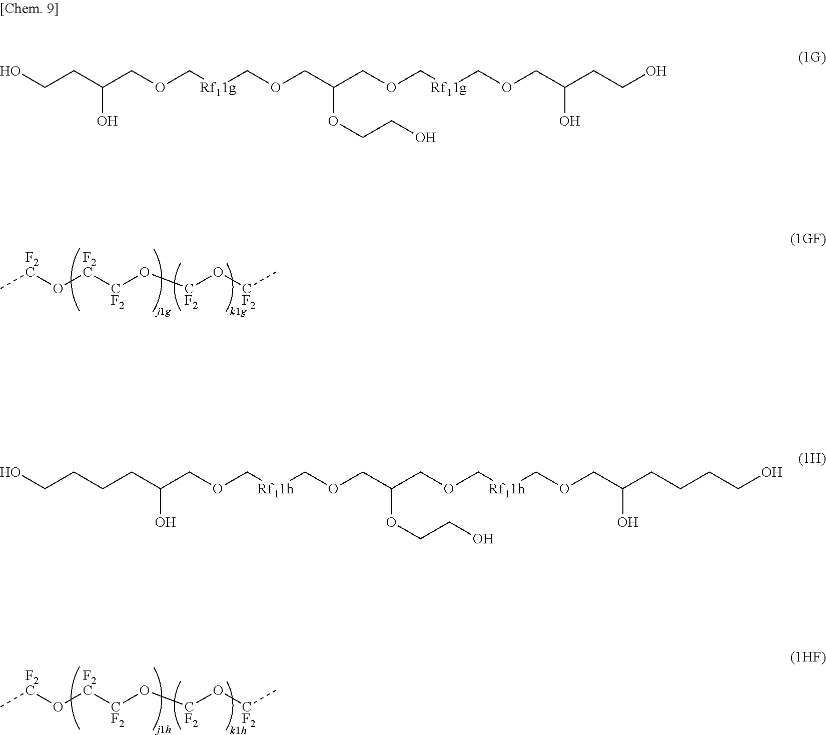

(in Formula (1G), Rf₁1 is represented by Formula (1GP); in Rf₁1g, j1g and k1g indicate an average degree of polymerization, j1g represents 0.1 to 020, and k1g represents 0 to 20; and in formula (1G), in two Rf₁1g's, j1g's and k1g's may be the same as or different from each other).
(in Formula (1H) Rf₁1h is represented by Formula (1HF); in Rf₁1h, j1g and k1h indicate an average degree of polymerization, j1h represents 0.1 to 20, and k1h represents 0 to 20, and in Formula (1H), in two Rf₁1h's, j1h's and k1h's may be the same as or different from each other).

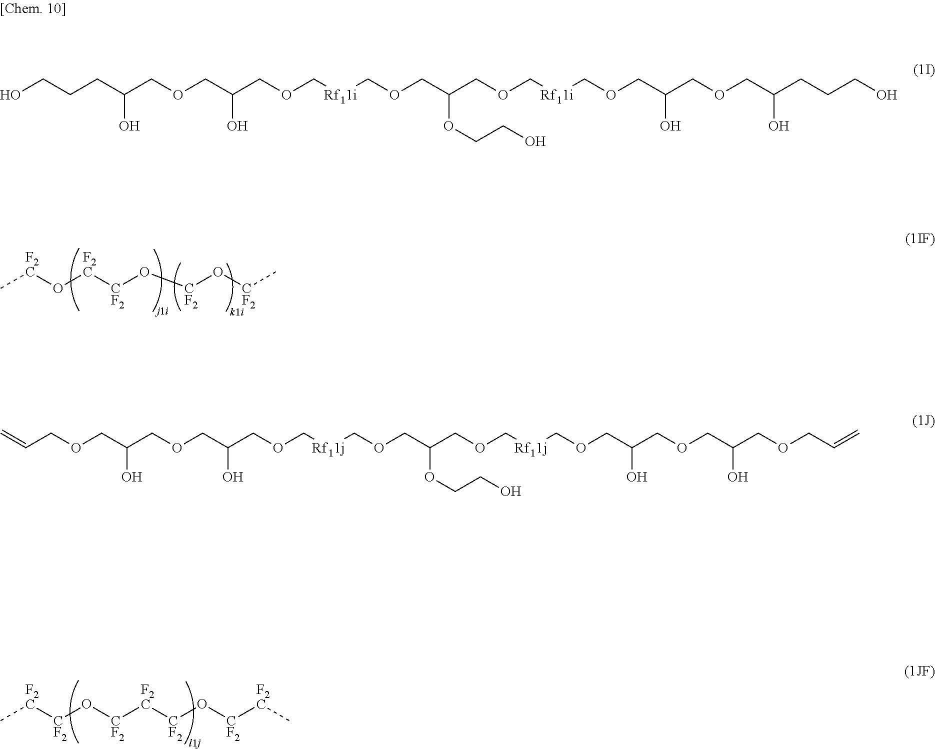

(in Formula (1I), Rf₁1i is represented by Formula (11F); in Rf₁1i, j1i and k1i indicate an average degree of polymerization, j1i represents 0.1 to 20, and k1i represents 0 to 20; and in Formula (1I), in two Rf₁1i's, j1i's and k1i's may be the same as or different from each other).
(in Formula (03), Rf₂1j is represented by Formula (1JF); in Rf₂1j, 11j indicates an average degree of polymerization and represents 0.1 to 15; and in Formula (13), in two Rf₁1j's, 11j's may be the same as or different from each other).

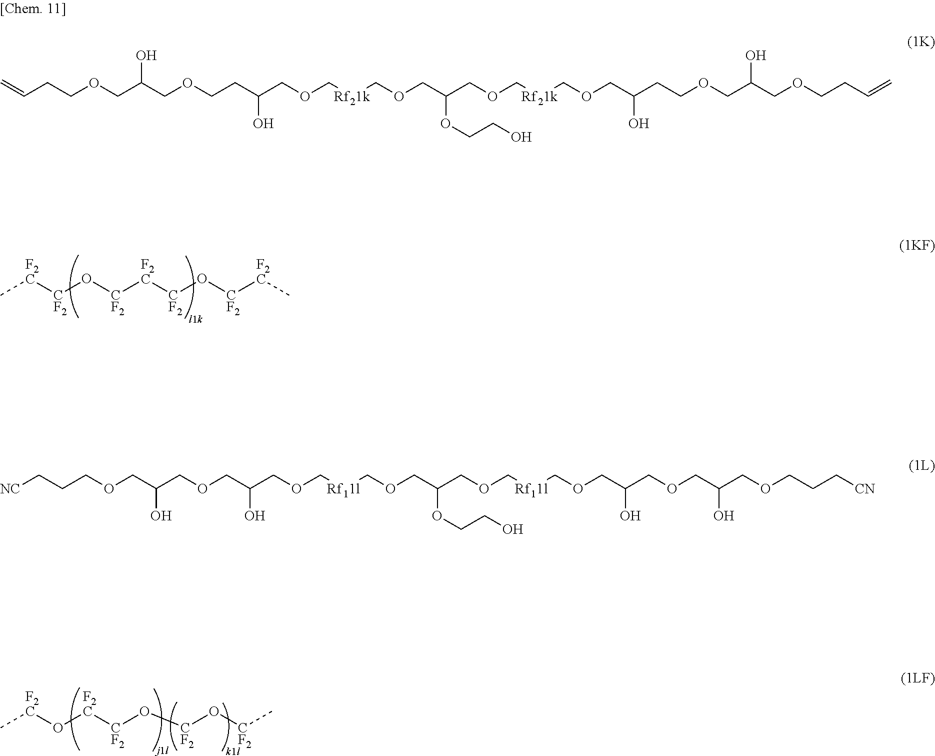

(in Formula (1K), Rf₂1k is represented by Formula (1KF); in Rf₂1k, 11k indicates an average degree of polymerization and represents 0.1 to 15, and in Formula (1K), in two Rf₂1k's, 11k's may be the sane as or different from each other).
(in Formula (1, Rf₁11 is represented by Formula (1LF); in Rf₁11, j1I and k1I indicate an average degree of polymerization, j11 represents 0.1 to 20, and k11 represent 0 to 20; and in Formula (1L), in two Rf₁11's, j11's and k11's may be the same as or different from each other).

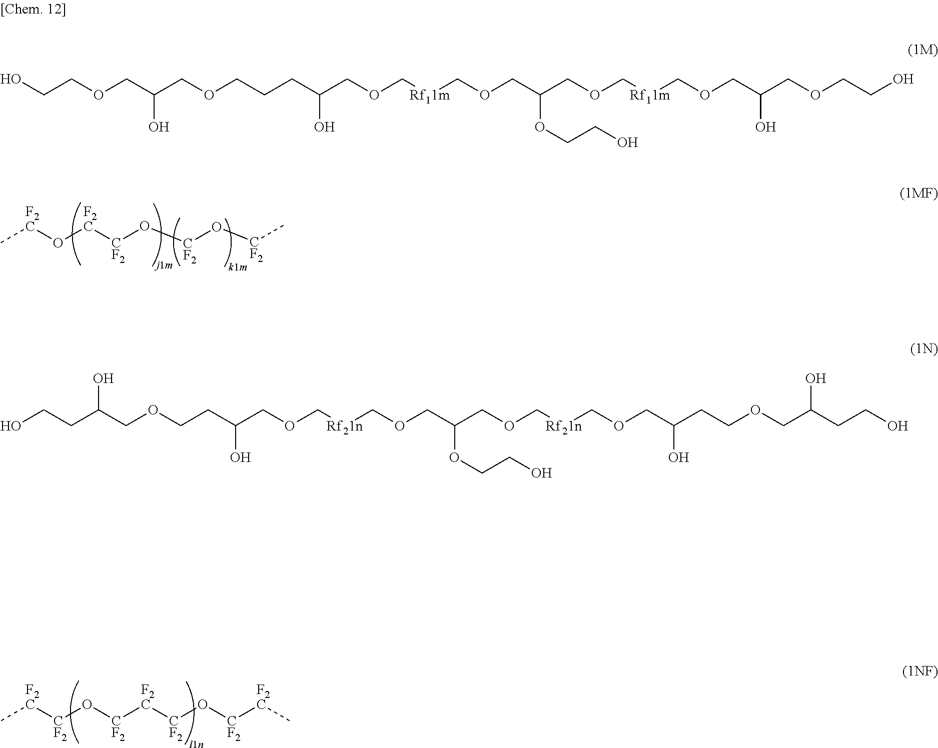

(in Formula (1M), Rf₁1m is represented by Formula (1MF): in Rf₁1m, j1m and k1m indicate an average degree of polymerization, j1n represents 0.1 to 20, and k1i represents 0 to 20; and in Formula (11M), in two Rf₁1m's, j1m's and k1m's may be the same as or different from each other).
(in Formula (1N), Rf₂1n is represented by Formula (1NF); in Rf₁1n, 11n indicates an average degree of polymerization and represents 0.1 to 15; and in Formula (1N), in two Rf₂1n's, 11n's may be the same as or different front each other).

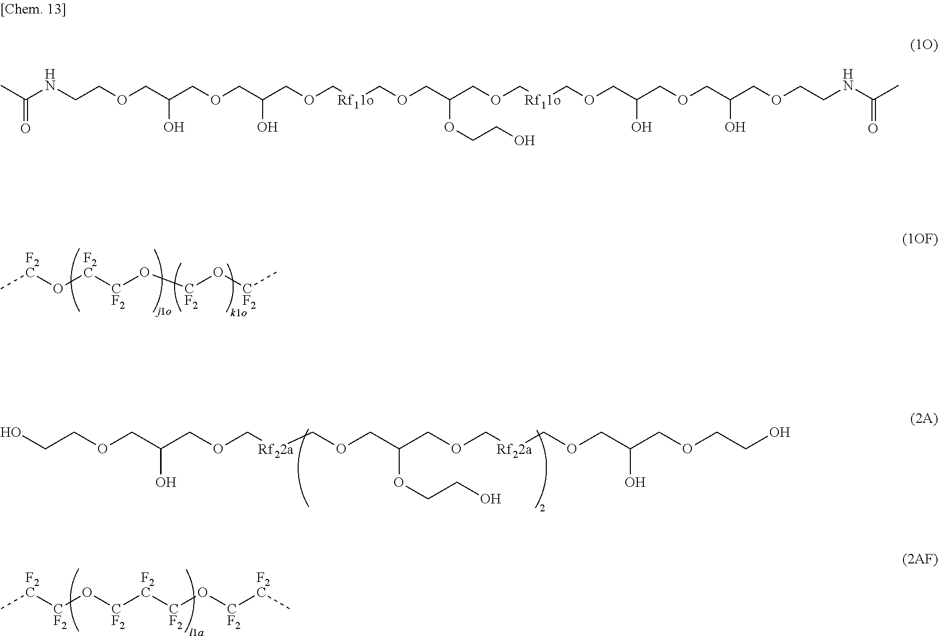

(in Formula (1O), Rf₁1o is represented by Formula (10F); in Rf₁1o, j1o and k1o indicate an average degree of polymerization, j1o represents 0.1 to 20, and k1o represents 0 to 20; and in Formula (1O), in two Rf₁1o's, j1o's and k1o's may be the same as or different from each other).
(in Formula (2A), Rf₂2a is represented by Formula (2AF); in Rf₂2a, 12a indicates an average degree of polymerization and represents 0.1 to 15; and in Formula (2A), in three Rf₂a's 12a's may be different from each other, or some or all of them may be the same).

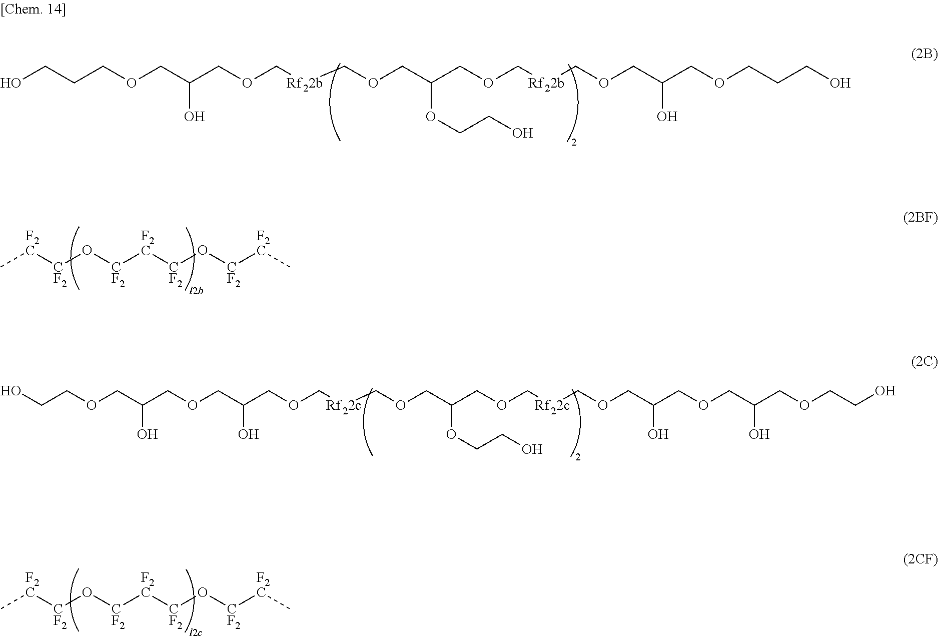

(in Formula 2 ft, R²2b s represented by Formula (2BF); in Rf₂1b, 12b indicates an average degree of polymerization and represents 0.1 to 15; and in Formula (28), in three Rf₂2b's, 12b's may be different from each other, or some or all of them may be the same).
(in Formula (2C), Rf₂2c is represented by Formula (2CF); in Rf₂2c, 12c indicates an average degree of polymerization and represent 0.1 to 15; and in Formula (2C), in three Rf₂ 2c's, 12c's may be different from each other, or some or all of them may be the same).

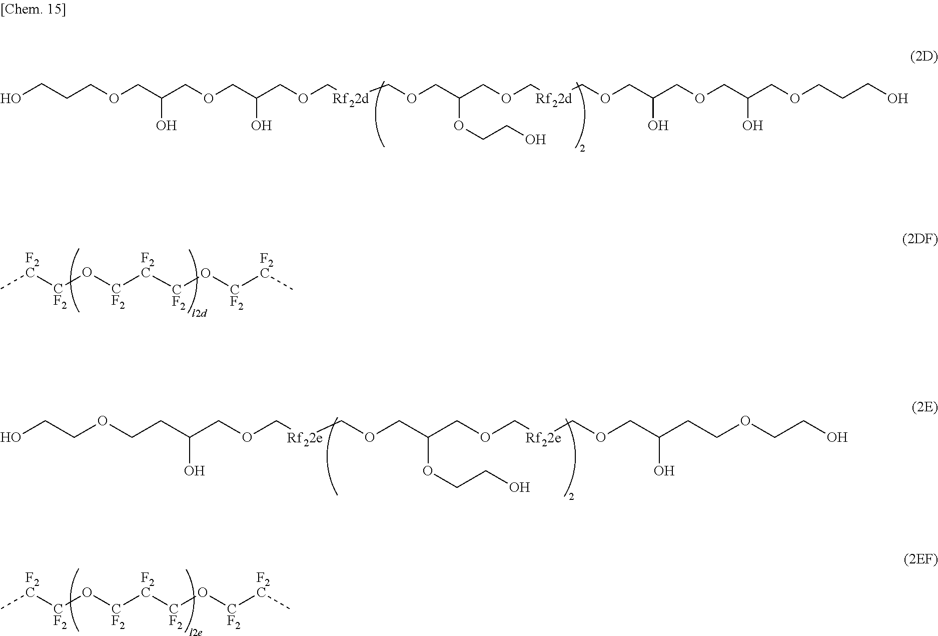

(in Formula (2D), Rf₂2d is represented by Formula (2DF); in Rf₂2d, 12d indicates an average degree of polymerization and represents 0.1 to 15, and in Formula (2D) in three Rf₂2d's, 12d's may be different from each other, or some or all of them may be the same).
(in Formula (2E), Rf₂2e is represented by Formula (2EF); in Rf₂2e, 12e indicate, an average degree of polymerization and represents 0.1 to 15; and in Formula (2E), in three Rf₂2e's, 12e's may be different from each other, or some or all of them may be the same).

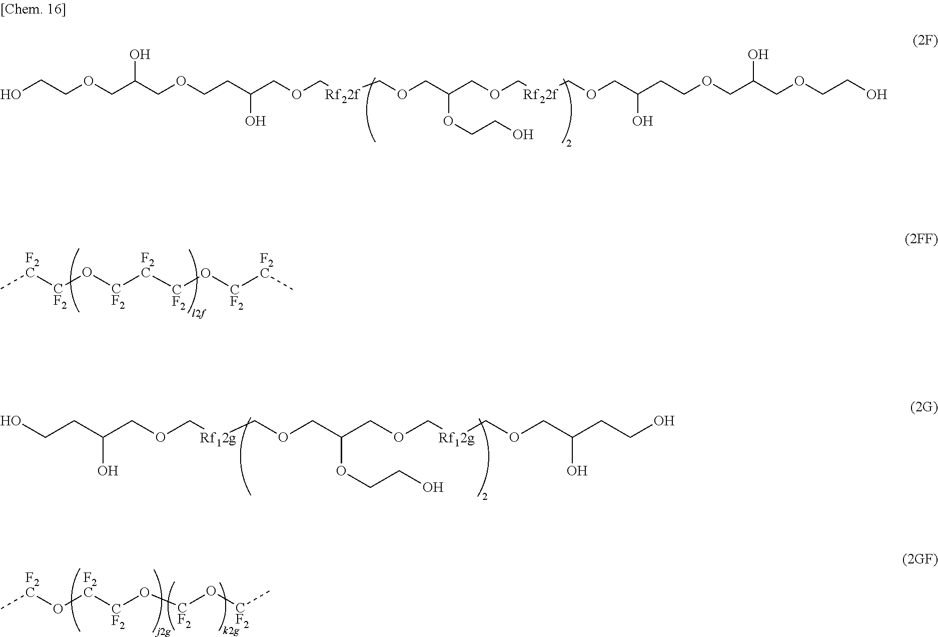

(in Formula (2F), Rf₂2f is represented by Formula (21F); in Rf₂2f, 12f indicates an average degree of polymerization and represents 0.1 to 15; and in Formula (2F), in three Rf₂2f's, 12f's may be different from each other, or some or all of them may be the same).
(in Formula (2G), Rf₁2g is represented by Formula (2GF); in Rf₁2g, j2g and k2g indicate an average degree (if polymerization, j2g represents 0.1 to 20, and k2g represents 0 to 20; and in Formula (2G), in three Rf₁2g's, j2g's and k2g's may be different from each other, or some or all of them may be the same).

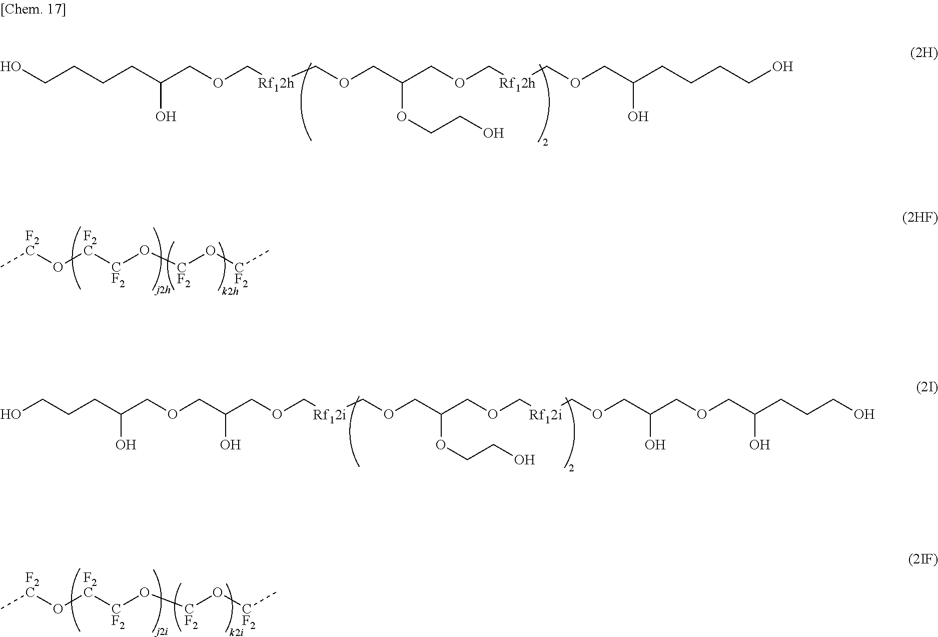

(i Formula (2H), Rf₁2h represented by Formula (2HF); in Rf₁2h j2h and k2h indicate an average degree of polymerization, j2 h represents 0.1 to 20, and k2 h represents 0 to 20; and in Formula (2H), in three Rf₁2 h's, j2h's and k2h's may be different from each other, or some or all of them may be the same).
(in Formula (2I), Rf₁2i is represented by Formula (21F); in Rf₁2i, j2i and k2i indicate an average degree of polymerization, j2i represents 0.1 to 20, and k2i represent 0 to 20; and
in Formula (2I), in three Rf₁2i's, j2i's and k2i's may be different from each other, or some or all of then may be the same).

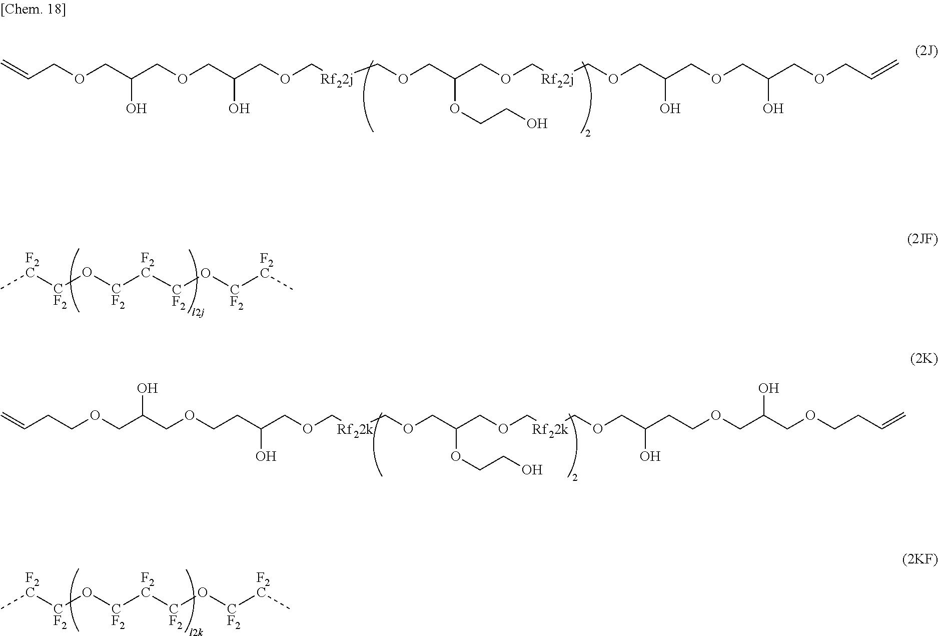

(in Formula (2I), Rf₂2j is represented by Formula (20F); in Rf₂2j, 12j indicates an average degree of polymerization and represents 0.1 to 15; and in Formula (2J), in three Rf₂2j's, 12j's may be different from each other, or some or all of them may be the same).
(in Formula (2K), Rf₂2k is represented by Formula (2KF): in Rf₂2k, 12k indicates an average degree of polymerization and represents 0.1 to 15; and in Formula (2K), in three Rf₂2k's, 12k's may be different from each other, or some or all of them may be the same).

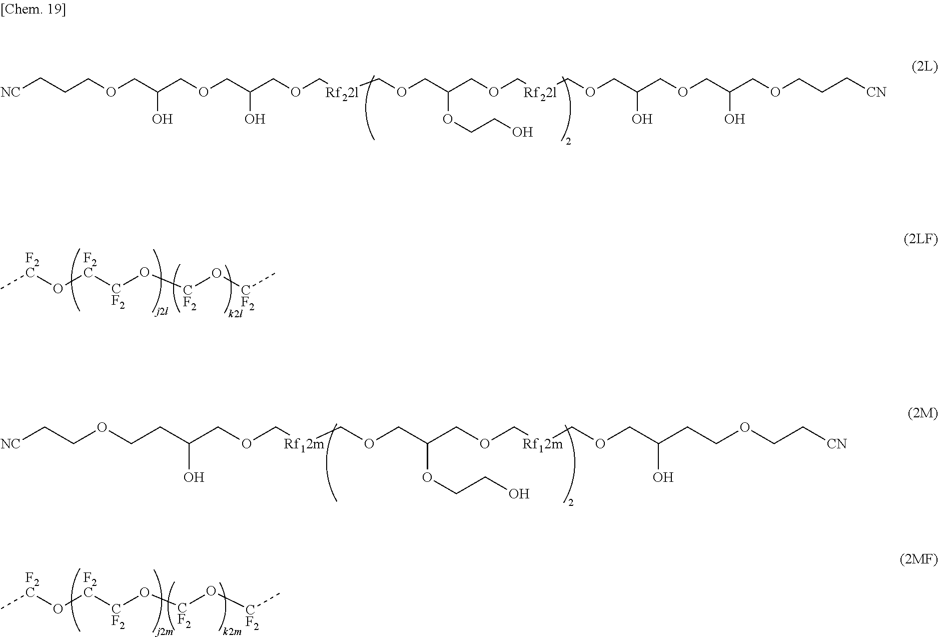

(in Formula (2L), Rf₁2l is represented by Formula (2LF): in Rf₁21, j2l and k2l indicate an average degree of polymerization, j2l represents 0.1 to 20, and k2l represents 0 to 20; and in Formula (2L), in three Rf₁21's, j2l's and k2l's may be different from each other, or some or all of them may be the same).
(in Formula (2M), Rf₁2m is represented by Formula (2MF); in Rf₁2m, j2m and k2m indicate an average degree of polymerization, j2m represents 0.1 to 20, and k2m represents 0 to 20; and in Formula (2M), in three Rf₁2m's, j2m's and k2m's may be different from each other, or some or all of them may be the same).

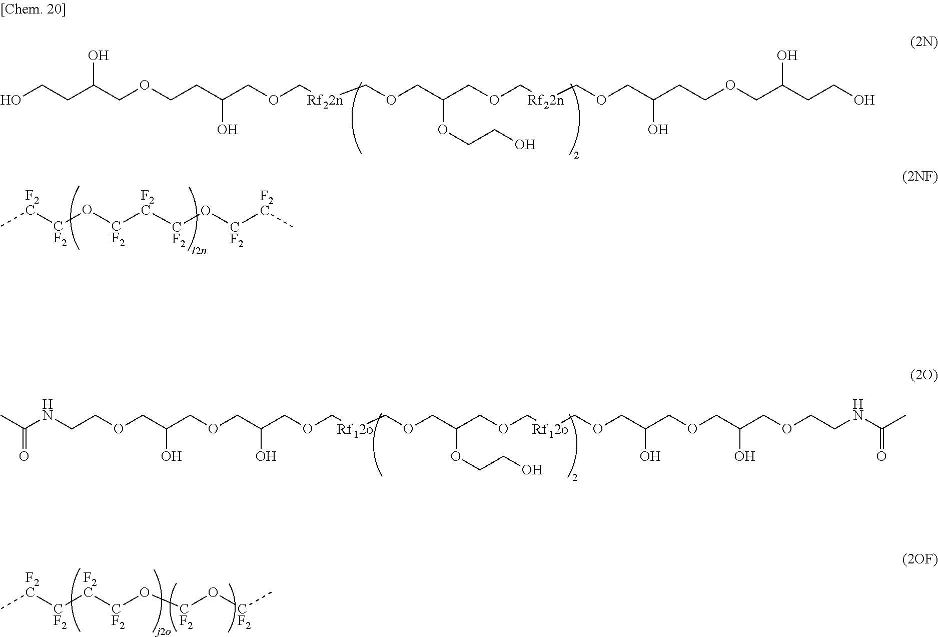

(in Formula (2N), Rf₂2n is represented by Formula (2NF); in Rf₂2n, 12n indicates an average degree of polymerization and represents 0.1 to 15; and in Formula (2N), in three Rf₂2n's, l2n's may be different from each other, or some or all of them may be the same).
(in Formula (2O), Rf_{E}2o is represented by Formula (20F): in Rf₂2o, j2o and k2o indicate an average degree of polymerization, j2o represents 0.1 to 20, and k2o represents 0 to 20; and in Formula (2O), in three Rf₁2o's, j2o's and k2o's may be different from each other, or some or all of them may be the sane).

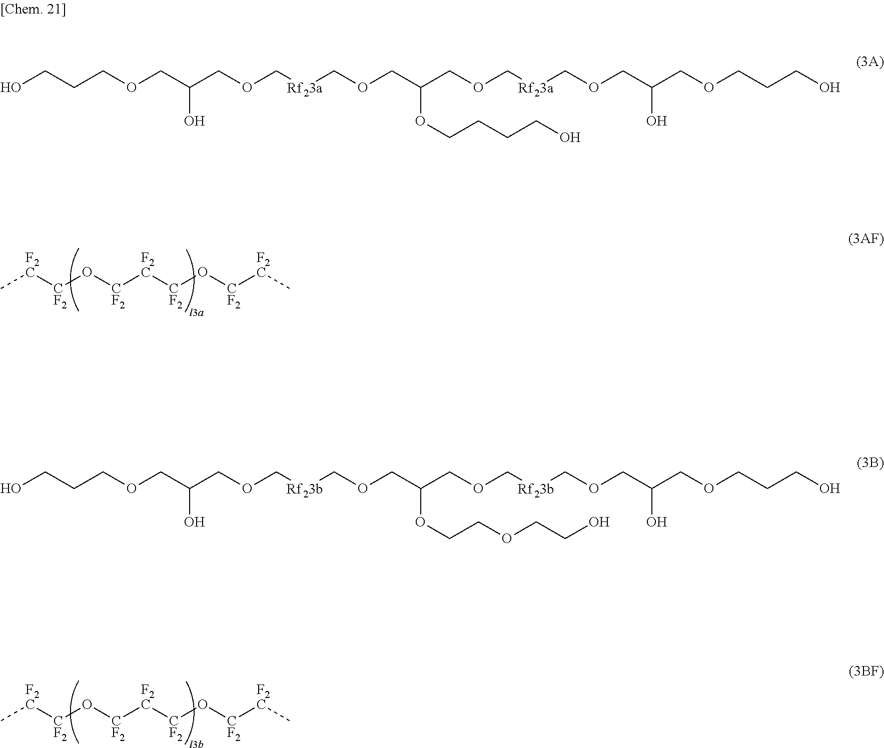

(in Formula (3A) Rf₂3a is represented by Formula (3AF); in Rf₂3a, 13n indicates an average degree of polymerization and represents 0.1 to 15; and in Formula (3A), in two Rf₂3a's, 13a's may be the same as or different from each other).
(in Formula (3B), Rf 3b is represented by Formula (3BF); in Rf₂3b, 13b indicates an average degree of polymerization and represents 0.1 to 15; and in Formula (3W), in two Rf₂3b's, 13b's may be the same as or different from each other).

The number-average molecular weight (Mn) of the fluorine-containing ether compound of the present embodiment is preferably in a range of 500 to 10,000 and particularly preferably in a range of 600 to 5,000. When the number-average molecular weight is 500 or more, the lubricating layer composed of the lubricant containing the fluorine-containing ether compound of the present embodiment has excellent heat resistance. The number-average molecular weight of the fluorine-containing ether compound is more preferably 600 or more. In addition, when the number-average molecular weight is 10,000 or less, the viscosity of the fluorine-containing ether compound becomes appropriate, and when a lubricant containing this is applied, a lubricating layer having a thin film thickness can be easily formed. The number-average molecular weight of the fluorine-containing ether compound is preferably 5,000 or less because the viscosity becomes one that makes the lubricant easy to handle.

The number-average molecular weight (Mn) of the fluorine-containing ether compound is a value measured through ¹H-NMR and ¹⁹F-NMR using a AVANCE III 400 (commercially available from Bruker BioSpin. Specifically, the number of repeating units of the PFPE chain is calculated from the integrated value measured by ¹⁹F-NMR to obtain a number-average molecular weight. In the measurement of nuclear magnetic resonance (NMR), a sample is diluted with a hexafluorobenzene/d-acetone(4/lv/v) solvent and used for measurement. The reference for ¹⁹F-NMR chemical shift is −164.7 ppm for the peak of hexafluorobenzene, and the reference for ¹H-NMR chemical shift is 2.2 ppm for the peak of acetone.

The fluorine-containing ether compound of the present embodiment preferably has a molecular weight dispersity (a ratio of the weight-average molecular weight (Mw)/the number-average molecular weight (Mn)) of 1.3 or less by molecular weight fractionation by an appropriate method.

In the present embodiment, the method for molecular weight fractionation is not particularly limited, and for example, molecular weight fractionation using a silica gel column chromatography method, a gel permeation chromatography (GPC) method or the like, molecular weight fractionation using a supercritical extraction method or the like can be used.

### “Production Method”

The method of producing the fluorine-containing ether compound of the present embodiment is not particularly limited, and conventionally known production methods can be used for production. The fluorine-containing ether compound of the present embodiment can be produced using, for example, the following production methods.

### [First Production Method]

When a compound in which x in Formula (1) is 1 is produced, the following production method can be used.

### <When Two R²'s are the Same>

### (First Reaction)

When a compound in which two R²s in Formula (1) are the same perfluoropolyether chain is produced, a fluorine-based compound in which hydroxymethyl groups (—CH₂OH) are arranged at both terminals of a perfluoropolyether chain corresponding to R² in Formula (1) is prepared. Next, a protecting group such as a tetrahydropyranyl (THP) group is introduced into a hydroxy group of a hydroxymethyl group arranged at one terminal of the fluorine-based compound to obtain an intermediate compound 1-1.

### (Second Reaction)

Next, the terminal hydroxy group of the intermediate compound 1-1 is reacted with a halogen compound having an epoxy group corresponding to a main chain moiety for R³. Accordingly, an intermediate compound 1-2 which has a linking group corresponding to a main chain moiety for R³ in the center and a perfluoropolyether chain corresponding to R² bonded to both ends via a methylene group is produced. In the intermediate compound 1-2, in the linking group corresponding to a main chain moiety for R³ one secondary hydroxy group generated by the reaction between the terminal hydroxy group of the intermediate compound 1-1 and the epoxy group of the halogen compound is arranged.

As the halogen compound having an epoxy group corresponding to a main chain moiety for R³, for example, when R³ is represented by Formula (3-1), and y1 and y2 in Formula (3-1) are both 1 or when R³ is represented by Formula (3-2) and y3 and y4 in Formula (3-2) are both 1, epibromohydrin or epichlorohydrin can be used.

### <When Two R²'s are Different>

When a compound in which two R²'s in Formula (1) are different perfluoropolyether chains is produced, the following reactions are performed as the first reaction and the second reaction.

### (First Reaction)

In the same manner as the first reaction when two R²'s are the same, a first intermediate compound 1-1-1 having a perfluoropolyether chain corresponding to R² on the side of R¹ is produced. In addition, in the same manner as the first reaction when two RN's are the same, a second intermediate compound 1-1-2 having a perfluoropolyether chain corresponding to R² on the side of R⁴ is produced.

### (Second Reaction)

A compound obtained by reacting the terminal hydroxy group of the first intermediate compound 1-1-1 with a halogen compound having an epoxy group corresponding to a main chain moiety for R³ is reacted with the terminal hydroxy group of the second intermediate compound 1-1-2. In addition, a compound obtained by reacting the terminal hydroxy group of the second intermediate compound 1-1-2 with a halogen compound having an epoxy group corresponding to a main chain moiety for R³ is reacted with the terminal hydroxy group of the first intermediate compound 1-1-1.

Accordingly, an intermediate compound 1-2-2 which has a linking group corresponding to a main chain moiety for R³ in the center, a perfluoropolyether chain corresponding to R² on the side of R¹ bonded to one end via a methylene group and a perfluoropolyether chain corresponding to R² on the side of R⁴ bonded to the other end via a methylene group is produced. In the intermediate compound 1-2-2 in which two R²'s are different, in the linking group corresponding to a main chain moiety for R³, one secondary hydroxy group generated by the reaction between the terminal hydroxy group of the first intermediate compound 1-1-1 or the terminal hydroxy group of the second intermediate compound 1-1-2 and the epoxy group of the halogen compound is arranged.

### (Third Reaction)

Then, in the intermediate compound 1-2 in which two R²'s are the same (or the intermediate compound 1-2-2 in which two R²'s are different), the secondary hydroxy group arranged in the main chain moiety for R³ is converted into a primary hydroxy group by chemical modification.

An intermediate compound 1-3 is produced by reacting a halogen compound with a structure corresponding to a side chain moiety for R¹ and a protecting group introduced into a terminal primary hydroxy group with a secondary hydroxy group of a linking group corresponding to a main chain moiety for R³ of the intermediate compound 1-2 (or intermediate compound 1-2-2).

As a halogen compound with a structure corresponding to a side chain moiety for R³ and a protecting group introduced into a terminal primary hydroxy group, for example, when R¹ is represented by Formula (3-1), BnO(CH₂)ₐBr (Bn represents a benzyl group, and a is an integer of 2 to 4) and the like can be used. As the halogen compound, for example, when R³ is represented by Formula (3-2), BnO(CH₂)₂O(CH₂)₂Br(Bn represents a benzyl group) can be used.

### (Fourth Reaction)

Next, the protecting groups (for example THP groups) bonded to both terminals of the intermediate compound 1-3 are removed by a known method to obtain an intermediate compound 1-4. For example, when a THP group is introduced as a protecting group, the THP group can be removed by a method using an acid such as a mixed solution containing hydrogen chloride and methanol.

<When R¹ and R⁴ are the Same>

### (Fifth Reaction)

When R¹ and R⁴ in Formula (1) are the same, the terminal hydroxy group of the intermediate compound 1-4 is reacted with an epoxy group of an epoxy compound having a group corresponding to R¹-(=a group corresponding to R⁴—). Accordingly, an intermediate compound 1-5 having a group corresponding to R¹-(=a group corresponding to R⁴—) via a methylene group at both terminals of a framework of a chain structure in which R² is bonded to both ends of a linking group corresponding to a main chain moiety for R³ via a methylene group is produced.

<When R¹ and R⁴ are Different>

When R¹ and R⁴ in Formula (1) are different, the following reaction is performed as the fifth reaction.

### (Fifth Reaction)

One terminal hydroxy group of the intermediate compound 1-4 is reacted with an epoxy group of an epoxy compound having a group corresponding to R¹—, and the other terminal hydroxy group is then reacted with an epoxy group of an epoxy compound having a group corresponding to R⁴—. In addition, one terminal hydroxy group of the intermediate compound 1-4 is reacted with an epoxy group of an epoxy compound having a group corresponding to R⁴—, and the other terminal hydroxy group is then reacted with an epoxy group of an epoxy compound having a group corresponding to R¹—, Accordingly, an intermediate compound 1-5-2 having a group corresponding to R¹— via a methylene group at one terminal of a framework of a chain structure in which R² is bonded to both ends of a linking group corresponding to a main chain moiety for R³ via a methylene group and a group corresponding to R¹—via a methylene group at the other terminal is produced.

The epoxy compound having a group corresponding to R¹— (or group corresponding to R⁴—) in Formula (1) used in the fifth reaction can be synthesized by, for example, a method of reacting an alcohol having a structure corresponding to R, (or R⁴) of a fluorine-containing ether compound to be produced with a compound having any epoxy group selected from among epichlorohydrin, epibromohydrin, 2-bromoethyloxirane, and allyl glycidyl ether. Such an epoxy compound may be synthesized by a method of oxidizing an unsaturated bond, and a commercial product may be purchased and used.

In the fifth reaction, the epoxy compound having a group corresponding to R¹— (or group corresponding to R⁴—) in Formula (1) may be reacted with an intermediate compound 1-4 after a hydroxy group of a group corresponding to R¹— (or group corresponding to R⁴—) is protected using an appropriate protecting group. Examples of protecting groups that protect a hydroxy group of an epoxy compound include a tetrahydropyranyl (THP) group and a methoxymethyl (MOM) group.

### (Sixth Reaction)

Finally, all protecting groups introduced into the intermediate compound 1-5 (or intermediate compound 1-5-2) are removed by a conventionally known method. For example, when a Bn group is introduced as a protecting group into the terminal primary hydroxy group in the structure corresponding to R³ of the intermediate compound 1.5 (or the intermediate compound 1-5-2), a method of reacting with palladium on carbon (Pd/C) under acidic conditions can be used for deprotection. In addition, when a THP group is introduced as a protecting group into the structure corresponding to R¹ and R⁴ of the intermediate compound 1-5 (or the intermediate compound 1-5-2), the THP group can also be removed together with the Bn group by a method of reacting with palladium on carbon under acidic conditions. In addition, when MOM groups are introduced as protecting groups into the structures corresponding to R¹ and R⁴ of the intermediate compound 1-5 (or the intermediate compound 1-5-2), for example, a method using an acid such as a mixed solution containing hydrogen chloride and methanol can be used for removal.

When the above step is performed, a compound in which x in Formula (1) is 1 can be produced.

### [Second Production Method]

When a compound in which x in Formula (1) is 2 is produced, the following production method can be used.

### <When Main Chain Moieties for Two R³'s are the Same>

### (First Reaction)

A fluorine-based compound in which hydroxymethyl groups (—CH₂OH) are arranged at both terminals of a perfluoropolyether chain corresponding to R² in the center among three R²'s in Formula (1) is prepared. Next, hydroxy groups of hydroxymethyl groups arranged at both terminals of the fluorine-based compound are reacted with a halogen compound having an epoxy group corresponding to a main chain moiety for R³. Accordingly, an intermediate compound 2-1 having epoxy groups at both terminals of a perfluoropolyether chain corresponding to R² is obtained.

As the halogen compound having an epoxy group corresponding to a main chain moiety for R⁴, for example, when R³ is represented by Formula (3-1), and y1 and y2 in Formula (3-1) are both 1 or when R³ is represented by Formula (3-2) and y3 and y4 in Formula (3-2) are both 1, epibromohydrin or epichlorohydrin can be used.

### <When Main Chain Moieties for Two R³'s are Different>

### (First Reaction)

When a compound in which the main chain moieties for two R³'s in Formula (1) are different is produced, the following reaction is performed as the first reaction.

A hydroxy group of a hydroxymethyl group of a fluorine-based compound in which hydroxymethyl groups (—CH₂OH) are arranged at both terminals of a perfluoropolyether chain corresponding to R² in the center is reacted with a halogen compound having an epoxy group corresponding to a main chain moiety for R³ on the side of R¹, and purification is then performed. Accordingly, an intermediate compound having an epoxy group corresponding to a main chain moiety for R³ on the side of R¹ at one terminal of a perfluoropolyether chain corresponding to R¹ and a hydroxy group at the other terminal is obtained. Next, the obtained intermediate compound is reacted with a halogen compound having an epoxy group corresponding to the main chain moiety for R³ on the side of R⁴.

Accordingly, an intermediate compound 2-1-2 having an epoxy group corresponding to a main chain moiety for R³ on the side of R¹ at one terminal of a perfluoropolyether chain corresponding to R² and an epoxy group corresponding to a main chain moiety for R³ on the side of R⁴ at the other terminal is obtained. The intermediate compound 2-1-2 may be produced by a method of reacting a compound obtained by reacting the hydroxy group of the hydroxymethyl group of the fluorine-based compound with a halogen compound having an epoxy group corresponding to a main chain moiety for R³ on the side of R⁴ and then performing purification with a halogen compound having an epoxy group corresponding to a main chain moiety for R³ on the side of R¹.

As the halogen compound having an epoxy group corresponding to a main chain moiety for R³ on the side of R¹ (or R³ on the side of R⁴), for example, when R³ is represented by Formula (3-1), and y1 and y2 in Formula (3-4) are both 1 or when R³ is represented by Formula (3-2) and y3 and y4 in Formula (3-2) are both 1, epibromohydrin or epichlorohydrin can be used.

As the halogen compound having an epoxy group corresponding to a main chain moiety for R³ on the side of R¹, for example, when R³ on the side of R¹ is represented by Formula (3-1), and in Formula (3-1), y1 is 1 and y2 is 2, or when R³ on the side of R¹ is represented by Formula (3-2), and in Formula (3-2), y3 is 1 and y4 is 2, 2-(2-chloroethyl)oxirane and 2-(2-bromoethyl)oxirane can be used. In addition, when R¹ on the side of R¹ is represented by Formula (3-1), and in Formula (3-1), y1 is 1 and y2 is 3, or when R³ on the side of R¹ is represented by Formula (3-2), and in Formula (3-2), y3 is 1 and y4 is 3, (3-chloropropyl)oxirane and (3-bromopropyl)oxirane can be used.

As the halogen compound having an epoxy group corresponding to a main chain moiety for R³ on the side of R¹, for example, when R³ on the side of R⁴ is represented by Formula (3-1), and in Formula (3-1), y1 is 2 and y2 is 1, or when R³ on the side of R⁴ is represented by Formula (3-2), and in Formula (3-2), y3 is 2 and y4 is 1, 242-chloroethyl)oxirane and 2-(2-bromoethyl)oxirane can be used. In addition, when R³ on the side of R⁴ is represented by Formula (3-1), and in Formula (3-1), y1 is 3 and y2 is 1, or when R³ on the side of R⁴ is represented by Formula (3-2), and in Formula (3-2), y3 is 3 and y4 is 1, (3-chloropropyl)oxirane and (3-bromopropyl)oxirane can be used.

<When Main Chain Moieties for Two R³'s are the Same, and R² on the Side of R¹ and R² on the Side of R⁴ are the Same>

### (Second Reaction)

A fluorine-based compound in which hydroxymethyl groups (—CH₂OH) are arranged at both terminals of a perfluoropolyether chain corresponding to R¹ on the side of R¹(═R² on the side of R) in Formula 11) is prepared. Then, a protecting group (for example, a THP group) is introduced into a hydroxy group of a hydroxymethyl group arranged at one terminal of the fluorine-based compound to obtain an intermediate compound 2-2.

### (Third Reaction)

Next, the epoxy group corresponding to the main chain moiety for R³ in the intermediate compound 2-1 is reacted with the hydroxy group in the intermediate compound 2-2. Accordingly, an intermediate compound 2-3 in which a linking group corresponding to a main chain moiety for R¹ is bonded to both terminals of a perfluoropolyether chain corresponding to R¹ in the center via a methylene group and a perfluoropolyether chain corresponding to R² on the side of R¹(═R² on the side of R⁴) is bonded to both ends via a methylene group is produced. In the intermediate compound 2-3, in two linking groups corresponding to a main chain moiety for R, one secondary hydroxy group generated by the reaction between the epoxy group of the intermediate compound 2-1 and the hydroxy group of the intermediate compound 2-2 is arranged.

<When Main Chain Moieties for Two R³'s are the Same and R² on the Side of R¹ and R² on the Side of R⁴ are Different>

### (Second Reaction)

When a compound in which, in Formula (1), R² on the side of R¹ and R² on the side of R⁴ are different perfluoropolyether chains is produced, the following reactions are performed as the second reaction and the third reaction.

In the same manner as the second reaction when R² on the side of R¹ and R² on the side of R⁴ are the same, a first intermediate compound 2-2-1 having a perfluoropolyether chain corresponding to R¹ on the side of R¹ is produced. In addition, in the same manner as the second reaction when R² on the side of R¹ and R² on the side of R⁴ are the same, a second intermediate compound 2-2-2 having a perfluoropolyether chain corresponding to R² on the side of R⁴ is produced.

### (Third Reaction)

The epoxy group corresponding to a main chain moiety for R³ in the intermediate compound 2-1 is reacted with the hydroxy group of the first intermediate compound 2-2-1, and purification is then performed. Accordingly, an intermediate compound having a linking group corresponding to a main chain moiety for R, a methylene group and a perfluoropolyether chain corresponding to R³ on the side of R¹ bonded to one end of a perfluoropolyether chain corresponding to R² in the center via a methylene group and an epoxy group at the other end is obtained. Next, the epoxy group of the obtained intermediate compound is reacted with the hydroxy group of the second intermediate compound 2-2-2.

Accordingly, an intermediate compound 2-3-1 having a linking group corresponding to a main chain moiety for R³, a methylene group and a perfluoropolyether chain corresponding to R² on the side of R¹ bonded to one end of a perfluoropolyether chain corresponding to R¹ in the center via a methylene group and a linking group corresponding to a main chain moiety for R³, a methylene group and a perfluoropolyether chain corresponding to R² on the side of R^{A} bonded to the other end via a methylene group is produced. In the intermediate compound 2-3-1 in which R² on the side of R¹ and R² on the side of R⁴ are different, in the linking groups corresponding to main chain moieties for two R³'s, one secondary hydroxy group generated by the reaction between the hydroxy group of the first intermediate compound 2-2-1 or the hydroxy group of the second intermediate compound 2-2-2, and the epoxy group of the intermediate compound 2-1 is arranged.

The intermediate compound 2-3-1 may be produced by a method of reacting a compound obtained by reacting the epoxy group corresponding to a main chain moiety for R³ in the intermediate compound 2-1 with the hydroxy group of the second intermediate compound 2-2-2 and then performing purification with a hydroxy group of the first intermediate compound 2-2-1.

### <When Main Chain Moieties for Two R¹'s are Different>

### (Third Reaction)

When a compound in which the main chain moieties for two R³'s in Formula (1) are different is produced, the following reaction is performed as the third reaction.

The third reaction is performed in the same manner as when the main chain moieties for two R³'s are the same except that the intermediate compound 2-1-2, which is produced in the first reaction when the main chain moieties for two R³'s are different, having an epoxy group corresponding to a main chain moiety for R³ on the side of R¹ at one terminal of R² and an epoxy group corresponding to a main chain moiety for R³ on the side of R⁴ at the other terminal of R² is used in place of the intermediate compound 2-1 produced in the first reaction when the main chain moieties for two R³'s are the same.

Specifically, when R² on the side of R¹ and R² on the side of R⁴ are the same, the epoxy group corresponding to a main chain moiety for R³ on the side of R¹ of the intermediate compound 2-1-2 is reacted with the hydroxy group of the intermediate compound 2-2, and the epoxy group corresponding to a main chain moiety for R³ on the side of R⁴ of the intermediate compound 2-1-2 is reacted with the hydroxy group of the intermediate compound 2-2.

When R² on the side of R¹ and R² on the side of R⁴ are different, a compound obtained by reacting an epoxy group corresponding to a main chain moiety for R³ on the side of R¹ of the intermediate compound 2-1-2 with a hydroxy group of the first intermediate compound 2-2-1 is reacted with a hydroxy group of the second intermediate compound 2-2-2. In addition, a compound obtained by reacting an epoxy group corresponding to a main chain moiety for R¹ on the side of R⁴ of the intermediate compound 2-1-2 with a hydroxy group of the second intermediate compound 2-2-2 is reacted with a hydroxy group of the first intermediate compound 2-2-1.

Accordingly, an intermediate compound 2-3-2 having a linking group corresponding to a main chain moiety for R³ on the side of R¹, a methylene group and a perfluoropolyether chain corresponding to R² on the side of R⁴ bonded to one end of a perfluoropolyether chain corresponding to R⁴ in the center via a methylene group and a linking group corresponding to a main chain moiety for R³ on the side of R⁴, a methylene group and a perfluoropolyether chain corresponding to R² on the side of R⁴ bonded to the other end via a methylene group is produced. In the intermediate compound 2-3-2 in which R³ on the side of R¹ and R³ on the side of R⁴ are different, in the linking groups corresponding to main chain moieties for two R³'s, one secondary hydroxy group generated by the reaction between the hydroxy group of the intermediate compound 2-2 for the first intermediate compound 2-2-1 and the second intermediate compound 2-2-2) and the epoxy group of the intermediate compound 2-1-2 is arranged.

### (Fourth Reaction)

Then, in any of the intermediate compound 2-3 in which the main chain moieties for two R³'s are the same and R² on the side of R¹ and R² on the side of R⁴ are the same, the intermediate compound 2-3-1 in which the main chain moieties for two R³'s are the same, and R² on the side of R¹ and R² on the side of R⁴ are different, and the intermediate compound 2-3-2 in which the main chain moieties for two R¹'s are different, and R² on the side of R¹ and R² on the side of R⁴ are the same or different, the secondary hydroxy group arranged in the main chain moieties of two R³'s is converted into a primary hydroxy group by chemical modification.

When the side chain moieties for two R³'s are the same (the intermediate compound 2-3 or the intermediate compound 2-3-1), an intermediate compound 2-4 is produced by reacting a halogen compound with a structure corresponding to a side chain moiety for R³ and a protecting group introduced into a terminal primary hydroxy group with secondary hydroxy groups of linking groups corresponding to main chain moieties for two R³'s.

When the side chain moieties for two R³'s are different (intermediate compound 2-3-2), specifically, a compound obtained by reacting a secondary hydroxy group of a linking group corresponding to a main chain moiety for R³ on the side of R¹ of the intermediate compound 2-3-2 with a halogen compound with a structure corresponding to a side chain moiety for R³ on the side of R¹ and a protecting group introduced into a terminal primary hydroxy group is reacted with a halogen compound with a structure corresponding to a side chain moiety for R³ on the side of R⁴ and a protecting group introduced into a terminal primary hydroxy group. In addition, a compound obtained by reacting a secondary hydroxy group of a linking group corresponding to a main chain moiety for R³ on the side of R⁴ of the intermediate compound 2-3-2 with a halogen compound with a structure corresponding to a side chain moiety for R³ on the side of R⁴ and a protecting group introduced into a terminal primary hydroxy group is reacted with a halogen compound with a structure corresponding to a side chain moiety for R³ on the side of R¹ and a protecting group introduced into a terminal primary hydroxy group. Accordingly, the intermediate compound 2-4-1 is produced.

As the halogen compound with a structure corresponding to side chain moieties for R³ on the side of R¹ and R³ on the side of R⁴ and a protecting group introduced into a terminal primary hydroxy group, used in the second production method, the same one that can be used as the halogen compound with a structure corresponding to a side chain moiety for R³ and a protecting group introduced into a terminal primary hydroxy group in the first production method can be used.

### (Fifth Reaction)

Next, the protecting groups (for example THP groups) bonded to both terminals of the intermediate compound 2-4 (or the intermediate compound 2.4-1) are removed by a known method to obtain an intermediate compound 2-5.

### (Sixth Reaction)

Next, in the same manner as the fifth reaction in the first production method, hydroxy groups bonded to both terminals of the intermediate compound 2-5 are reacted with an epoxy compound having a group corresponding to R¹— in Formula (1) (or an epoxy compound having a group corresponding to R¹— and an epoxy compound having a group corresponding to R⁴). Accordingly, an intermediate compound 2-6 having a group corresponding to R¹— at one terminal and a group corresponding to R⁴— at the other terminal is produced.

### (Seventh Reaction)

Finally, all protecting groups introduced into the intermediate compound 2-6 are removed. As a method of removing a protecting group, the same method as the first production method can be used.

When the above step is performed, a compound in which x in Formula i 1) is 2 can be produced.

The fluorine-containing ether compound of the present embodiment is a compound represented by Formula (1). Therefore, a lubricating layer formed on the protective layer using the lubricant containing the fluorine-containing ether compound of the present embodiment has excellent chemical substance resistance and favorable magnetic head flying stability even if the thickness is thin.

### [Lubricant for Magnetic Recording Medium]

The lubricant for magnetic recording medium of the present embodiment contains the fluorine-containing ether compound represented by Formula (1).

The lubricant of the present embodiment can be used by being mixed with a known material used as a material for the lubricant as necessary as long as the characteristics are not impaired due to the inclusion of the fluorine-containing ether compound represented by Formula (1).

Specific examples of known materials include, for example FOMBLIN (registered trademark) ZDIAC. FOMBLIN ZDEAL and FOMBLIN AM-2001 (all commercially available from Solvay Solexis), and Moresco A20H (commercially available from Moresco).

A known material used in combination with the lubricant of the present embodiment preferably has a number-average molecular weight of 1,000 to 10,000.

When the lubricant of the present embodiment contains a material other than the fluorine-containing ether compound represented by Formula (1), the content of the fluorine-containing ether compound represented by Formula (1) in the lubricant of the present embodiment is preferably 50 mass % or more and more preferably 70 mass % or more.

Since the lubricant of the present embodiment contains the fluorine-containing ether compound represented by Formula (1), it is possible to form a lubricating layer having high chemical substance resistance and favorable magnetic head flying stability even if the thickness is thin.

### [Magnetic Recording Medium]

In a magnetic recording medium of the present embodiment, at least a magnetic layer, a protective layer, and a lubricating layer are sequentially provided on a substrate. In the magnetic recording medium of the present embodiment, as necessary, one, two or more base layers can be provided between the substrate and the magnetic layer. In addition, at least one of the adhesive layer and the soft magnetic layer can be provided between the base layer and the substrate.

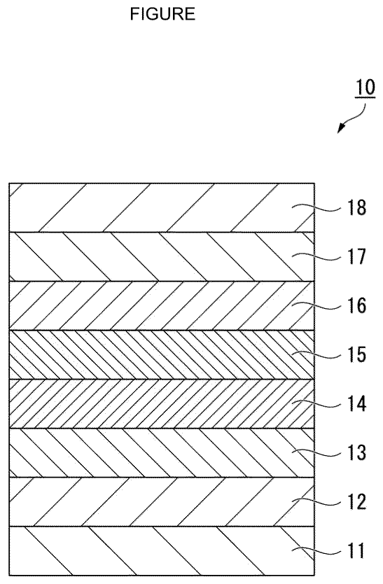

FIG. 1 is a schematic cross-sectional view showing a magnetic recording medium according to one embodiment of the present invention.

A magnetic recording medium 10 of the present embodiment has a structure in which an adhesive layer 12, a soft magnetic layer 13, a first base layer 14, a second base layer 15, a magnetic layer 16, a protective layer 17, and a lubricating layer 18 are sequentially provided on a substrate 11.

### “Substrate”

As the substrate 11, for example, a non-magnetic substrate in which a film made of NiP or a NiP alloy is formed on a base made of a metal or an alloy material such as Al or an Al alloy can be used.

In addition, as the substrate 11, a non-magnetic substrate made of a non-metallic material such as glass, a ceramic, silicon, silicon carbide, carbon, and a resin may be used, or a non-magnetic substrate in which a film of NiP or a NiP alloy is formed on a base made of these non-metallic materials may be used.

### “Adhesive Layer”

The adhesive layer 12 prevents the progress of corrosion of the substrate 11 that occurs when the substrate 11 and the soft magnetic layer 13 provided on the adhesive layer 12 are arranged in contact with each other.

The material of the adhesive layer 12 can be appropriately selected from among, for example. Cr, a Cr alloy, Ti, a Ti alloy, CrTi, NiAl, and an AlRu alloy. The adhesive layer 12 can be formed by, for example, a sputtering method.

### “Soft Magnetic Layer”

The soft magnetic layer 13 preferably has a structure in which a first soft magnetic film, an intermediate layer made of a Ru film, and a second soft magnetic film are sequentially laminated. That is, the soft magnetic layer 13 preferably has a structure in which an intermediate layer made of a Ru film is interposed between two soft magnetic film layers, and thus the soft magnetic films above and below the intermediate layer are bonded by anti-ferromagnetic coupling (AFC).

Examples of materials of the first soft magnetic film and the second soft magnetic film include a CoZrTa alloy and a CoFe alloy.

It is preferable to add any of Zr, Ta, and Nb to the CoFe alloy used for the first soft magnetic film and the second soft magnetic film. Thereby, the amorphization of the first soft magnetic film and the second soft magnetic film is promoted. As a result, the orientation of the first base layer (seed layer) can be improved, and the raised amount of the magnetic head can be reduced.

The soft magnetic layer 13 can be formed by, for example, a sputtering method.

### “First Base Layer”

The first base layer 14 is a layer that controls the orientation and the crystal size of the second base layer 15 and the magnetic layer 16 provided thereon.

Examples of the first base layer 14 include a Cr layer, a Ta layer, a Ru layer, a CrMo alloy layer, a CoW alloy layer, a CrW alloy layer, a CrV alloy layer, and a CrTi alloy layer.

The first base layer 14 can be formed by, for example, a sputtering method.

### “Second Base Layer”

The second base layer 15 is a layer that controls the orientation of the magnetic layer 16 such that it becomes favorable. The second base layer 15 is preferably a layer made of Ru or a Ru alloy.

The second base layer 15 may be a single layer or may be composed of a plurality of layers. When the second base layer 15 is composed of a plurality of layers, all of the layers may be composed of the same material, or at least, one layer may be composed of a different material.

The second base layer 15 can be formed by, for example, a sputtering method.

### “Magnetic Layer”

The magnetic layer 16 is made of a magnetic film in which the axis of easy magnetization is in a direction perpendicular or horizontal to the surface of the substrate. The magnetic layer 16 is a layer containing Co and Pt. The magnetic layer 16 may be a layer containing an oxide, Cr, B, Cu. Ta, Zr or the like in order to improve SNR characteristics.

Examples of oxides contained in the magnetic layer 16 include SiO₂, SiO, Cr₂O₃, CoO, Ta₂O₃, and TiO₂.

The magnetic layer 16 may be composed of one layer or may be composed of a plurality of magnetic layers made of materials with different compositions.

For example, when the magnetic layer 16 is composed of three layers including a first magnetic layer, a second magnetic layer and a third magnetic layer sequentially laminated from below, the first magnetic layer preferably has a granular structure made of a material containing Co, Cr, and Pt, and further containing an oxide. As the oxide contained in the first magnetic layer, for example, it is preferable to use an oxide of Cr, Si, Ta, Al, Ti, Mg, Co or the like. Among these, particularly, TiO₂, Cr₂O₃, SiO₂ or the like can be preferably used. In addition, the first magnetic layer is preferably made of a composite oxide in which two or more oxides are added. Among these, particularly. Cr₂O₃—SiO₂, Cr₂O—TiO₂, SiO₂—TiO₂ or the like can be preferably used.

The first magnetic layer can contain one or more elements selected from among B, Ta, Mo, Cu, Nd, W, Nb, Sm, Tb, Ru, and Re in addition to Co, Cr, Pt, and an oxide. For the second magnetic layer, the same material as for the first magnetic layer can be used. The second magnetic layer preferably has a granular structure.

The third magnetic layer preferably has a non-granular structure made of a material containing Co, Cr, and Pt and not, containing an oxide. The third magnetic layer can contain one or more elements selected from among B, Ta, Mo, Cu, Nd, W, Nh, Sm, Tb, Ru, Re, and Mn in addition to Co, Cr, and Pt.

When the magnetic layer 16 is formed of a plurality of magnetic layers, it is preferable to provide a non-magnetic layer between adjacent magnetic layers. When the magnetic layer 16 is composed of three layers including a first magnetic layer, a second magnetic layer and a third magnetic layer, it is preferable to provide a non-magnetic layer between the first magnetic layer and the second magnetic layer and between the second magnetic layer and the third magnetic layer.

For the non-magnetic layer provided between adjacent magnetic layers of the magnetic layer 16, for example. Ru, a Ru alloy, a CoCr alloy, a CoCrX1 alloy (X1 represents one, two or more elements selected from among Pt, Ta, Zr, Re, Ru, Cu, Nb, Ni, Mn, Ge, Si, O, N, W, Mo, Ti, V, and B) or the like can be preferably used.

For the non-magnetic layer provided between adjacent magnetic layers of the magnetic layer 16, it is preferable to use an alloy material containing an oxide, a metal nitride, or a metal carbide. Specifically, as the oxide, for example, SiO₂, Al₂O₃, Ta₂O₅, Cr₂O₃, MgO, Y₂O, TiO₂ or the like can be used. As the metal nitride, for example. AlN, Si₂N₄, TaN, CrN or the like can be used. As the metal carbide, for example, TaC, BC, SiC or the like can be used.

The non-magnetic layer can be formed by, for example, a sputtering method.

The magnetic layer 16 is preferably a magnetic layer for perpendicular magnetic recording in which the axis of easy magnetization is in a direction perpendicular to the surface of the substrate in order to realize a higher recording density. The magnetic layer 16 may be a magnetic layer for in-plane magnetic recording.

The magnetic layer 16 may be formed by any conventionally known method such as a vapor deposition method, an ion beam sputtering method, and a magnetron sputtering method. The magnetic layer 16 is generally formed by a sputtering method.

### “Protective Layer”

The protective layer 17 protects the magnetic layer 16. The protective layer 17 may be composed of one layer or may be composed of a plurality of layers. As the protective layer 17, a carbon-based protective layer can be preferably used, and an amorphous carbon protective layer is particularly preferable. When the protective layer 17 is a carbon-based protective layer, this is preferable because the interaction with the polar group (particularly the hydroxy group) contained in the fluorine-containing ether compound in the lubricating layer 18 is further improved.

The adhesive force between the carbon-based protective layer and the lubricating layer 18 can be controlled by forming a carbon-based protective layer with hydrogenated carbon and/or nitrogenated carbon, and adjusting the hydrogen content, and/or nitrogen content in the carbon-based protective layer. The hydrogen content in the carbon-based protective layer measured by a hydrogen forward scattering (HFS) is preferably 3 atom % to 20 atom %. In addition, the nitrogen content in the carbon-based protective layer measured through X-ray photoelectron spectroscopy (XPS) is preferably 4 atom % to 15 atom %.

Hydrogen and/or nitrogen contained in the carbon-based protective layer need not be uniformly contained through the entire carbon-based protective layer. For example, the carbon-based protective layer is preferably formed as a composition gradient layer in which nitrogen is contained in the protective layer 17 on the side of the lubricating layer 18 and hydrogen is contained in the protective layer 17 on the side of the magnetic layer 16. In this case, the adhesive force between the magnetic layer 16 and the lubricating layer 18, and the carbon-based protective layer is further improved.

The film thickness of the protective layer 17 is preferably 1 nm to 7 nt. When the film thickness of the protective layer 17 is 1 nm or more, the performance of the protective layer 17 can be sufficiently obtained. The film thickness of the protective layer 17 is preferably 7 nm or less in order to reduce the thickness of the protective layer 17.

As a film formation method for the protective layer 17, a sputtering method using a target material containing carbon, a chemical vapor deposition (CVD) method using a hydrocarbon raw material such as ethylene or toluene, an ion beam deposition (IBD) method or the like can be used.

When a carbon-based protective layer is formed as the protective layer 17, for example, a film can be formed by a DC magnetron sputtering method. Particularly, when a carbon-based protective layer is formed as the protective layer 17, it is preferable to form an amorphous carbon protective layer by a plasma CVD method. The amorphous carbon protective layer formed by the plasma CVD method has a uniform surface and low roughness.

### “Lubricating Layer”

The lubricating layer 18 prevents contamination of the magnetic recording medium 10. In addition, the lubricating layer 18 reduces a frictional force of a magnetic head of a magnetic recording and reproducing device, which slides on the magnetic recording medium 10, and improves the durability of the magnetic recording medium 10.

As shown in FIG. 1, the lubricating layer 18 is formed on and in contact with the protective layer 17. The lubricating layer 18 is formed by applying the lubricant for magnetic recording medium according to the embodiment described above to the protective layer 17. Therefore, the lubricating layer 18 contains the above fluorine-containing ether compound.

When the protective layer 17 arranged below the lubricating layer 18 is a carbon-based protective layer, particularly, the lubricating layer 18 is bonded to the protective layer 17 with a bonding force. As a result, even if the thickness of the lubricating layer 18 is thin, it is easy to obtain the magnetic recording medium 10 in which the surface of the protective layer 17 is covered at a high coating rate, and it is possible to effectively prevent contamination of the surface of the magnetic recording medium 10.

The average film thickness of the lubricating layer 18 is preferably 0.5 nm (5 Å) to 2.0 nm (20 Å) and more preferably 0.5 nm (5 Å) to 1.2 nm (12 Å). When the average film thickness of the lubricating layer 18 is 0.5 nm or more, the lubricating layer 18 is formed with a uniform film thickness without forming an island shape or a mesh shape. Therefore, the surface of the protective layer 17 can be coated with the lubricating layer 18 at a high coating rate. In addition, when the average film thickness of the lubricating layer 18 is 2.0 nm or less, the lubricating layer 18 can be made sufficiently thin, and the raised amount of the magnetic head can be sufficiently reduced.

### “Method of Forming Lubricating Layer”

Examples of methods of forming the lubricating layer 18 include a method in which a magnetic recording medium during production in which respective layers up to the protective layer 17 are formed on the substrate 11 is prepared, and a lubricating layer forming solution is applied onto the protective layer 17 and dried.

The lubricating layer forming solution can be obtained by dispersing and dissolving the lubricant for magnetic recording medium according to the embodiment described above in a solvent as necessary, and adjusting the viscosity and concentration to be suitable for application methods.

Examples of solvents used for the lubricating layer forming solution include fluorine-based solvents such as Vertel (registered trademark) XF (product name, commercially available from Du Pont-Mitsui Fluorochemicals Co., Ltd.).

The method of applying a lubricating layer forming solution is not particularly limited, and examples thereof include a spin coating method, a spraying method, a paper coating method, and a dipping method.

When the dipping method is used, for example, the following method can be used. First, the substrate 11 in which respective layers up to the protective layer 17 are formed is immersed in the lubricating layer forming solution contained in an immersion tank of a dip coating device. Next, the substrate 11 is lifted from the immersion tank at a predetermined speed. Accordingly, the lubricating layer forming solution is applied to the surface of the protective layer 17 of the substrate 11.

When the dipping method is used, the lubricating layer forming solution can be uniformly applied to the surface of the protective layer 17, and the lubricating layer 18 with a uniform film thickness can be formed on the protective layer 17.

In the present embodiment, the substrate 11 in which the lubricating layer 18 is formed is preferably subjected to a heat treatment. When the heat treatment is performed, the adhesion between the lubricating layer 18 and the protective layer 17 is improved, and the adhesive force between the lubricating layer 18 and the protective layer 17 is improved.

The heat treatment temperature is preferably 100° C., to 180° C., and more preferably 100° C. to 160° C. When the heat treatment temperature is 100° C. or higher, an effect of improving the adhesion between the lubricating layer 18 and the protective layer 17 is sufficiently obtained. In addition, when the heat treatment temperature is 180° C., or lower, it is possible to prevent thermal decomposition of the lubricating layer 18 according to the heat treatment. The heat treatment time can be appropriately adjusted according to the heat treatment temperature, and is preferably 10 minutes to 120 minutes.

In the present embodiment, in order to further improve the adhesive force of the lubricating layer 18 with respect to the protective layer 17, an ultraviolet ray (UV) emitting treatment may be performed on the lubricating layer 18 before the heat treatment or after the heat treatment.

In the magnetic recording medium 10 of the present embodiment, at least the magnetic layer 16, the protective layer 17, and the lubricating layer 18 are sequentially provided on the substrate 11. In the magnetic recording medium 10 of the present embodiment, the lubricating layer 18 containing the above fluorine-containing ether compound is formed on and in contact with the protective layer 17. Even if the film thickness of the lubricating layer 18 is thin, the magnetic recording medium 10 having excellent chemical substance resistance and favorable magnetic head flying stability is obtained. Accordingly, the magnetic recording medium 10 of the present embodiment has excellent reliability, and particularly has an excellent silicon contamination ability and durability. Therefore, the magnetic recording medium 10 of the present embodiment can have a small raised amount of the magnetic head (for example, 10 nm or less), and operates stably for a long period of time even in a harsh environment due to diversity of applications. Therefore, the magnetic recording medium 10 of the present embodiment is particularly preferable as a magnetic disk mounted in a load unload (LUL) type magnetic disk device.

### EXAMPLES

Hereinafter, the present invention will be described in more detail with reference to examples and comparative examples. Here, the present invention is not limited only to the following examples.

### Example 1

The compound represented by Formula (1A) was obtained by the following method.

### (First Reaction)

20 g of a compound (a number-average molecular weight of 909 and a molecular weight distribution of 1.1) represented by HOCH₂CF₂CF₂O(CF₂CF₂CF₂O)CF₂CF₂CH₂OH (in the formula, 1 indicating an average degree of polymerization is 3.8), 1.95 g of 3,4-dihydro-2H-pyran, and 44 mL, of a mixed solution (a volume ratio of 1:1) containing Asahiklin (registered trademark) AE3000 (commercially available from AGC) as a fluorine-based solvent and dichloromethane were put into 300 mL eggplant flask under a nitrogen gas atmosphere, and stirred at 0° C. until they became uniform to form a mixture, 0.084 g of p-toluenesulfonic acid monohydrate was added to the mixture, the mixture was stirred at 0° C. for 30 minutes, and the mixture was then stirred and reacted at room temperature for 2 hours.

The reaction product obtained after the reaction was cooled to 0° C., and 50 mL of a saturated sodium bicarbonate solution was added to stop the reaction. The obtained reaction solution was transferred into a separatory funnel and extracted three times with 100 mL of ethyl acetate. The organic layer was washed with a saline and dehydrated with anhydrous sodium sulfate. After the desiccant was filtered, the filtrate was concentrated, and the residue was purified through silica gel column chromatography to obtain 10.8 g a compound represented by the following Formula (7) as an intermediate compound 1-1.

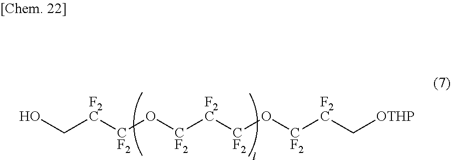

(in Formula (7), 1 indicating an average degree of polymerization represents 3.8 and THP represents a tetrahydropyranyl group).

### (Second Reaction)

10.8 g (a molecular weight of 993, 10.9 mmol) of the compound represented by Formula (7) as the intermediate compound 1-1, 10.2 mL of t-butanol, and 0.37 g (a molecular weight of 112, 3.3 mmol) of potassium tert-butoxide were put into a 200 mL eggplant flask under a nitrogen gas atmosphere, and stirred at room temperature until they became uniform, 0.49 mL of epibromohydrin (a molecular weight of 137, 6.0 mmol) was added to the uniform solution, and the mixture was stirred and reacted at 70° C. for 2 hours. Next, 0.25 g of potassium tert-butoxide was added, and the mixture was stirred and reacted at 70C for 2 hours. Then, 0.25 g of potassium tert-butoxide was added, and the mixture was stirred and reacted at 70° C. for 13 hours.

The reaction solution obtained after the reaction was returned to room temperature, 31 g of a 10% hydrogen chloride/methanol solution (a hydrogen chloride-methanol reagent (5-10%), commercially available from Tokyo Chemical Industry Co., Ltd.) was added, and the mixture was stirred at room temperature for 2 hours. The reaction solution was transferred little by little into a separatory funnel containing 100 mL of a saline solution, and extracted three times with 200 mL of ethyl acetate. The organic layer was washed with 100 mL of a saline solution, 100 mL of a saturated sodium bicarbonate solution, and 100 mL, of a saline solution in that order, and dehydrated with anhydrous sodium sulfate. After the desiccant was filtered, the filtrate was concentrated, and the residue was purified through silica gel column chromatography. When the above step was performed, 7.6 g of a compound represented by the following Formula (8) was obtained as an intermediate compound 1-2.

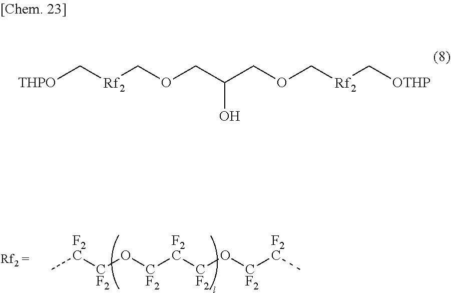

(in Formula (8), THP represents a tetrahydropyranyl group, and Rf₂ is represented by the above formula; and in Rf₂, 1 indicating an average degree of polymerization represents 3.8),

### (Third Reaction)

7.6 g (a molecular weight of 2,042, 3.7 mmol) of the compound represented by Formula (8) as the intermediate compound 1-2, 7.4 mL of N,N-dimethylformamide and 0.16 g of sodium hydride (a purity of 60%, a molecular weight of 24.00, 4.1 mmol) were put into a 200 mL eggplant flask under a nitrogen gas atmosphere, and stirred at 0° C. until they became uniform, and additionally stirred at room temperature for 30 minutes, and 1.2 mL (a molecular weight of 215, 7.4 mmol) of benzyl 2-bromoethyl ether (BnO(CH₂)₂Br(Bn represents a benzyl group)) was then added dropwise at 0° C., and the mixture was stirred at room temperature until it became uniform, 0.16 g of sodium hydride was added to the uniform solution, and the mixture was stirred at room temperature for 20 hours and then stirred and reacted at 40° C. for 3 hours.

The reaction solution obtained after the reaction was returned to room temperature, and the reaction solution was transferred little by little into a separatory funnel containing 40 mL of a saline and extracted three times with 40 mL of ethyl acetate. The organic layer was washed with 20 ml of a saline and dehydrated with anhydrous sodium sulfate. After the desiccant was filtered, the filtrate was concentrated, and the residue was purified through silica gel column chromatography. When the above step was performed, 5.4 g of a compound represented by the following Formula (9) was obtained as an intermediate compound 1-3.

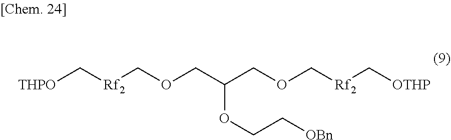

(in Formula (9), THP represents a tetrahydropyranyl group, Bn represents a benzyl group, and Rf₂ is the same as Rf₂ in Formula (8); and in Rf₂, 1 indicating an average degree of polymerization represents 3.8).

### (Fourth Reaction)

6.8 g (a molecular weight of 2,176, 3.1 mmol) of the compound represented by Formula (9) as the intermediate compound 1-3 and 46 mL of trifluoroethanol were put into a 200 mL eggplant flask under a nitrogen gas atmosphere, and stirred at room temperature until they became uniform to form a mixture, 0.12 g of p-toluenesulfonic acid monohydrate was added to the mixture, and the mixture was stirred and reacted at room temperature for 1 hour.

0.13 mL of diisopropylethylamine was added to the reaction product obtained after the reaction to stop the reaction. The residue of the obtained reaction solution was purified through silica gel column chromatography to obtain 4.5 g of a compound represented by the following Formula (1O) as an intermediate compound 1.4.

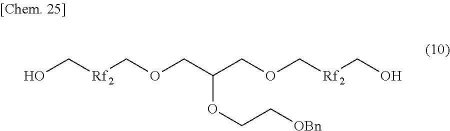

(in Formula (1O), Bn represents a benzyl group, and Rf₂ is the same as Rf₂ in Formula (8); and in R², 1 indicating an average degree of polymerization represents 3.8).

### (Fifth Reaction)

4.5 g (a number-average molecular weight of 2008, 2.2 mmol) of the compound represented by Formula (1O) as the intermediate compound 1-4, 1.5 g (a molecular weight of 202.3, 7.2 mmol) of a compound represented by the following Formula (11) and 21 mL of t-butanol were put into a 200 mL eggplant flask under a nitrogen gas atmosphere, and stirred at room temperature until they became uniform, 0.025 g of potassium tert-butoxide was additionally added to the uniform solution, and the mixture was stirred and reacted at 70° C. for 16 hours.

The compound represented by Formula (11) was synthesized by a method of oxidizing a compound in which a hydroxy group of ethylene glycol monoallyl ether was protected using dihydropyran.

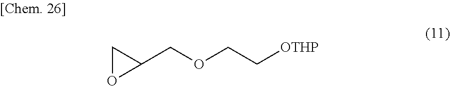

(in Formula (1 1). THP represents a tetrahydropyranyl group).

The reaction product obtained after the reaction was cooled to 25° C., transferred into a separatory funnel containing 100 mL of water, and extracted three times with 100 mL of ethyl acetate. The organic layer was washed with water and dehydrated with anhydrous sodium sulfate. After the desiccant was filtered, the filtrate was concentrated, and the residue was purified through silica gel column chromatography to obtain 3.3 g of a compound represented by the following Formula (12) as an intermediate compound 1-5.

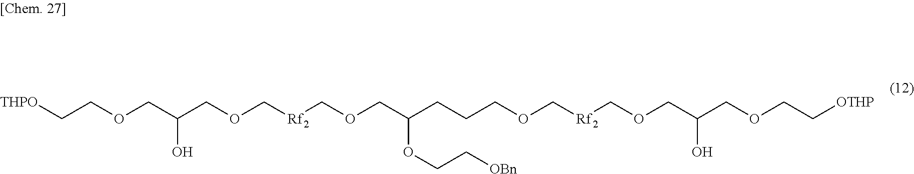

(in Formula (12). THP represents a tetrahydropyranyl group, Bn represents a benzyl group, and Rf₂ is the same as Rf₂ in Formula (8); and in Rf₂, 1 indicating an average degree of polymerization represents 3.8).

### (Sixth Reaction)

3.3 g (a number-average molecular weight of 2,413, 1.4 mmol) of the compound represented by Formula (12) as the intermediate compound 1-5, 33 mL of methanol, and 3.3 mL of formic acid were put into a 20) mL eggplant flask under a nitrogen gas atmosphere, and stirred at room temperature until they became uniform, 0.33 g of palladium on carbon (Pd/C) was additionally added to the uniform solution, and the mixture was stirred and reacted at 70° C. for 2 hours.

The reaction solution obtained after the reaction was filtered to remove Pd/C. and the filtrate was concentrated. After concentration, the residue was purified through silica get column chromatography to obtain 2.4 g (a number-average molecular weight of 2,154, 1.1 mmol) of the compound represented by Formula (1A) (in Formula (1A). Rf₂1a is represented by Formula (1 AF), and in two Rf₂1a's, 11 a indicating an average degree of polymerization is 3.8).

The obtained compound (A) was subjected to ¹H-NMR and ¹⁹F-NMR measurement, and the structure was identified based on the following results. ¹H-NMR(CD₃COCD₃): δ[ppm]=3.39 to 4.34 (40H) ¹⁹F-NMR(CD₃COCD₃): δ[ppm]=−84.0 to −83.0 (30.4F), −86.4 (8F), −124.3 (8F), −130,0 to −129.0 (15.2F)

### Example 2

2.4 g (a number-average molecular weight of 2.182, 1.1 mmol) of the compound represented by Formula (11B) (in Formula (113), Rf₂1b is represented by Formula (1BF), and in two Rf₂1b's, l1b indicating an average degree of polymerization is 3.8) was obtained in the same operation as in Example 1 except that, in the fifth reaction, in place of the compound represented by Formula (11), 1.6 g (a molecular weight of 216, 7.2 mmol) of a compound represented by the following Formula (13) was used.

The compound represented by Formula (13) was synthesized by protecting one hydroxy group of 1,3-propanediol with a tetrahydropyranyl (THP) group and reacting the other hydroxy group with epibromohydrin.

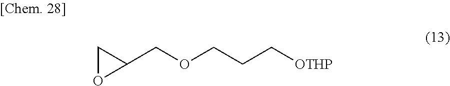

(in Formula (13), THP represents a tetrahydropyranyl group).

The obtained compound (1B) was subjected to ¹H-NMR and ¹⁹F-NMR measurement, and the structure was identified based on the following results. ¹H-NMR(CD₃COCD₃): δ[ppm]=1.65 to 1.81 (41-1), 3.39 to 4.35 (40H) ¹⁹F-NMR(CD₃COCD₃): δ[ppm]=−84.0 to −83.0 (30AF), −86,4 (8F), −24,3 (8F), −130.0 to −129.0 (15.2F)

### Example 3

The operation up to the sixth reaction was performed in the same manner as in Example 1 except that, in the fifth reaction, in place of the compound represented by Formula (11), 2.3 g (a molecular weight of 320, 7.2 mmol) of the compound represented by the following Formula (14) was used.

31 g of a 10% hydrogen chloride/methanol solution (a hydrogen chloride-methanol reagent (5-10%), commercially available from Tokyo Chemical Industry Co., Ltd.) was added to the reaction product obtained in the sixth reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL of a saline solution, 10 mL of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.5 g (a number-average molecular weight of 2,302, 1.1 nmol) of the compound represented by Formula (1C) (in Formula (1C), Rf₂1c is represented by Formula (1CF), and in two Rf₂1c's, 11c indicating an average degree of polymerization is 3.8) was obtained.

A compound represented by Formula (14) was synthesized by the following method.

A tert-butyldimethylsilyl (TBS) group as a protecting group was introduced into a primary hydroxy group of 3-allyloxy-1,2-propanediol, and a methoxymethyl (MOM) group as a protecting group was introduced into a secondary hydroxy group of the obtained compound. The TBS group was removed from the obtained compound, and the generated primary hydroxy group was reacted with 2-bromoethoxytetrahydropyran. The double bond of the obtained compound was oxidized. Through the above step, the compound represented by Formula (14) was obtained.

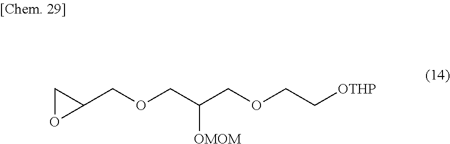

(in Formula (14). THP represents a tetrahydropyranyl group, and MOM represents a methoxymethyl group).

The obtained compound (1C) was subjected to ¹H-NMR and ¹⁹F-NMR measurement, and the structure was identified based on the following results. ¹H-NMR(CD₃COCD₃): δ[ppm]=3.37 to 4.36 (52H) ¹⁹F-NMR(CD₃COCD₃): δ[ppm]=−84.0 to −83.0 (30.4F), −86.4 (8F), −124.3 (8F), −130.0 to −129.0 (15.2F)

### Example 4

The operation up to the sixth reaction was performed in the same manner as in Example 1 except that, in the fifth reaction, in place of the compound represented by Formula (11), 2.4 g (a molecular weight of 334, 7.2 mmol) of the compound represented by the following Formula (15) was used.

31 g of a 10% hydrogen chloride/methanol solution (a hydrogen chloride-methanol reagent (5-10%), commercially available from Tokyo Chemical Industry Co., Ltd.) was added to the reaction product obtained in the sixth reaction, and the mixture was stirred at room temperature for 2 hours. The obtained reaction solution was transferred little by little into a separatory funnel containing 1N) mL of a saline and extracted three times with 200 mL of ethyl acetate. The organic layer was washed with 100 mL of a saline solution, 100 mL of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.6 g (a number-average molecular weight of 2,331, 1.1 mmol) of the compound represented by Formula 1D) (in Formula (1D), Rf₂1d is represented by Formula (1DF), and in two Rf₂1d's, 11d indicating an average degree of polymerization is 3.8) was obtained.

A compound represented by Formula (15) was synthesized by the following method.

A tert-butyldimethylsilyl (TBS) group as a protecting group was introduced into a primary hydroxy group of 3-allyloxy-1,2-propanediol, and a methoxymethyl (MOM) group as a protecting group was introduced into a secondary hydroxy group of the obtained compound. The TBS group was removed from the obtained compound and the generated primary hydroxy group was reacted with 2-(chloropropoxy)tetrahydro-2H-pyran. The double bond of the obtained compound was oxidized. Through the above step, the compound represented by Formula (15) was obtained.

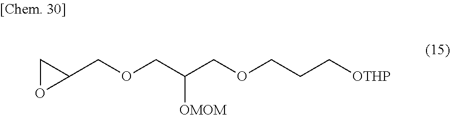

(in Formula (15). T-HP represents a tetrahydropyranyl group, and MOM represents a methoxymethyl group).

The obtained compound (1D) was subjected to ¹H-NMR and ¹⁹F-NMR measurement, and the structure was identified based on the following results. ¹H-NMR(CD₃COCD₃): δ[ppm]=1.65 to 1.81 (4H), 3.39 to 4.34 (52H) ¹⁹F-NMR(CD₃COCD₃): δ[ppm]=−84.0 to −83.0 (30.4F), −86.4 (8F), −124.3 (8F), −130.0 to −129.0 (15.2F)

### Example 5

2.4 g (a number-average molecular weight of 2,182, 1.1 mmol) of the compound represented by Formula (1f) (in Formula (1E), Rf₂1e is represented by Formula (1EF), and in two Rf₂1e's, 11e indicating an average degree of polymerization is 3.8) was obtained in the same operation as in Example 1 except that, in the fifth reaction, in place of the compound represented by Formula (11), 1.6 g (a molecular weight of 216, 7.2 mmol) of a compound represented by the following Formula (16) was used.

The compound represented by Formula (16) was synthesized by reacting 3-buten-1-ol with 2-bromoethoxytetrahydropyran and oxidizing the double bond of the obtained compound.

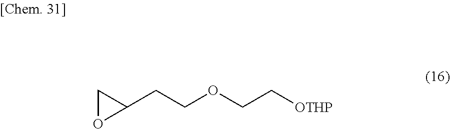

(in Formula (16). THP represents a tetrahydropyranyl group).

The obtained compound (1E) was subjected to ¹H-NMR and ¹⁹F-NMR measurement, and the structure was identified based on the following results. ¹H-NMR(CD₃COCD₃): δ[ppm]=1.65 to 1.79 (4H), 3.41 to 4.33 (40H) ¹⁹F-NMR(CD₃COCD₃): δ[ppm]=−84.0 to −83.0 (30.4F), −86.4 (8F), −124.3 (8F), −130.0 to −129.0 (15.2F)

### Example 6

The operation up to the sixth reaction was performed in the same manner as in Example 1 except that, in the fifth reaction, in place of the compound represented by Formula (1I), 2.4 g (a molecular weight of 334, 7.2 mmol) of a compound represented by the following Formula (17) was used.

31 g of a 10% hydrogen chloride/methanol solution (a hydrogen chloride-methanol reagent (5-10%), commercially available from Tokyo Chemical industry Co., Ltd.) was added to the reaction product obtained in the sixth reaction, and the mixture was stirred at room temperature for 2 hours. The obtained reaction solution was transferred little by little into a separatory funnel containing 1 (0) mL, of a saline and extracted three times with 200 mL of ethyl acetate. The organic layer was washed with 100 mL of a saline solution, 100 mL of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.6 g (a number-average molecular weight of 2,331, 1.1 mmol) of the compound represented by Formula (1F) (in Formula 1F), Rf₂1f is represented by Formula (1FF), ad in two Rf₂1f's, l1f indicating an average degree of polymerization is 3.8) was obtained.

A compound represented by Formula (17) was synthesized by the following method.

A hydroxy group of ethylene glycol monoallyl ether was protected using dihydropyran, and the double bond of the obtained compound was oxidized. An epoxy group of the compound obtained by oxidizing the double bond was reacted with a hydroxy group of 3-buten-1-ol. A secondary hydroxy group of the obtained compound was protected with a methoxymethyl (MOM) group, and the double bond of the obtained compound was oxidized. Through the above step, the compound represented by Formula (17) was obtained.

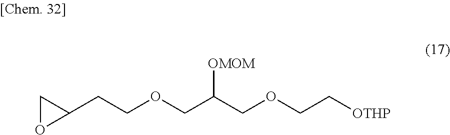

(in Formula (17), THP represents a tetrahydropyranyl group, and MOM represents a methoxymethyl group).

The obtained compound (1F) was subjected to ¹H-NMR and ¹⁹F-NMR measurement, and the structure was identified based on the following results. ¹H-NMR(CD₃COCD₃): δ[ppm]=1.65 to 1.79 (4H), 3.41 to 4.33 (52H) ¹⁹F-NMR(CD₃COCD₃): δ[ppm]=−84.0 to −83.0 (30.4F), −86.4 (8F), −124.3 (8F), −130.0 to −129.0 (15.2F)

### Example 7

2.3 g (a number-average molecular weight of 2,089, 1.1 mmol) of the compound represented by Formula 10) (in Formula (0G), Rf₁1g is represented by Formula (1GF), and in two Rf; 1g's, j1g indicating an average degree of polymerization is 4.0 and k1g indicating an average degree of polymerization is 4.0) was obtained in the same operation as in Example 1 except that, in (the first reaction, in place of the compound represented by HOCH₂CF₂CF₂O(CF₂CF₂CF₂O)CF₂CF₂CF₂CH₂OH, 20 g of a compound (a number-average molecular weight of 906 and a molecular weight distribution of 1.1) represented by HOCH₂CF₂OCF₂CF₂O(CF₂CF₂O)ⱼ(CF₂O)ₖCH₂OH (in the formula, j indicating an average degree of polymerization is 4.0, and k indicating an average degree of polymerization is 4.0) was used, and in the fifth reaction, in place of the compound represented by Formula (1I), 1.2 g (a molecular weight of 172, 7.2 mmol) of a compound represented by the following Formula (18) was used.

The compound represented by Formula (18) was synthesized by a method of introducing a tetrahydropyranyl (THP) group into a primary hydroxy group of 3-buten-1-ol and oxidizing the double bond of the obtained compound.

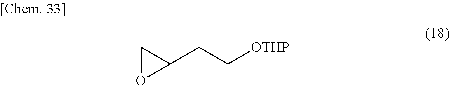

(in Formula (18), THP represents a tetrahydropyranyl group).

The obtained compound (1O) was subjected to ¹H-NMR and ¹⁹F-NMR measurement, and the structure was identified based on the following results, ¹H-NMR(CD₃COCD₃): δ[ppm]=1.66 to 1.79 (4H), 3.42 to 4.34 (32H) ¹⁹F-NMR(CD₃COCD₃): δ[ppm]=−55.6 to −50.6 (16F), −77.7 (4F), −80.3 (4F), −91.0 to −88.5 (32F)

### Example 8

2.4 g (a number-average molecular weight of 2,145, 1.1 nmol) of the compound represented by Formula (1H) (in Formula (1H), Rf₁1h is represented by Formula (1 HF), and in two Rf₁1h's, j1h indicating an average degree of polymerization is 4.0 and k1h indicating an average degree of polymerization is 4.0) was obtained in the same operation as in Example 7 except that, in place of the compound represented by Formula (18), 1.4 g (a molecular weight of 200, 7.2 mmol) of a compound represented by the following Formula (19) was used.

The compound represented by Formula (19) was synthesized by a method of introducing a tetrahydropyranyl (THP) group into a primary hydroxy group of 5-hexen-1-of and oxidizing the double bond of the obtained compound.

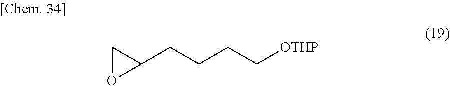

(in Formula (19), THP represents a tetrahydropyranyl group).

The obtained compound 11H) was subjected to ¹H-NMR and ¹⁹F-NMR measurement, and the structure was identified based on the following results. ¹H-NMR(CD₃COCD₃): δ[ppm]=1.37 to 1.81 (12H), 3.39 to 4.33 (32H) ¹⁹F-NMR(CD₃COCD₃): δ[ppm]=−55.6 to −50.6 (16F), −77.7 (4F), −80.3 (4F), −91.0 to −88.5 (32F)

### Example 9

The operation up to the sixth reaction was performed in the same manner as in Example 1 except that, in the first reaction, in place of the compound represented by HCCH₂CF₂CF₂O(CF₂CF₂CF₂O)ₗCF₂CF₂CH₂OH, 20 g of a compound (a number-average molecular weight of 909 and a molecular weight distribution of 1.1) represented by HOCH₂CF₂CF₂CF₂O(CF₂CF₂CF₂O)ₗCF₂CH₂OH (in the formula, j indicating an average degree of polymerization is 6.3, and k indicating an average degree of polymerization is 0) was used, and in the fifth reaction, in place of the compound represented by Formula (11), 2.2 g (a molecular weight of 304, 7.2 mmol) of a compound represented by the following Formula (20) was used.

31 g of a 10% hydrogen chloride/methanol solution (a hydrogen chloride-methanol reagent (5-10%), commercially available from Tokyo Chemical Industry Co., Ltd.) was added to the reaction product obtained in the sixth reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL of a saline solution, 100 mL, of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.5 g (a number-average molecular weight of 2.270, 1.1 mmol of the compound represented by Formula (1I) (in Formula (1I), Rf₁1i is represented by Formula (11F), and in two Rf₁1i's, j1i indicating an average degree of polymerization is 6.3 and k1i indicating an average degree of polymerization is 0) was obtained.

A compound represented by Formula (20) was synthesized by the following method.

A tetrahydropyranyl (THP) group was introduced into a primary hydroxy group of 4-penten-1-ol, and the double bond of the obtained compound was oxidized. The compound obtained by oxidizing the double bond was reacted with allyl alcohol. A secondary hydroxy group of the obtained compound was protected with a methoxymethyl (MOM) group, and the double bond of the obtained compound was oxidized. Through the above step, the compound represented by Formula (20) was obtained.

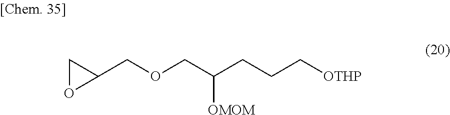

(in Formula (2O), THP presents a tetrahydropyranyl group, and MOM represents a methoxymethyl group).

The obtained compound (1I) was subjected to ¹H-NMR and ¹⁹F-NMR measurement, and the structure was identified based on the following results. ¹H-NMR(CD₃COCD₃): δ[ppm]=1.34 to 1.67 (8H), 3.39 to 4.34 (44H) ¹⁹F-NMR(CD₃COCD₃): δ[ppm]=−78.6 (4F), −81.3 (4F), −90.0 to −88.5 (50.4F)

### Example 10

2.5 g (a number-average molecular weight of 2,295, 1.1 mmol) of the compound represented by Formula (1J) (in Formula (1J), Rf₂1j is represented by Formula (1JF), and in two Rf₂1j's, I1j indicating an average degree of polymerization is 3.8) was obtained in the same operation as in Example 1 except that, in the fifth reaction, in place of the compound represented by Formula (1I), 2.0 g (a molecular weight of 272, 7.2 mmol) of a compound represented by the following Formula (2I) was used.

A compound represented by Formula (2I) was synthesized by the following method.

1,3-Diallyloxy-2-propanol was reacted with 3,4dihydro-2H-pyran. The double bond of the obtained compound on one side was oxidized using m-chloroperbenzoic acid. Through the above step, the compound represented by Formula (2I) was obtained.

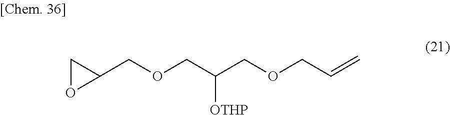

(in Formula (2I), THP represents a tetrahydropyranyl group).

The obtained compound (I3) was subjected to ¹H-NMR and ¹⁹F-NMR measurement, and the structure was identified based on the following results. ¹H-NMR(CD₃COCD₃): δ[ppm]=3.39 to 4.34 (46H), 5.14 to 5.22 (2H), 5.26 to 5.35 (2H), 5.87 to 5.91 (2H)¹⁹F-NMR(CD₃COCD₃): δ[ppm]=−84.0 to −83.0 (30.4F), −86.4 (8F),−124.3 (8F), −130.0 to −129.0 (15.2F)

### Example 11

2.6 g (a number-average molecular weight of 2,351, 1.1 mmol) of the compound represented by Formula (1K) (in Formula (1K), Rf₂1k is represented by Formula (1KF), and in two Rf₂1k's, 11k indicating an average degree of polymerization is 3.8) was obtained in the sane operation as in Example 1 except that, in the fifth reaction, in place of the compound represented by Formula (11), 2.2 g (a molecular weight of 300, 7.2 mmol) of a compound represented by the following Formula (22) was used.

A compound represented by the following Formula (22) was synthesized by the following method.

2 equivalents of 3-buten-1-ol were reacted with 1 equivalent of epichlorohydrin. The obtained compound was reacted with 3,4-dihydro-2H-pyran, and a secondary hydroxy group of the compound was protected with a tetrahydropyranyl (THP) group. The double bond of the obtained compound on one side was oxidized using m-chloroperbenzoic acid. Through the above step, the compound represented by Formula (22) was obtained.

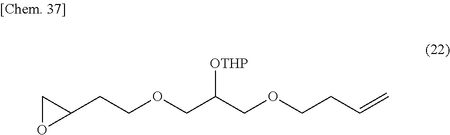

(in Formula (22), THP represents a tetrahydropyranyl group).

The obtained compound (1K) was subjected to ¹H-NMR and ¹⁹F-NMR measurement, and the structure was identified based on the following results. ¹H-NMR(CD₃COCD₃): δ[ppm]=1.66 to 1.81 (4H), 2.33 to 2.43 (4H), 3.39 to 4.34 (46H), 5.14 to 5.22 (2H), 5.26 to 5.35 (2H), 5.87 to 5.91 (2H) ¹⁹F-NMR(CD₃COCD₃): δ[ppm]=−84.0 to −83.0 (30.4F), −86.4 (8F), −124.3 (8F), −130.0 to −129.0 (15.2F)

### Example 12

2.6 g (a number-average molecular weight of 2.348, 1.1 mmol) of the compound represented by Formula (1L) (in Formula (1L.) Rf₁1l is represented by Formula (1LF), and in two Rf₁1i's, j1l indicating an average degree of polymerization is 6.3 and k1l indicating an average degree of polymerization is 0) was obtained in the same operation as in Example 9 except that, in the fifth reaction, in place of the compound represented by Formula (2O), 2.1 g (a molecular weight of 299, 7.2 mmol) of a compound represented by the following Formula (23) was used.

A compound represented by Formula (23) was synthesized by the following method.

A reaction product obtained by reacting cyanopropanol with epibroniohydrin was hydrolyzed. A primary hydroxy group of the obtained compound was protected with a tert-butyldimethylsilyl group, and a secondary hydroxy group was then protected with a tetrahydropyranyl group. The tert-butyldimethylsilyl group was deprotected from the compound in which the secondary hydroxy group was protected, and epibromohydrin was reacted. Through the above step, the compound represented by Formula (23) was obtained.

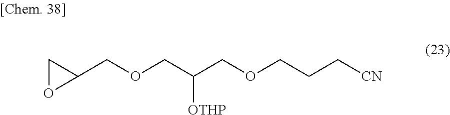

(in Formula (23), THP represents a tetrahydropyranyl group).

The obtained compound (1L) was subjected to ¹H-NMR and ¹⁹F-NMR measurement, and the structure was identified based on the following results. ¹H-NMR(CD₃COCD₃): δ[ppm]=1.15 to 1.25 (4H), 2.00 to 2.10 (4H), 3.39 to 4.34 (46H) ¹⁹F-NMR (CD₃COCD₃): δ[ppm]=−78.6 (4F), −81.3 (4F), −90.0 to −88.5 (50.4F)

### Example 13

2.6 g (a number-average molecular weight of 2,353, 1.1 mmol) of the compound represented by Formula (1M)(in Formula (1M), Rf₁1m is represented by Formula (1MF), and in two Rf₁1m's, j1m indicating an average degree of polymerization is 4.0 and k1m indicating an average degree of polymerization is 4.0) was obtained in the same operation as in Example 7 except that, in the fifth reaction, in place of the compound represented by Formula (18), 2.8 g (a molecular weight of 389, 7.2 mmol) of a compound represented by the following Formula (24) was used.

A compound represented by Formula (24) was synthesized by the following method.

A hydroxy group of ethylene glycol monoallyl ether was protected using dihydropyran, and the double bond of the obtained compound was oxidized. An epoxy group of the compound obtained by oxidizing the double bond was reacted with a hydroxy group of 4-penten-1-ol. A secondary hydroxy group of the obtained compound was protected with a THP group, and the double bond of the obtained compound was oxidized. Through the above step, the compound represented by Formula (24) was obtained.

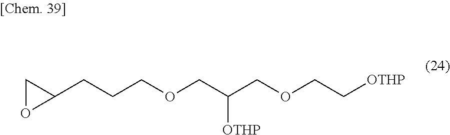

(in Formula (24). THP represents a tetrahydropyranyl group).

The obtained compound (1M) was subjected to ¹H-NMR and ¹⁹F-NMR measurement, and the structure was identified based on the following results. ¹H-NMR(CD₃COCD₃): δ[ppm]=1.64 to 1.81 (8H), 3.39 to 4.34 (52H) ¹⁹F-NMR(CD₃COCD₃): δ[ppm]=−55.6 to −50.6 (16F), −77.7 (4F), −80.3 (4F), −91.0 to −88.5 (32F)

### Example 14

The operation up to the sixth reaction was performed in the same manner as in Example 1 except that, in the fifth reaction, in place of the compound represented by Formula (1I), 1.9 g (a molecular weight of 264, 7.2 mmol) of the compound represented by the following Formula (25) was used.

31 g of a 10% hydrogen chloride/methanol solution (a hydrogen chloride-methanol reagent (5-10%), commercially available from Tokyo Chemical Industry Co., Ltd.) was added to the reaction product obtained in the sixth reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL of a saline solution, 100 n, of a saturated sodium bicarbonate solution, and 100 mL, of a saline solution in that order, and dehydrated with anhydrous sodium sulfate. After the desiccant was filtered, the filtrate was concentrated, and the residue was purified through silica gel column chromatography. When the above step was performed, 2.5 g (a number-average molecular weight of 2.270, 1.1 mmol) of the compound represented by Formula (1N) (in Formula (1N), Rf₂1n is represented by Formula (1NF), and in two Rf₂1n's, I1n indicating an average degree of polymerization is 3.8) was obtained.

A compound represented by Formula (25) was synthesized by the following method.

1,2,4-butanetriol was reacted with benzaldehyde dimethyl acetal. Accordingly, a compound in which hydroxy groups bonded to a carbon atom at position 2 and a carbon atom at position 4 in 1,2,4-butanetriol were protected was synthesized. This compound was reacted with 2-bromomethyloxiran. Through the above step, the compound represented by Formula (25) was obtained.

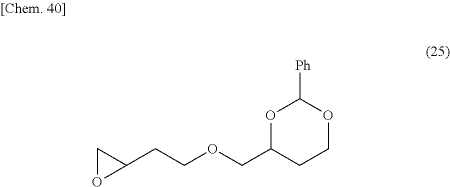 [SMILES: c1ccc(C2OCCC(COCCC3CO3)O2)cc1]

(in Formula (25), Ph represents a phenyl group).

The obtained compound (1N) was subjected to ¹H-NMR and ¹⁹F-NMR measurement, and the structure was identified based on the following results. ¹H-NMR(CD₃COCD₃): δ[ppm]=1.66 to 1.85 (8H), 3.31 to 4.43 (44H) ¹⁹F-NMR(CD₃COCD₃): δ[ppm]=−84.0 to −83.0 (30.4F), −86.4 (8F), −124.3 (8P), −130.0 to −129.0 (15.2F)

### Example 15

2.6 g (a number-average molecular weight of 2,384, 1.1 mmol) of the compound represented by Formula (1O) (in Formula (1O), Rf₁1o is represented by Formula (1OF), and in two Rf₁1o's, j1o indicating an average degree of polymerization is 6.3 and k1o indicating an average degree of polymerization is 0) was obtained in the same operation a: in Example 9 except, that, in the fifth reaction, in place of the compound represented by Formula (2O), 2.3 g (a molecular weight of 317, 7.2 mmol) of a compound represented by the following Formula (26) was used.

A compound represented by Formula (26) was synthesized by the following method.

2-acetamidoethanol was reacted with allyl glycidyl ether to obtain a compound. Next, a secondary hydroxy group of the obtained compound was protected with a THP group. The terminal double bond of the obtained compound was oxidized using meta-chloroperoxybenzoic acid in dichloromethane. Through the above step, the compound represented by Formula (26) was obtained.

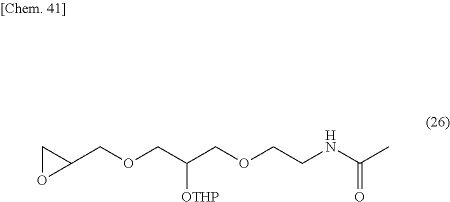

(in Formula (26), THP represents a tetrahydropyranyl group).

The obtained compound (1O) was subjected to ¹H-NMR and ¹⁹F-NMR measurement, and the structure was identified based on the following results. ¹H-NMR(CD₃COCD₃): δ[ppm]=1.80 to 1.9 (6H), 3.32 to 4.39 (50H), 7.25 to 7.41 (2H) ¹⁹F-NMR(CD₃COCD₃): δ[ppm]=−78.6 (4F), −81.3 (4F), −90.0 to −88.5 (50.4F)

### Example 16

The compound represented by Formula (2A) was obtained by the following method.

### (First Reaction)

7.1 g (11.6 mmol) of a compound (a number-average molecular weight of 610 and a molecular weight distribution of 1.1) represented by HOCH₂CF₂CF₂(CF₂CF₂CF₂O)ₗCF₂CF₂CH₂OH (in the formula, 1 indicating an average degree of polymerization is 2.0), 1.5 g (38 mmol) of 60% sodium hydride, and 12 mL of N,N-dimethylformamide were put into a 200 mL eggplant flask under a nitrogen gas atmosphere, and stirred at room temperature until they became uniform, 2.0 mL (24 mmol) of epibromohydrin was additionally added to the uniform solution, and the mixture was stirred and reacted at 40° C. for 2 hours,

The reaction product obtained after the reaction was cooled to 25° C., and 80 mL of water was added to stop the reaction. The mixed solution was transferred into a separatory funnel and extracted twice with 150 mL of ethyl acetate. The organic layer was washed with a saturated saline and dehydrated with anhydrous sodium sulfate. After the desiccant was filtered, the filtrate was concentrated, and the residue was purified through silica gel column chromatography to obtain 5.0 g (a molecular weight of 722, 7.0 mmol) of a compound represented by the following Formula (27) as an intermediate compound 2˜1.

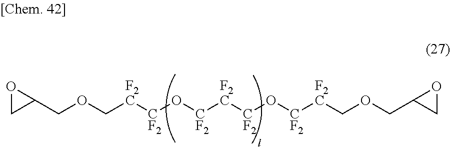

(in Formula (27), 1 indicating an average degree of polymerization represents 2.0).

### (Second Reaction)

15.5 g of a compound (a number-average molecular weight of 610 and a molecular weight distribution of 1.1) represented by HOCH₂CF₂CF₂O(CF₂CF₂CF₂O)ₗCF₂CF₂CH₂OH (in the formula, 1 indicating an average degree of polymerization is 2.0), 2.2 g of 3,4-dihydro-2H-pyran, and 88 mL of a mixed solution (a volume ratio of 1:1) containing Asahiklin (registered trademark) AF-3000 (commercially available from AGC) as a fluorine-based solvent and dichloromethane were put into a 300 mL eggplant flask under a nitrogen gas atmosphere, and stirred at 0° C. until they became uniform to form a mixture, 0.1 g of p-toluenesulfonic acid monohydrate was added to the mixture, the mixture was stirred at 0° C. for 30 minutes, and the mixture was then stirred and reacted at room temperature for 2 hours.

The reaction product obtained after the reaction was cooled to 0° C., and 50 mL of a saturated sodium bicarbonate solution was added to stop the reaction. The obtained reaction solution was transferred into a separatory funnel and extracted three times with 100 mL of ethyl acetate. The organic layer was washed with a saline and dehydrated with anhydrous sodium sulfate. After the desiccant was filtered, the filtrate was concentrated, and the residue was purified through silica gel column chromatography to obtain 10.2 g (a molecular weight of 694, 14.7 mmol) of the compound represented by Formula (7) (in Formula (7), 1 indicating an average degree of polymerization represents 2.0, and THP represents a tetrahydropyranyl group) as an intermediate compound 2-2.

### (Third Reaction)

10.0 g (a molecular weight of 694, 14.7 mmol) of the compound represented by Formula (7) as the intermediate compound 2.2, 0.23 g of potassium ten-butoxide, and 6.5 mL of t-butanol were put into a 200 mL eggplant flask under a nitrogen gas atmosphere, and stirred at room temperature until they became uniform, 5.0 g (a molecular weight of 722, 7.0 nmol) of the compound represented by Formula (27) as the intermediate compound 2-1 was additionally added to the uniform solution, and the mixture was stirred and reacted at 70° C. for 16 hours.

The reaction product obtained after the reaction was cooled to 25° C., transferred into a separatory funnel containing 100 mL of water, and extracted three times with 100 mL of ethyl acetate. The organic layer was washed with water and dehydrated with anhydrous sodium sulfate. After the desiccant was filtered, the filtrate was concentrated, and the residue was purified through silica gel column chromatography to obtain 11.7 g (a molecular weight of 2,110, 5.5 mmol) of a compound represented by the following Formula (28) as an intermediate compound 2-3.

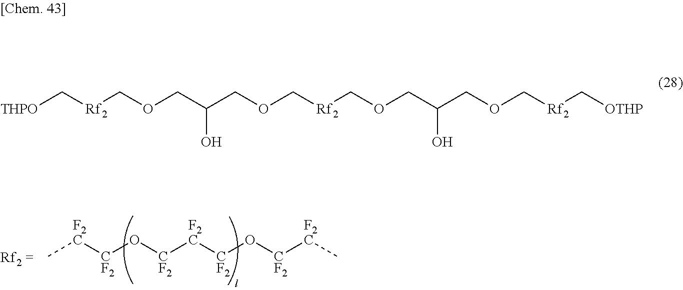

(in Formula (28), THP represents a tetrahydropyranyl group, Rf₂ is represented by the above formula; and in Rf₂, 1 indicating an average degree of polymerization represents 2.0).

### (Fourth Reaction)

11.7 g (a molecular weight of 2.110, 5.5 mmol) of the compound represented by Formula (28) as the intermediate compound 2-3, 11 mL of N,N-dimethylformamide, and 2.2 g of sodium hydride (a purity of 60%, a molecular weight of 24.A), 55 mmol) were put into a 200 mL eggplant flask under a nitrogen gas atmosphere, stirred at 0° C. until they became uniform, and additionally stirred at room temperature for 30 minutes. Then, 2.6 mL of benzyl 2-bromoethyl ether (a molecular weight of 215, 16.6 mmol) was added dropwise at 0° C., and the mixture was stirred at room temperature until it became uniform, 0.2 g of sodium hydride was added to the uniform solution, and the mixture was stirred at room temperature for 20 hours, and then stirred and reacted at 40° C. for 3 hours.

The reaction solution obtained after the reaction was returned to room temperature, and the reaction solution was transferred little by little into a separatory funnel containing 40 mL of a saline, and extracted three times with 40 mL of ethyl acetate. The organic layer was washed with 20 mL, of a saline and dehydrated with anhydrous sodium sulfate. After the desiccant was filtered, the filtrate was concentrated, and the residue was purified through silica gel column chromatography. When the above step was performed, 8.6 g of a compound represented by the following Formula (29) was obtained as an intermediate compound 2-4.

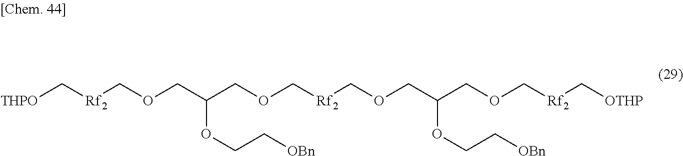

(in Formula (29), THP represents a tetrahydropyranyl group, Bn represents a benzyl group, and Rf₂ is the same as Rf₂ in Formula (28); and in RM₂, 1 indicating an average degree of polymerization represents 2.0).

### (Fifth Reaction)

8.6 g (a molecular weight of 2,379, 3.6 mmol) of the compound represented by Formula (29) as the intermediate compound 2-4 and 53 mL of trifluoroethanol were put into a 200 mL eggplant flask under a nitrogen gas atmosphere, and stirred at room temperature until they became uniform to form a mixture, 0.14 g of p-toluenesulfonic acid monohydrate was added to the mixture, and the mixture was stirred and reacted at room temperature for i hour.

0.15 mL of diisopropylethylamine was added to the reaction product obtained after the reaction to stop the reaction. The residue of the obtained reaction solution was purified through silica gel column chromatography to obtain 4.8 g of a compound represented by the following Formula (30) as an intermediate compound 2-5.

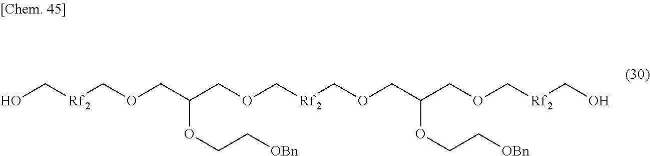

(in Formula (30), Bn represents a benzyl group, Rf₂ is the same as Rf₂ in Formula (28); and inRf₂, 1 indicating an average degree of polymerization represents 2.0).

### (Sixth Reaction)

4.8 g of the compound represented by Formula (30) (a number-average molecular weight of 2,211, 2.2 mmol) as the intermediate compound 2-5, 0.92 g of the compound represented by Formula (11) (a molecular weight of 202.3, 4.5 mmol) and 2 mL of t-butanol were put into a 200 mL eggplant flask under a nitrogen gas atmosphere, and stirred and reacted at room temperature until they became uniform,

The reaction product obtained after the reaction was cooled to 25° C.:, transferred into a separatory funnel containing 10 mL of water, and extracted three times with 100 mL of ethyl acetate. The organic layer was washed with water and dehydrated with anhydrous sodium sulfate. After the desiccant was filtered, the filtrate was concentrated, and the residue was purified through silica gel column chromatography to obtain 3.7 g of a compound represented by the following Formula (31) as an intermediate compound 2-6.

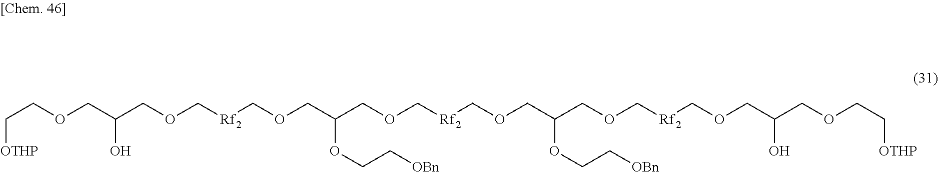

(in Formula (31), THP represents a tetrahydropyranyl group. Bn represents a benzyl group, and Rf₁ is the same as Rf₂ in Formula (28), and in Rf₂, 1 indicating an average degree of polymerization represents 2.0).

### (Seventh Reaction)

3.7 g of the compound represented by Formula (31) (a number-average molecular weight of 2615, 1.4 mmol) as the intermediate compound 2-6, 37 mL of methanol and 3.7 mL of formic acid were put into a 200 mL eggplant flask under a nitrogen gas atmosphere, and stirred at room temperature until they became uniform, 0.37 g of palladium on carbon (Pd/C) was additionally added to the uniform solution, and the mixture was stirred and reacted at 70° C. for 2 hours.

The reaction solution obtained after the reaction was filtered to remove Pd/C, the filtrate was concentrated, and the residue was then purified through silica gel column chromatography to obtain 2.6 g (a number-average molecular weight of 2.267, 1.1 mmol) of the compound represented by Formula (2A) (in Formula (2A), Rf₂2a is represented by Formula (2AF), and in three Rf₂2a's, 12a indicating an average degree of polymerization is 2.0).

The obtained compound (2A) was subjected to ¹H-NMR and ¹⁹F-NMR measurement, and the structure was identified based on the following results. ¹H-NMR (CD₃COCD₃): δ[ppm]=3.39 to 4.34 (54H) ¹⁹F-NMR(CD₃COCD₃): δ[ppm]=−84.0 to −83.0 (24F), −6.4 (12F), −124.3 (12F), −130.0 to −129.0 (12F)

### Example 17

2.5 g (a number-average molecular weight of 2,295, 1.1 mmol) of the compound represented by Formula (2B) (in Formula (2B), Rf₂ 2b is represented by Formula (2BF), and in three Rf₂2b's, 12b indicating an average degree of polymerization is 2.0) was obtained in the same operation as in Example 16 except that, in the sixth reaction, in place of the compound represented by Formula (11I), 1.0 g of the compound represented by Formula (13) was used.

The obtained compound (2B) was subjected to ¹H-NMR and ¹⁹F-NMR measurement, and the structure was identified based on the following results. ¹H-NMR(CD₃COCD₃): δ[ppm]=1.65 to 1.81 (4H), 3.39 to 4.35 (54H) ¹⁹F-NMR(CD₃COCD₃): δ[ppm]=−84.0 to −83.0 (24F), −86.4 (12F), −124.3 (12F), −130.0 to −129.0 (12F)

### Example 18

The operation up to the seventh reaction was performed in the same manner as in Example 16 except that, in the sixth reaction, in place of the compound represented by Formula (1I), 1.45 g of the compound represented by Formula (14) was used.

31 g of a 10% hydrogen chloride/methanol solution (a hydrogen chloride-methanol reagent (5-10%), commercially available from Tokyo Chemical industry Co. ltd.) was added to the reaction product obtained in the seventh reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL, of a saline solution, 100 mL, of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.7 g (a number-average molecular weight of 2,415, 1.1 mmol) of the compound represented by Formula (2C) (in Formula (2C), Rf₂2c is represented by Formula (2CF), and in three Rf₂2c's, 12c indicating an average degree of polymerization is 2.0) was obtained.

The obtained compound (2C) was subjected to ¹H-NMR and)F-NMR measurement, and the structure was identified based on the following results. ¹H-NMR(CD₃COCD₃): δ[ppm]=3.37 to 4.36 (66H) ¹⁹F-NMR(CD₃COCD₃): δ[ppm]=−84.0 to −83.0 (24F), −86.4 (12F), −124.3 (12F), −130.0 to −129.0 (12F)

### Example 19

The operation up to the seventh reaction was performed in the same manner as in Example 16 except that, in the sixth reaction, in place of the compound represented by Formula (1I), 1.52 g of the compound represented by Formula (15) was used.

31 g of a 10% hydrogen chloride/methanol solution (a hydrogen chloride-methanol reagent (5-10%), commercially available from Tokyo Chemical industry Co. ltd.) was added to the reaction product obtained in the seventh reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL, of a saline solution, 1 (0) mL, of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.7 g (a number-average molecular weight of 2,443, 1.1 mmol) of the compound represented by Formula 2D) (in Formula (2D), Rf₁2d is represented by Formula (2DF), and in three Rf₂2d's, 12d indicating an average degree of polymerization is 2.0) was obtained.

The obtained compound (2D) was subjected to ¹H-NMR and ¹⁹F-NMR measurement, and the structure was identified based on the following results. ¹H-NMR (CD₃COCD₃): δ[ppm]=1.65 to 1.81 (4H), 3.39 to 4.34 (66H) ¹⁹F-NMR(CD₃COCD₃): δ[ppm]=−84.0 to −83.0 (24F.−86.4 (12F), −124.3 (12F), −130.0 to −129.0 (12F)

### Example 20

2.5 g (a number-average molecular weight of 2.295, 1.1 mmol) of the compound represented by Formula (2E) (in Formula (2M), Rf₂2e is represented by Formula (2EF), and in three Rf₂2e's, l2e indicating an average degree of polymerization is 2.0) was obtained in the same operation as in Example 16 except that, in the sixth reaction, in place of the compound represented by Formula (1I), 1.0 g of the compound represented by Formula (16) was used.

The obtained compound (2E) was subjected to ¹H-NMR and ¹⁹F-NMR measurement, and the structure was identified based on the following results. ¹H-NMR(CD₃COCD₃): δ[ppm]=1.65 to 1.79 (4H), 3.41 to 4.33 (54H) ¹⁹F-NMR(CD₃COCD₃): δ[ppm]=−84.0 to −83.0 (24P)−86.4 (12F), −124.3 (12F), −130.0 to −129.0 (12F)

### Example 21

The operation up to the seventh reaction was performed in the same manner as in Example 16 except that, in the sixth reaction, in place of the compound represented by Formula (1), 1.5 g of the compound represented by Formula (17) was used.

31 g of a 10% hydrogen chloride/methanol solution (a hydrogen chloride-methanol reagent (5-10%), commercially available from Tokyo Chemical Industry Co., Ltd.) was added to the reaction product obtained in the seventh reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL of a saline solution, 100 mL of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.7 g (a number-average molecular weight of 2,443, 1.1 nmol) of the compound represented by Formula (2F) (in Formula (2F), Rf₂2f is represented by Formula (2FF), and in three Rf₂2f's, 12f indicating an average degree of polymerization is 2.0) was obtained.

The obtained compound (2F) was subjected to ¹H-NMR and ¹⁹F-NMR measurement, and the structure was identified based on the following results. ¹H-NMR(CD₃COCD₃): δ[ppm]=1.65 to 1.79 (4H), 3.41 to 4.33 (66H) ¹⁹F-NMR(CD₃COCD₃): δ[ppm]=−84.0 to −83.0 (24P)−86.4 (12F)), −124.3 (12F), −130.0 to −129.0 (12F)

### Example 22

2.4 g (a number-average molecular weight of 2,221, 1.1 mmol) of the compound represented by Formula (2G) (in Formula (2G), Rf₁2g is represented by Formula (2CF), and in three Rf₁2g's, j2g indicating an average degree of polymerization is 2.4 and k2g indicating an average degree of polymerization is 2.4) was obtained in the same operation as in Example 16 except that, in the first reaction and the second reaction, in place of the compound represented by HOCH₂CF₂CF₂O(CF₂CF₂CF₂O)ₗCF₂CF₂CH₂OH, a compound (a number-average molecular weight of 699 and a molecular weight distribution of 1.1) represented by HOCH₂CF₂O(CF₂CF₂O)₂(CF₂O)ₖCF₂CH₂OH (in the formula, j indicating an average degree of polymerization is 2.4, and k indicating an average degree of polymerization is 2.4) was used, and in the sixth reaction, in place of the compound represented by Formula (1I), 0.78 g of the compound represented by Formula (18) was used.

The obtained compound (2O) was subjected to ¹H-NMR and ¹⁹F-NMR measurement, and the structure was identified based on the following results. ¹H-NMR(CD₃COCD₃): δ[ppm]=1.66 to 1.79 (4H), 3.42 to 4.34 (46H) ¹⁹F-NMR(CD₃COCD₃): δ[ppm]=−55.6 to −50.6 (14.4F), −77.7 (6F), −80.3 (6F), −91.0 to −88.5 (28.8F)

### Example 23

2.5 g (a number-average molecular weight of 2,277, 1.1 mmol) of the compound represented by Formula (2H) (in Formula (2H), Rf₁2 h is represented by Formula (2HF), and in three Rf₁2h's, j2 h indicating an average degree of polymerization is 2.4 and k2 h indicating an average degree of polymerization is 2.4) was obtained in the same operation as in Example 22 except that, in the sixth reaction, in place of the compound represented by Formula (18), 0.91 g of the compound represented by Formula (19) was used.

The obtained compound (2H) was subjected to ¹H-NMR and ¹⁹-NMR measurement, and the structure was identified based on the following results, ¹H-NMR(CD₃COCD₃): δ[ppm]=1.37 to 1.81 (12H), 3.39 to 4.33 (46H) ¹⁹F-NMR(CD₃COCD₃): δ[ppm]=−55.6 to −50.6 (14.4F), −77.7 (6F), −80.3 (6F), −91.0 to −88.5 (28.8F)

### Example 24

The operation up to the seventh reaction was performed in the same manner as in Example 16 except that, in the first reaction and the second reaction, in place of the compound represented by HOCH₂CF₂CF₂O(CF₂CF₂CF₂O)ⱼCF₂CF₂CH₂OH, a compound (a number-average molecular weight of 703 and a molecular weight distribution of 1.1) represented by HOCH₂CF(CF₂CF₂O)₂(CF₂O)ₖCF₂CH₂OH (in the formula, j indicating an average degree of polymerization is 3.8, and k indicating an average degree of polymerization is 0) was used, and in the sixth reaction, in place of the compound represented by Formula (1I), 1.4 g of the compound represented by Formula (2O) was used.

31 g of a 10% hydrogen chloride/methanol solution (a hydrogen chloride-methanol reagent (5-10%), commercially available from Tokyo Chemical Industry Co., Ltd.) was added to the reaction product obtained in the seventh reaction, and the mixture was stirred at room temperature for 2 hours. The obtained reaction solution was transferred little by little into a separatory funnel containing 100 mL of a saline and extracted three times with 200 mL of ethyl acetate. The organic layer was washed with 100 mL of a saline solution, 100 mL of a saturated sodium bicarbonate solution, and 100 dL of a saline solution in that order, and dehydrated with anhydrous sodium sulfate. After the desiccant was filtered, the filtrate was concentrated, and the residue was purified through silica gel column chromatography. When the above step was performed, 2.6 g (a number-average molecular weight of 2.409, 1.1 mmol) of the compound represented by Formula (2I) (in Formula (2I), Rf₁2i is represented by Formula (21F), and in three Rf₁2i's, j2i indicating an average degree of polymerization is 3.8 and k2i indicating an average degree of polymerization is 0) was obtained.

The obtained compound (2I) was subjected to ¹H-NMR and ¹⁹F-NMR measurement, and the structure was identified based on the following results. ¹H-NMR (CD₃COCD₃): δ[ppm]=1.34 to 1.67 (8H), 3.39 to 4.34 (58H) ¹⁹F-NMR(CD₃COCD₃): δ[ppm]=−78.6 (6F), −81.3 (6F), −90.0 to −88.5 (45.6F)

### Example 25

2.6 g (a number-average molecular weight of 2,407, 1.1 mmol) of the compound represented by Formula (2.1) (in Formula (2.1), Rf₂2j is represented by Formula (2J), and in three Rf₂2j's, 12j indicating an average degree of polymerization is 2.0) was obtained in the same operation as in Example 16 except that, in the sixth reaction, in place of the compound represented by Formula (1I), 1.2 g of the compound represented by Formula (2I) was used.

The obtained compound (2J) was subjected to ¹H-NMR and ¹⁹F-NMR measurement, and the structure was identified based on the following results. ¹H-NMR(CD₃COCD₃): δ[ppm]=3.39 to 4.34 (60H), 5.14 to 5.22 (2H), 5.26 to 5.35 (2H), 5.87 to 5.91 (2H)¹⁹F-NMR(CD₃COCD₃): δ[ppm]=−84.0 to −83.0 (24F), −86.4 (12F), −124.3 (12F), −130.0 to −129.0 (12F)

### Example 26

2.7 g (a number-average molecular weight of 2,463, 1.1 mmol) of the compound represented by Formula (2K) (in Formula (2K), Rf₂2k is represented by Formula (2KF), and in three Rf₂2k's, 12k indicating an average degree of polymerization is 2.0) was obtained in the same operation as in Example 16 except that, in the sixth reaction, in place of the compound represented by Formula (1I), 1.4 g of the compound represented by Formula (22) was used.

The obtained compound (2K) was subjected to ¹H-NMR and ¹⁹F-NMR measurement, and the structure was identified based on the following results. ¹H-NMR(CD₃COCD₃): δ[ppm]=1.66 to 1.81 (4H), 2.33 to 2.43 (4H), 3.39 to 4.34 (60H), 5.14 to 5.22 (2H), 5.26 to 5.35 (2H), 5.87 to 5.91 (2H) ¹⁹F-NMR(CD₃COCD₃): δ[ppm]=−84.0 to −83.0 (24F), −86.4 (12F), −124.3 (12F), −130.0 to −129.0 (12F.

### Example 27

2.7 g (a number-average molecular weight of 2,487, 1.1 mmol) of the compound represented by Formula (2L) (in Formula (21.) Rf₁2l is represented by Formula (2LF), and in three Rf₁2l's, j2l indicating an average degree of polymerization is 3.8 and k2l indicating an average degree of polymerization is 0) was obtained in the same operation as in Example 24 except that, in the sixth reaction, in place of the compound represented by Formula (20), 1.4 g of the compound represented by Formula (23) was used.

The obtained compound (2L) was subjected to ¹H-NMR and ¹⁹P-NMR measurement, and the structure was identified based on the following results. ¹H-NMR(CD₃COCD₃): δ[ppm]=1.15 to 1.25 (4H), 2.00 to 2.1 (4H), 3.39 to 4.34 (60H) ¹⁹F-NMR(CD₃COCD₃): δ[ppm]=−78.6 (6F), −81.3 (6F), −90.0 to −88.5 (45.6F)

### Example 28

2.6 g (a number-average molecular weight of 2.327, 1.1 mmol) of the compound represented by Formula (2M) (in Formula (2M), Rf₁2m is represented by Formula (2MF), and in three Rf₂m's, j2m indicating an average degree of polymerization is 2.4 and k2m indicating an average degree of polymerization is 2.4) was obtained in the same operation as in Example 22 except that, in the sixth reaction, in place of the compound represented by Formula (18), 0.64 g (a molecular weight of 141, 4.5 mmol) of a compound represented by the following Formula (32) was used.

The compound represented by Formula (32) was synthesized by a method of oxidizing the reaction product of ethylene cyanohydrin and 4-bromo-1-butene.

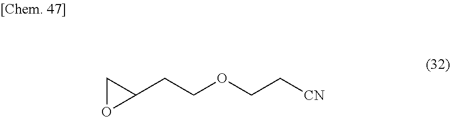

The obtained compound (2M) was subjected to ¹H-NMR and ¹⁹F-NMR measurement, and the structure was identified based on the following results. ¹H-NMR(CD₃COCD₃): δ[ppm]=1.15 to 1.25 (4H), 2.00 to 2.10 (4H), 3.65 to 4.10 (48H) ¹⁹F-NMR(CD₃COCD₃): δ[ppm]=−55.6 to −50.6 (14.4F), −77.7 (6F), −80.3 (6F), −91.0 to −88.5 (28.8F)

### Example 29

The operation up to the seventh reaction was performed in the same manner as in Example 16 except that, in the sixth reaction, in place of the compound represented by Formula (11), 1.2 g of the compound represented by Formula (25) was used.

31 g of a 10% hydrogen chloride/methanol solution (a hydrogen chloride-methanol reagent (5-10%), commercially available from Tokyo Chemical Industry Co., Ltd,) was added to the reaction product obtained in the seventh reaction, and the mixture was stirred at room temperature for 2 hours. The obtained reaction solution was transferred little by little into a separatory funnel containing 100 mL, of a saline and extracted three times with 200 mL of ethyl acetate. The organic layer was washed with 100 mL of a saline solution, 100 mL of a saturated sodium bicarbonate solution, and 100 mL of a saline solution in that order, and dehydrated with anhydrous sodium sulfate. After the desiccant was filtered, the filtrate was concentrated, and the residue was purified through silica gel column chromatography. When the above step was performed, 2.6 g (a number-average molecular weight of 2,383, 1.1 mmol) of the compound represented by Formula (2N) (in Formula (2N), Rf₂n is represented by Formula (2NF), and in three Rf₂2n's, 12n indicating an average degree of polymerization is 2.0) was obtained.

The obtained compound (2N) was subjected to ¹H-NMR and ¹⁹F-NMR measurement, and the structure was identified based on the following results. ¹H-NMR(CD₃COCD₃): δ[ppm]=1.66 to 1.85 (8H), 3.31 to 4.43 (58H) ¹⁹F-NMR(CD₃COCD₃): δ[ppm]=−84.0 to −83.0 (24F), −86.4 (12F), −124.3 (12F), −130.0 to −129.0 (12F)

### Example 30

2.8 g (a number-average molecular weight of 2.523, 1.1 mmol) of the compound represented by Formula (2O) (in Formula (2O), Rf₁2o is represented by Formula (2OF), and in three Rf₁2o's, j2o indicating an average degree of polymerization is 3.8 and k2o indicating an average degree of polymerization is 0) was obtained in the same operation as in Example 24 except that, in the sixth reaction, in place of the compound represented by Formula (2O), 1.4 g of the compound represented by Formula (26) was used.

The obtained compound (2O) was subjected to ¹H-NMR and ¹⁹F-NMR measurement, and the structure was identified based on the following results. ¹H-NMR(CD₃COCD₃): δ[ppm]=1.80 to 1.90 (6H), 3.32 to 4.39 (64H), 7.25 to 7.41 (2H) ¹⁹F-NMR(CD₃COCD₃): δ[ppm]=−78.6 (6F), −81.3 (6F), −90.0 to −88.5 (45.6F)

### Example 31

2.4 g (a number-average molecular weight of 2210, 1.1 mmol) of the compound represented by Formula (3A) (in Formula (3A), Rf₂3a is represented by Formula (3AF), and in two Rf₂3a's, 13a indicating an average degree of polymerization is 3.8) was obtained in the same operation as in Example 2 except that, in the third reaction, in place of benzyl 2-bromoethyl ether, 1.4 mL (a molecular weight of 243, 7.4 mmol) of benzyl 4-bromobutyl ether (BnO(CH₂)₄Br(Bn represents a benzyl group)) was used.

The obtained compound (3A) was subjected to ¹H-NMR and ¹⁹F-NMR measurement, and the structure was identified based on the following results. ¹H-NMR(CD₃COCD₃): δ[ppm]=1.56 to 1.82 (8H), 3.39 to 4.35 (40H) ¹⁹F-NMR(CD₃COCD₃): δ[ppm]=−84.0 to −83.0 (24F), −86.4 (12F), −124.3 (12F), −130.0 to −129.0 (12F)

### Example 32

2.4 g (a number-average molecular weight of 2,226, 1.1 mmol) of the compound represented by Formula (3B) (in Formula (3B), Rf₂3b is represented by Formula (3BF), and in two Rf₂ 3's, 13b indicating an average degree of polymerization is 3.8) was obtained in the same operation as in Example 2 except that, in the third reaction, in place of benzyl 2-bromoethyl ether, 1.9 g (a molecular weight of 259, 7.4 nmol) of 2-(2-benzyloxy)ethoxy-1-bromoethane(BnO(CH₄)₂O(CF₂)₂Br(Bn represents a benzyl group)) was used.

The obtained compound (3B) was subjected to ¹H-NMR and ^{I}F-NMR measurement, and the structure was identified based on the following results. ¹H-NMR(CD₃COCD₃): δ[ppm]=1.65 to 1.81 (4H), 3.39 to 4.42 (44H) ¹⁹F-NMR(CD₃COCD₃): δ[ppm]=−84.0 to −83.0 (24F), −86.4 (12F), −124.3 (12F), −130.0 to −129.0 (12F)

The values of x when the compounds (1A) to (1O), (2A) to (2O), (3A), and (3B) of Examples 1 to 32 thus obtained were applied to Formula(1), and the structures of R¹, R¹, R³, and R⁴ are shown in Table 1 to Table 4.

TABLE 1

| | x | R¹ | R² | R³ | R⁴ | Compound |
|---|---|---|---|---|---|---|
| Example | 1 | Formula | Formula | Formula | Same as | (1A) |
| 1 | | (4-1) | (6-2) | (3-1) | R¹ | |
| | | b = 1 | l = 3.8 | a = 2 | | |
| | | c = 1 | | y1 = 1 | | |
| | | X = —OH | | y2 = 1 | | |
| Example | 1 | Formula | Formula | Formula | Same as | (1B) |
| 2 | | (4-1) | (6-2) | (3-1) | R¹ | |
| | | b = 1 | l = 3.8 | a = 2 | | |
| | | c = 2 | | y1 = 1 | | |
| | | X = —OH | | y2 = 1 | | |
| Example | 1 | Formula | Formula | Formula | Same as | (1C) |
| 3 | | (4-1) | (6-2) | (3-1) | R¹ | |
| | | b = 2 | l = 3.8 | a = 2 | | |
| | | c = 1 | | y1 = 1 | | |
| | | X = —OH | | y2 = 1 | | |
| Example | 1 | Formula | Formula | Formula | Same as | (1D) |
| 4 | | (4-1) | (6-2) | (3-1) | R¹ | |
| | | b = 2 | l = 3.8 | a = 2 | | |
| | | c = 2 | | y1 = 1 | | |
| | | X = —OH | | y2 = 1 | | |
| Example | 1 | Formula | Formula | Formula | Same as | (1E) |
| 5 | | (4-2) | (6-2) | (3-1) | R¹ | |
| | | d = 1 | l = 3.8 | a = 2 | | |
| | | e = 0 | | y1 = 1 | | |
| | | f = 1 | | y2 = 1 | | |
| | | X = —OH | | | | |
| Example | 1 | Formula | Formula | Formula | Same as | (1F) |
| 6 | | (4-2) | (6-2) | (3-1) | R¹ | |
| | | d = 1 | l = 3.8 | a = 2 | | |
| | | e = 1 | | y1 = 1 | | |
| | | f = 1 | | y2 = 1 | | |
| | | X = —OH | | | | |
| Example | 1 | Formula | Formula | Formula | Same as | (1G) |
| 7 | | (4-3) | (6-1) | (3-1) | R¹ | |
| | | g = 0 | j = 4.0 | a = 2 | | |
| | | h = none | k = 4.0 | y1 = 1 | | |
| | | i = 1 | | y2 = 1 | | |
| | | X = —OH | | | | |
| Example | 1 | Formula | Formula | Formula | Same as | (1H) |
| 8 | | (4-3) | (6-1) | (3-1) | R¹ | |
| | | g = 0 | j = 4.0 | a = 2 | | |
| | | h = none | k = 4.0 | y1 = 1 | | |
| | | i = 3 | | y2 = 1 | | |
| | | X = —OH | | | | |

TABLE 2

| | x | R¹ | R² | R³ | R⁴ | Compound |
|---|---|---|---|---|---|---|
| Example | 1 | Formula | Formula | Formula | Same as | (1I) |
| 9 | | (4-3) | (6-1) | (3-1) | R¹ | |
| | | g = 1 | j = 6.3 | a = 2 | | |
| | | h = 1 | k = 0 | y1 = 1 | | |
| | | i = 2 | | y2 = 1 | | |
| | | X = —OH | | | | |
| Example | 1 | Formula | Formula | Formula | Same as | (1J) |
| 10 | | (4-1) | (6-2) | (3-1) | R¹ | |
| | | b = 2 | l = 3.8 | a = 2 | | |
| | | c = 0 | | y1 = 1 | | |
| | | X = —CH═CH₂ | | y2 = 1 | | |
| Example | 1 | Formula | Formula | Formula | Same as | (1K) |
| 11 | | (4-2) | (6-2) | (3-1) | R¹ | |
| | | d = 1 | l = 3.8 | a = 2 | | |
| | | e = 1 | | y1 = 1 | | |
| | | f = 1 | | y2 = 1 | | |
| | | X = —CH═CH₂ | | | | |
| Example | 1 | Formula | Formula | Formula | Same as | (1L) |
| 12 | | (4-1) | (6-1) | (3-1) | R¹ | |
| | | b = 2 | j = 6.3 | a = 2 | | |
| | | c = 2 | k = 0 | y1 = 1 | | |
| | | X = —CN | | y2 = 1 | | |
| Example | 1 | Formula | Formula | Formula | Same as | (1M) |
| 13 | | (4-2) | (6-1) | (3-1) | R¹ | |
| | | d = 2 | j = 4.0 | a = 2 | | |
| | | e = 1 | k = 4.0 | y1 = 1 | | |
| | | f = 1 | | y2 = 1 | | |
| | | X = —OH | | | | |
| Example | 1 | Formula | Formula | Formula | Same as | (1N) |
| 14 | | (4-3) | (6-2) | (3-1) | R¹ | |
| | | g = 1 | l = 3.8 | a = 2 | | |
| | | h = 2 | | y1 = 1 | | |
| | | i = 1 | | y2 = 1 | | |
| | | X = —OH | | | | |
| Example | 1 | Formula | Formula | Formula | Same as | (1O) |
| 15 | | (4-1) | (6-1) | (3-1) | R¹ | |
| | | b = 2 | j = 6.3 | a = 2 | | |
| | | c = 1 | k = 0 | y1 = 1 | | |
| | | X = —NHCOCH₃ | | y2 = 1 | | |
| Example | 2 | Formula | Formula | Formula | Same as | (2A) |
| 16 | | (4-1) | (6-2) | (3-1) | R¹ | |
| | | b = 1 | l = 2.0 | a = 2 | | |
| | | c = 1 | | y1 = 1 | | |
| | | X = —OH | | y2 = 1 | | |

TABLE 3

| | x | R¹ | R² | R³ | R⁴ | Compound |
|---|---|---|---|---|---|---|
| Example | 2 | Formula | Formula | Formula | Same as | (2B) |
| 17 | | (4-1) | (6-2) | (3-1) | R¹ | |
| | | b = 1 | l = 2.0 | a = 2 | | |
| | | c = 2 | | y1 = 1 | | |
| | | X = —OH | | y2 = 1 | | |
| Example | 2 | Formula | Formula | Formula | Same as | (2C) |
| 18 | | (4-1) | (6-2) | (3-1) | R¹ | |
| | | b = 2 | l = 2.0 | a = 2 | | |
| | | c = 1 | | y1 = 1 | | |
| | | X = —OH | | y2 = 1 | | |
| Example | 2 | Formula | Formula | Formula | Same as | (2D) |
| 19 | | (4-1) | (6-2) | (3-1) | R¹ | |
| | | b = 2 | l = 2.0 | a = 2 | | |
| | | c = 2 | | y1 = 1 | | |
| | | X = —OH | | y2 = 1 | | |
| Example | 2 | Formula | Formula | Formula | Same as | (2E) |
| 20 | | (4-2) | (6-2) | (3-1) | R¹ | |
| | | d = 1 | l = 2.0 | a = 2 | | |
| | | e = 0 | | y1 = 1 | | |
| | | f = 1 | | y2 = 1 | | |
| | | X = —OH | | | | |
| Example | 2 | Formula | Formula | Formula | Same as | (2F) |
| 21 | | (4-2) | (6-2) | (3-1) | R¹ | |
| | | d = 1 | l = 2.0 | a = 2 | | |
| | | e = 1 | | y1 = 1 | | |
| | | f = 1 | | y2 = 1 | | |
| | | X = —OH | | | | |
| Example | 2 | Formula | Formula | Formula | Same as | (2G) |
| 22 | | (4-3) | (6-1) | (3-1) | R¹ | |
| | | g = 0 | j = 2.4 | a = 2 | | |
| | | h: none | k = 2.4 | y1 = 1 | | |
| | | i = 1 | | y2 = 1 | | |
| | | X = —OH | | | | |
| Example | 2 | Formula | Formula | Formula | Same as | (2H) |
| 23 | | (4-3) | (6-1) | (3-1) | R¹ | |
| | | g = 0 | j = 2.4 | a = 2 | | |
| | | h: none | k = 2.4 | y1 = 1 | | |
| | | i = 3 | | y2 = 1 | | |
| | | X = —OH | | | | |
| Example | 2 | Formula | Formula | Formula | Same as | (2I) |
| 24 | | (4-3) | (6-1) | (3-1) | R¹ | |
| | | g = 1 | j = 3.8 | a = 2 | | |
| | | h = 1 | k = 0 | y1 = 1 | | |
| | | i = 2 | | y2 = 1 | | |
| | | X = —OH | | | | |

TABLE 4

| | x | R¹ | R² | R³ | R⁴ | Compound |
|---|---|---|---|---|---|---|
| Example | 2 | Formula | Formula | Formula | Same as | (2J) |
| 25 | | (4-1) | (6-2) | (3-1) | R¹ | |
| | | b = 2 | l = 2.0 | a = 2 | | |
| | | c = 0 | | y1 = 1 | | |
| | | X = —CH═CH₂ | | y2 = 1 | | |
| Example | 2 | Formula | Formula | Formula | Same as | (2K) |
| 26 | | (4-2) | (6-2) | (3-1) | R¹ | |
| | | d = 1 | l = 2.0 | a = 2 | | |
| | | e = 1 | | y1 = 1 | | |
| | | f = 1 | | y2 = 1 | | |
| | | X = —CH═CH₂ | | | | |
| Example | 2 | Formula | Formula | Formula | Same as | (2L) |
| 27 | | (4-1) | (6-1) | (3-1) | R¹ | |
| | | b = 2 | j = 3.8 | a = 2 | | |
| | | c = 2 | k = 0 | y1 = 1 | | |
| | | X = —CN | | y2 = 1 | | |
| Example | 2 | Formula | Formula | Formula | Same as | (2M) |
| 28 | | (4-2) | (6-1) | (3-1) | R¹ | |
| | | d = 1 | j = 2.4 | a = 2 | | |
| | | e = 0 | k = 2.4 | y1 = 1 | | |
| | | f = 1 | | y2 = 1 | | |
| | | X = —CN | | | | |
| Example | 2 | Formula | Formula | Formula | Same as | (2N) |
| 29 | | (4-3) | (6-2) | (3-1) | R¹ | |
| | | g = 1 | l = 2.0 | a = 2 | | |
| | | h = 2 | | y1 = 1 | | |
| | | i = 1 | | y2 = 1 | | |
| | | X = —OH | | | | |
| Example | 2 | Formula | Formula | Formula | Same as | (2O) |
| 30 | | (4-1) | (6-1) | (3-1) | R¹ | |
| | | b = 2 | j = 3.8 | a = 2 | | |
| | | c = 1 | k = 0 | y1 = 1 | | |
| | | X = —NHCOCH₃ | | y2 = 1 | | |
| Example | 1 | Formula | Formula | Formula | Same as | (3A) |
| 31 | | (4-1) | (6-2) | (3-1) | R¹ | |
| | | b = 1 | l = 3.8 | a = 4 | | |
| | | c = 2 | | y1 = 1 | | |
| | | X = —OH | | y2 = 1 | | |
| Example | 1 | Formula | Formula | Formula | Same as | (3B) |
| 32 | | (4-1) | (6-2) | (3-2) | R¹ | |
| | | b = 1 | l = 3.8 | y3 = 1 | | |
| | | c = 2 | | y4 = 1 | | |
| | | X = —OH | | | | |

### Comparative Example 1

A compound represented by the following Formula (4A) was, synthesized by the method escribed in Patent Document 1.

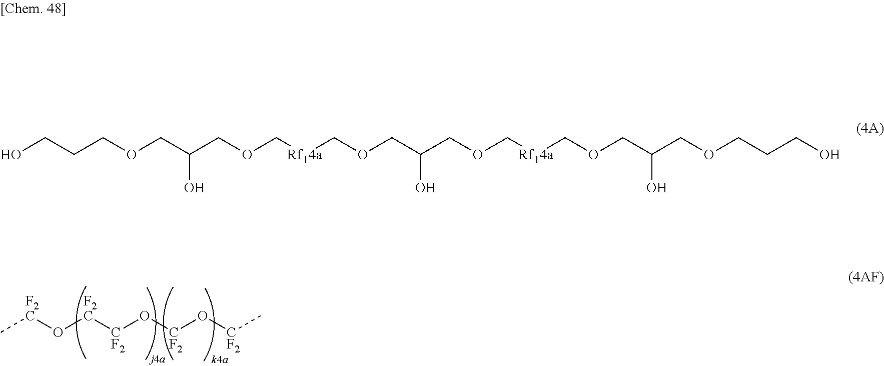

(in Formula (4A), Rf₁4a is the PFPE chain represented by Formula (4AF); and in two Rf₁4a's, j4a indicating an average degree of polymerization represents 4.0).

### Comparative Example 2

A compound represented by the following Formula (4A) was, synthesized by the method escribed in Patent Document 2.

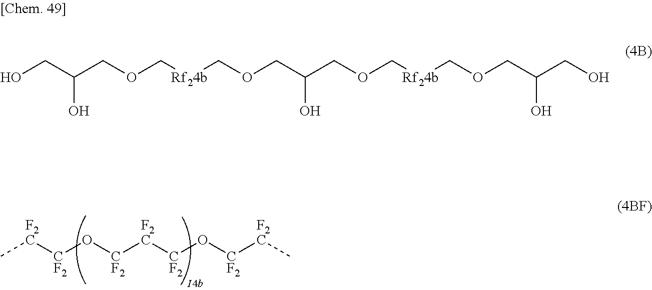

(in Formula (4B), Rf₂4b is the PFPE chain represented by Formula (4BF); and in two Rf₂4b's, l4b indicating an average degree of polymerization represents 3.8).

### Comparative Example 32

A compound represented by the following Formula (40) was synthesized by the method described in Patent Document 4.

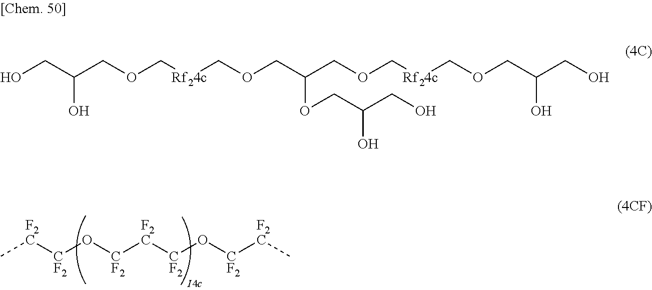

(in Formula (4C), Rf₂4c is the PRPE chain represented by Formula (4OF); and in two Rf₂4c's, l4c indicating an average degree of polymerization represents 3.8s.

### Comparative Example 41

A compound represented by the following Formula (4D) was synthesized by the method described in Patent Document 4,

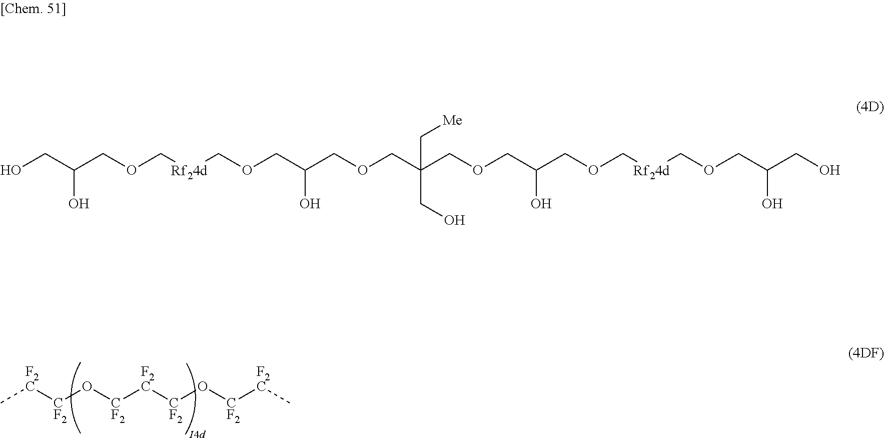

(in Formula (4D), Rf₂4d is the PFPE chain represented by Formula (4OF), and in two Rf₂4d's, l4d indicating an average degree of polymerizaiton represents 3.8).

### Comparative Example 5

A compound represented by the following Formula (4E) was synthesized by the method described in Patent Document 4.

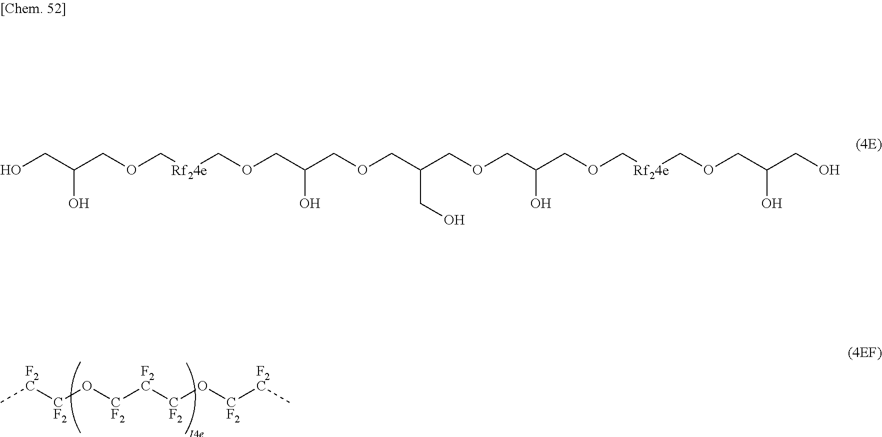

(in Formula (4E), Rf₂4e is the PFPE chain represented by Formula (4EF); and in two Rf₂4e's, l4e indicating an average degree of polymerization represents 3.8).

### Comparative Example 6

A compound represented by the following Formula (4F) was synthesized by the method described in Patent Document 3.

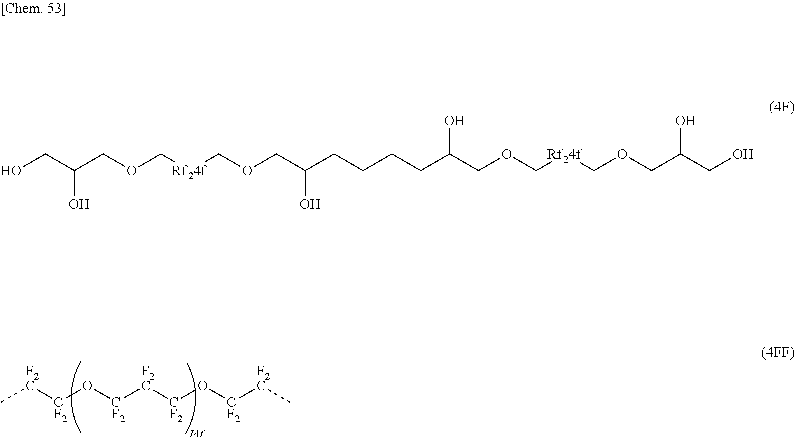

(in Formula (4F), Rf₂4f is the PFPE chain represented by Formula (4FF), and in two Rf₂4f's, l4f indicating an average degree of polymerization represents 3.8).

### Comparative Example 7

A compound represented by the following Formula (4G) was synthesized by the following method.

20 g of a compound (a number-average molecular weight of 909 and a molecular weight distribution of 1.1) represented by HOCH₂CF₂CF₂CF₂O(CF₂CF₂CF₂O)CF₂CF₂OH (in the formula, 1 indicating an average degree of polymerization is 3.8), 2.4 g of the compound represented by Formula (11), and 20 mL, of t-butanol were put into a 200 mL eggplant flask under a nitrogen gas atmosphere, and stirred at room temperature until they became uniform, 0.67 g of potassium tert-butoxide was additionally added to the uniform solution, and the mixture was stirred and reacted at 70° C. for 16 hours.

The reaction product obtained after the reaction was cooled to 25° C., transferred into a separatory funnel containing 0 mL of water, and extracted three times with 100 mL of ethyl acetate. The organic layer was washed with water and dehydrated with anhydrous sodium sulfate. After the desiccant was filtered, the filtrate was concentrated, and the residue was purified through silica gel column chromatography to obtain 8.9 g (a molecular weight of 1,111, 8.0 mmol) of a compound represented by the following Formula (33) as an intermediate.

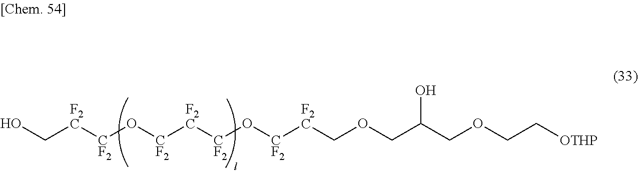

(in Formula (33), 1 indicating an average degree of polymerization represents 3.8, and THP represents a tetrahydropyranyl group).

Subsequently, 8.9 g of the compound represented by Formula (33) as the intermediate and 80 mL of NN-dimethylformamide were put into a 200 mL eggplant flask under a nitrogen gas atmosphere, and stirred at room temperature until they became uniform. The uniform solution was cooled to OT, 0.33 g of sodium hydride (a purity of 6)%, a molecular weight of 24.00, 8.2 mmol) was added, and the mixture was stirred for 30 minutes. Then, 1.31 g (a molecular weight of 328.04, 4.0 mmol) of a compound represented by Formula (34) was gradually added, and the mixture was stirred and reacted at room temperature for 24 hours.

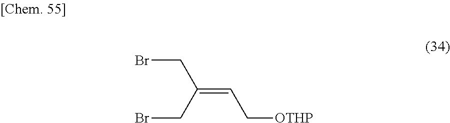

(in Formula (34). THP represents a tetrahydropyranyl group).

10 mL of water was gradually added to the reaction solution obtained after the reaction under ice cooling, and the mixture was transferred little by little into a separatory funnel containing 100 mL of a saturated saline solution and extracted three times with 200 mL of a mixed solvent of ethyl acetate and hexane. Each extracted organic layer was washed with 100 mL of a saline solution and dehydrated with anhydrous sodium sulfate. After the desiccant was filtered, the filtrate was concentrated, and the residue was purified through silica gel column chromatography to obtain 3,7 g (a molecular weight of 2,307, 1.6 mmol) of a compound represented by Formula (35) as an intermediate.

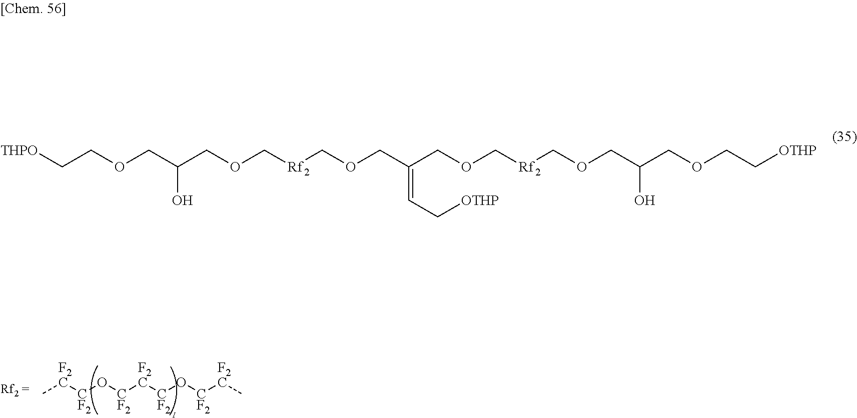

(in Formula (35), Rf₂ is the PFPE chain represented by the above formula; and in two Rf₂'s, 1 indicating an average degree of polymerization represents 3.8).

The compound represented by Formula (34) used in the above reaction was synthesized by a 5-step reaction from a first reaction to a fifth reaction shown below.

One hydroxy group of ethylene glycol was protected with a tetrahydropyranyl (THP) group (first Reaction). Next, the other hydroxy group of ethylene glycol was changed into an aldehyde group by Swern oxidation to obtain an aldehyde compound represented by Formula (36) (second Reaction). A compound represented by Formula (37) was obtained by a Knoevenagel condensation reaction between the obtained aldehyde compound represented by Formula (36) and dimethyl malonate (third Reaction). A compound represented by Formula (3B) was obtained by reducing esters of the obtained compound represented by Formula (37) (fourth Reaction). Then, a compound represented by Formula (34) was obtained by brominating the hydroxy group of the compound represented by Formula (3B) by the Appel reaction (fifth Reaction).

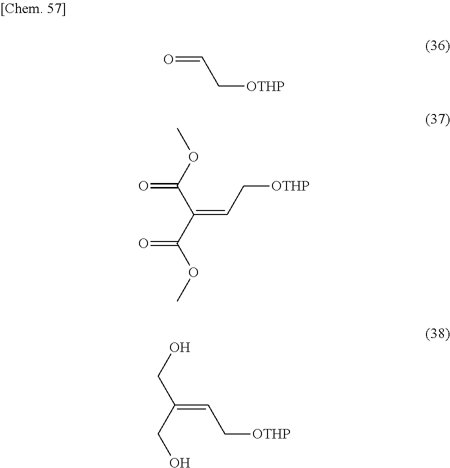

(in Formula (36), THP represents a tetrahydropyranyl group).
(in Formula (37), THP represents a tetrahydropyranyl group).
(in Formula (3B). THP represents a tetrahydropyranyl group).

3.7 g of the compound represented by Formula (35), 30 mL of ethanol, and 0.10 g of palladium on carbon (Pd/C) (5% Pd) were put into a 200 mL eggplant flask under a nitrogen gas atmosphere, the reaction system was made into a hydrogen atmosphere, and the mixture was stirred at room temperature for 16 hours. After removing Pd/C by celite filtration, 30 mL of a 5% hydrogen chloride methanol solution was added to the filtrate, and the mixture was stirred at room temperature for 2 hours. The reaction solution was neutralized with 125 mL of a saturated sodium bicarbonate aqueous solution, and then extracted three times with 250 mL of ethyl acetate. Each extracted organic layer was washed with 125 mL of a saturated sodium chloride aqueous solution and dehydrated with anhydrous sodium sulfate. After the desiccant was filtered, the filtrate was concentrated, and the residue was purified through silica gel column chromatography to obtain 3.0 g of a compound represented by the following Formula (4G) (a number-average molecular weight of 2138, 1.4 mmol).

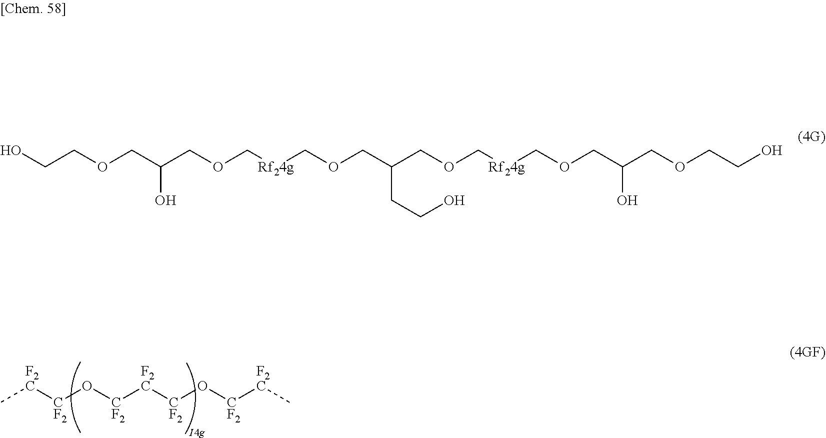

(in Formula (4G), Rf₂₄g is the PFPE chain represented by Formula (40P); and in two Rf₂₄g's, 14g indicating an average degree of polymerization represents 3.8).

The obtained compound (4G) was subjected to ¹H-NMR and ¹⁹F-NMR measurement, and the structure was identified based on the following results, ¹H-NMR(CD₃COCD₃): δ[ppm]=1.51 to 1.89 (7H), 3.4 to 4.3 (37H) ¹⁹F-NMR(CD₃COCD₃): δ[ppm]=−84,0 to −83 (30.4F), −86.4 (8F), −124.3 (8P), −130.0 to −129.0 (15.2F)

### Comparative Example 8

A compound represented by the following Formula (4H) was synthesized by the method described in Patent Document 6.

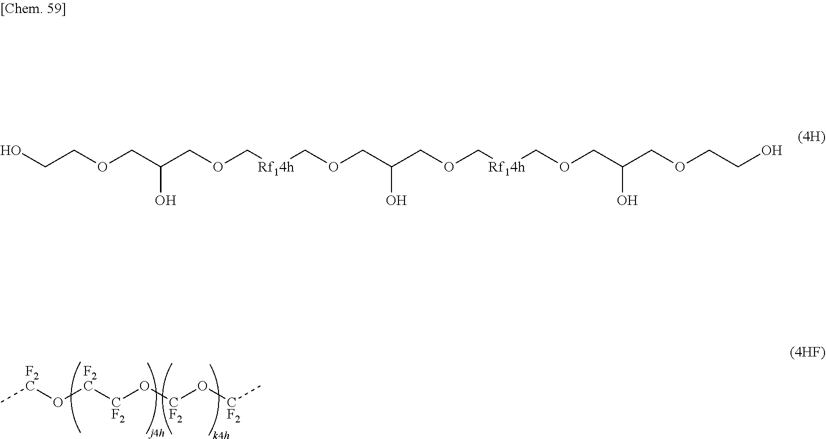

(in Formula (4H), Rf₁4 h is the PFPE chain represented by Formula (4HF); in the center Rf₁4 h among three Rf₁4 h's, j4 h indicating an average degree of polymerization represents 3.8, and k4 h indicating an average degree of polymerization represents 0; and in two Rf₁4 h's on the terminal side, j4 h indicating an average degree of polymerization represents 2.4, and k4 h indicating an average degree of polymerization represents 2.4).

### Comparative Example 9

A compound represented by the following Formula (4I) was synthesized by the method described in Patent Document 7.

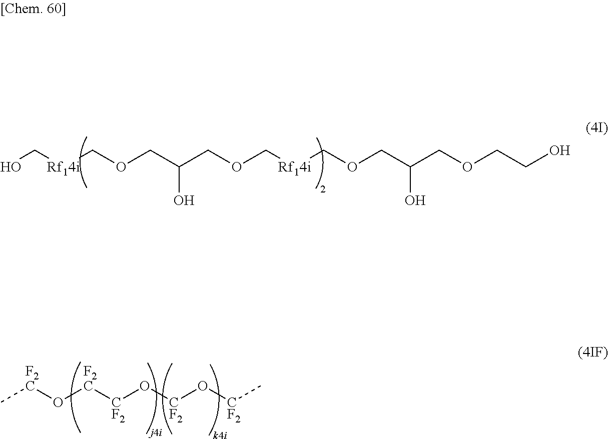

(in Formula (4I), Rf₁4i is the PFPE chain represented by Formula (41F); and in three Rf₁4i's, j4i indicating an average degree of polymerization represents 3.8 and k4i indicating an average degree of polymerization represents 0).

### Comparative Example 10

A compound represented by the following Formula (4) was synthesized by the method described in Patent Document 5. The operation described in Patent Document 5 was performed except that a compound (a number-average molecular weight of 699 and a molecular weight distribution of 1.1) represented by HOCH₂CF₂O(CF₂CF₂O)ⱼ(CF₂O)ₖCF₂CH₂OH (in the formula, j indicating an average degree of polymerization is 2.4 and k indicating an average degree of polymerization is 2.4) was used in place of HOCH₂CF₂O(CF₂CF₂O)ⱼCF₂CH₂OH, and thereby 2.5 g (a number-average molecular weight of 2,253, 1.1 mmol) of a compound represented by the following Formula (Q) was obtained.

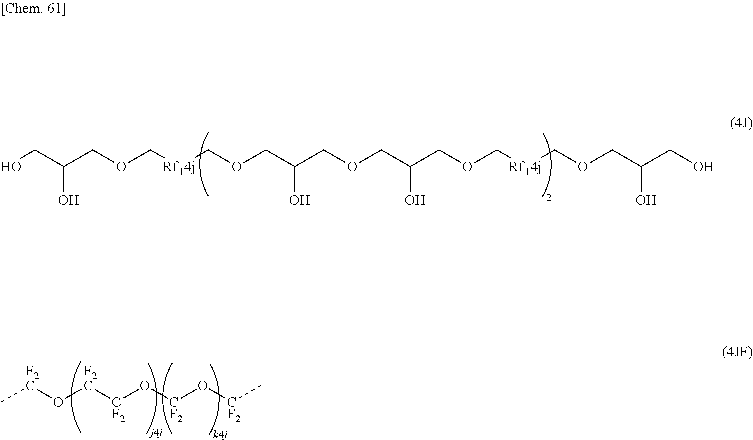

(in Formula (4i), Rf₁4j is the PFPE chain represented by Formula (4JF); and in three Rf₁4j's, j4j indicating an average degree of polymerization represents 2.4 and k₄j indicating an average degree of polymerization represents 2.4).

The number-average molecular weight (Mn) of the compounds of Examples 1 to 32 and Comparative Examples 1 to 10 thus obtained was measured by the method. The results are shown in Table 5 or Table 6.

TABLE 5

| | | Number- | | | |
|---|---|---|---|---|---|
| | | average | | | |
| | | molecular | Film | Flying | Chemical |
| | | weight | thickness | stability | resistance |
| | Compound | (Mn) | (Å) | test | test |
| Example 1 | (1A) | 2154 | 9.5 | B | A |
| Example 2 | (1B) | 2182 | 9.5 | A | A |
| Example 3 | (1C) | 2302 | 9.4 | A | B |
| Example 4 | (1D) | 2331 | 9.5 | A | B |
| Example 5 | (1E) | 2182 | 9.4 | B | B |
| Example 6 | (1F) | 2331 | 9.4 | B | B |
| Example 7 | (1G) | 2089 | 9.6 | A | A |
| Example 8 | (1H) | 2145 | 9.4 | A | 8 |
| Example 9 | (1I) | 2270 | 9.4 | A | A |
| Example 10 | (1J) | 2295 | 9.5 | B | B |
| Example 11 | (1K) | 2351 | 9.3 | B | B |
| Example 12 | (1L) | 2348 | 9.6 | A | B |
| Example 13 | (1M) | 2353 | 9.5 | A | A |
| Example 14 | (1N) | 2270 | 9.5 | B | B |
| Example 15 | (1O) | 2384 | 9.5 | A | B |
| Example 16 | (2A) | 2267 | 9.6 | B | A |
| Example 17 | (2B) | 2295 | 9.6 | A | A |
| Example 18 | (2C) | 2415 | 9.5 | A | B |
| Example 19 | (2D) | 2443 | 9.5 | A | B |
| Example 20 | (2E) | 2295 | 9.4 | B | B |
| Example 21 | (2F) | 2443 | 9.6 | B | B |
| Example 22 | (2G) | 2221 | 9.5 | A | A |
| Example 23 | (2H) | 2277 | 9.5 | A | B |
| Example 24 | (2I) | 2409 | 9.5 | A | A |
| Example 25 | (2J) | 2407 | 9.4 | B | B |
| Example 26 | (2K) | 2463 | 9.5 | B | B |
| Example 27 | (2L) | 2487 | 9.5 | A | B |
| Example 28 | (2M) | 2327 | 9.5 | B | A |
| Example 29 | (2N) | 2383 | 9.6 | B | B |
| Example 30 | (2O) | 2523 | 9.6 | A | B |
| Example 31 | (3A) | 2210 | 9.5 | A | B |
| Example 32 | (3B) | 2226 | 9.4 | A | A |

TABLE 6

| | | Number- | | | |
|---|---|---|---|---|---|
| | | average | | | |
| | | molecular | Film | Flying | Chemical |
| | | weight | thickness | stability | resistance |
| | Compound | (Mn) | (Å) | test | test |
| Comparative | (4A) | 2133 | 9.5 | C | D |
| Example 1 | | | | | |
| Comparative | (4B) | 2022 | 9.5 | E | E |
| Example 2 | | | | | |
| Comparative | (4C) | 2096 | 9.5 | D | E |
| Example 3 | | | | | |
| Comparative | (4D) | 2064 | 9.5 | D | D |
| Example 4 | | | | | |
| Comparative | (4E) | 2184 | 9.4 | D | D |
| Example 5 | | | | | |
| Comparative | (4F) | 2108 | 9.6 | D | D |
| Example 6 | | | | | |
| Comparative | (4G) | 2138 | 9.6 | B | C |
| Example 7 | | | | | |
| Comparative | (4H) | 2197 | 9.5 | C | C |
| Example 8 | | | | | |
| Comparative | (4I) | 2088 | 9.4 | E | B |
| Example 9 | | | | | |
| Comparative | (4J) | 2253 | 9.5 | C | D |
| Example 10 | | | | | |

Next, by the following method, lubricating layer forming solutions were prepared using the compounds obtained in Examples 1 to 32 and Comparative Examples 1 to 10. Then, lubricating layers of magnetic recording media were formed using the obtained lubricating layer forming solution by the following method, and magnetic recording media of Examples 1 to 32 and Comparative Examples 1 to 10 were obtained.

### “Lubricating Layer Forming Solution”

The compounds obtained in Examples 1 to 32 and Comparative Examples 1 to 10 were each dissolved in Vertel (registered trademark) XF (product name, commercially available from Du Pont-Mitsui Fluorochemicals Co., Ltd.) as a fluorine-based solvent and diluted with Vertel XF so that the film thickness when applied onto the protective layer was 9.0 Å to 9.6 Å, and thereby a lubricating layer forming solution was obtained.

### “Magnetic Recording Medium”

A magnetic recording medium in which an adhesive layer, a soft magnetic layer, a first base layer, a second base layer, a magnetic layer and a protective layer were sequentially provided on a substrate with a diameter of 65 mm was prepared. The protective layer was made of carbon.

The lubricating layer forming solutions of Examples 1 to 32 and Comparative Examples 1 to 10 were applied onto the protective layer of the magnetic recording medium in which respective layers up to the protective layer were formed by a dipping method. Hew, the dipping method was performed under conditions of an immersion speed of 10 mm/sec, an immersion time of 30 sec, and a lifting speed of 1.2 mm/sec. Then, the magnetic recording medium to which the lubricating layer forming solution was applied was put into a thermostatic chamber and subjected to a heat treatment at 120° C. for 10 minutes in order to remove the solvent in the lubricating layer forming solution and improve the adhesion between the protective layer and the lubricating layer, and thus a lubricating layer was formed on the protective layer to obtain a magnetic recording medium.

### (Measurement of Film Thickness)

The film thickness of the lubricating layer of the magnetic recording media of Examples 1 to 32 and Comparative Examples 1 to 10 obtained in this manner was measured using FT-1R (product name: Nicolet iS50, commercially available from Thermo Fisher Scientific). The results are shown in Table 5 and Table 6.

Next, the magnetic recording media of Examples 1 to 32 and Comparative Examples 1 to 10 were subjected to the following flying stability test and chemical resistance test.

### (Flying Stability Test)

The following glide test and credence measurement were performed, and the flying stability was evaluated based on the following evaluation criteria. The results are shown in Table 5 or Table 6.

### “Glide Test”

In the glide test, it was inspected whether there was any projection on the surface of the magnetic recording medium. That is, when a magnetic head was used to record and reproduce a magnetic recording medium, if there was a protrusion on the surface of the magnetic recording medium that had a height equal to or higher than the raised amount (the distance between the magnetic recording medium and the magnetic head), the magnetic head would sometimes collide with the protrusion, damaging the magnetic head, and causing defects in the magnetic recording medium. In the glide test, 50 magnetic recording media were inspected whether there was a protrusion with a height equal to or higher than the raised amount of the surface.

Specifically, when the distance between the inspection magnetic head and the magnetic recording medium was set to 0.25 microinches, the inspection magnetic head was moved over the magnetic recording medium, and a signal caused by a collision with the projection on the surface of the magnetic recording medium was output from the inspection magnetic head, the magnetic recording medium was determined to be defective, and otherwise was determined to be acceptable. Then, evaluation was performed using the number of magnetic recording media determined to be acceptable among the 50 magnetic recording media.

### “Creedence Measurement”

When the glide test was performed, noise temporarily increased, and a signal caused by a collision with a projection on the surface was sometimes detected or sometimes not even at the same location on the magnetic recording medium among a plurality of measurements. This phenomenon is called creedence. The creedence was not detected as a projection in the glide test and was not used to determine whether the glide test was successful. However, a temporary increase in noise during the glide test generally indicates non-uniformity in the lubricant layer or the presence of relatively soft foreign matter. Therefore, the glide test was performed on the magnetic recording media, and the credence average value was calculated by dividing the total number of detected creedences by the number of magnetic recording media (50) on which the glide test was performed and used as an index indicating the smoothness and cleanliness of the lubricant layer.

### “Evaluation Criteria”

A: the number of media determined to be acceptable in the glide test was 45 or more and the creedence average value was less than 0.5
B: the number of media determined to be acceptable in the glide test was 45 or more and the creedence average value was 0.5 or more and less than 1.0
C: the number of media determined to be acceptable in the glide test was 45 or more and the creedence average value was 1.0 or more and less than 5.0
D: the number of media determined to be acceptable in the glide test was less than 45 or the creedence average value was 5.0 or more
E: the number of media determined to be acceptable in the glide test was less than 45 and the creedence average value was 5.0 or more

### [Chemical Resistance Test]

The contamination of the magnetic recording medium due to environmental substances that generated contamination substances under a high temperature environment was examined by the following method. Si ions were used as the environmental substance, and an amount of Si adsorbed was measured as the amount of the contamination substance that contaminated the magnetic recording medium generated from the environmental substance.

Specifically, the magnetic recording medium to be evaluated was held under a high temperature environment with a temperature of 85° C., and a humidity of 0% in the presence of siloxane-based Si rubber for 240 hours. Next, the amount of Si adsorbed present on the surface of the magnetic recording medium was analyzed and measured using secondary ion mass spectrometry (SIMS), and the degree of contamination with Si ions was evaluated as the amount of Si adsorbed. The amount of Si adsorbed was evaluated using a numerical value when the result of Comparative Example 1 was set as 1.00 based on the following evaluation criteria. The results are shown in Table 5 and Table 6.

### “Evaluation Criteria”

A: the amount of Si adsorbed was less than 0.60
B: the amount of Si adsorbed was 0.60 or more and less than 0.75
C: the amount of Si adsorbed was 0.75 or more and less than 0.90
D: the amount of Si adsorbed was 0.90 or more and less than I00
E: the amount of Si adsorbed was 1.00 or more

As shown in Table 5, the magnetic recording media of Examples 1 to 32 were all evaluated as A or B in the flying stability test and the chemical resistance test. Accordingly, it was confirmed that the magnetic recording media of Examples 1 to 32 had favorable magnetic head flying stability and the magnetic recording media had high chemical substance resistance.

This was speculated to be because the compounds represented by (1A) to (1O), (2A) to (2O), (3A), and (3B) forming the lubricating layer of the magnetic recording media of Examples 1 to 32 were less likely to generate polar groups that were not bonded to functional groups (active sites) present on the protective layer. In other words, it was speculated to be because the polar groups in R¹ and R⁴ and the primary hydroxy group in R³ contained in the compounds represented by (1A) to (1O), (2A) to (2O), (3A), and (3B) adhered to the protective layer with a high probability. As a result, it was speculated that the adhesion of the lubricating layer to the protective layer was favorable, entrainment of contamination substances caused by polar groups that were not adhered to the protective layer contained in the lubricating layer was restricted, excellent chemical substance resistance was obtained, and favorable magnetic head flying stability was obtained.

In addition, the magnetic recording media of Examples 2 to 4, 7 to 9, 12, 13, 15, 17 to 19, 22 to 24, 27, and 30 to 32 were evaluated as A in the flying stability test, and had particularly favorable magnetic head flying stability. This was speculated to be because the magnetic recording media of the above examples had a lubricating layer formed using a compound in which R¹ and R⁴ were represented by Formulae (4-1) to (4-3), and X was a polar group, and thus the adhesion of the lubricating layer to the protective layer was favorable, and the lubricating layer was less likely to rise from the protective layer.

In addition, the magnetic recording media of Examples 10, 11, 25, and 26 were formed using a compound in which R¹ and R⁴ were Formula (4-1) or (4-2), and in both cases, X was an alkenyl group. Therefore, it was speculated that, in the magnetic recording media of Examples 10, 11, 25, and 26, due to the π-π interaction between the alkenyl group in the compound forming the lubricating layer and the protective layer, the adhesion to the protective layer was favorable, and the magnetic head flying stability result was favorable.

In addition, the magnetic recording media of Examples 1, 2, 7, 9, 13, 16, 17, 22, 24, 28, and 32 were evaluated a, A in the chemical resistance test, which was good. On the other hand, as shown in Table 6, in the magnetic recording media of Comparative Examples 1 to 10, at least one of flying stability test evaluation and chemical resistance test evaluation was C to E, which were inferior to those of Examples 1 to 32.

The magnetic recording medium of Comparative Example 1 was evaluated as C in the flying stability test and evaluated as D in the chemical resistance test. The magnetic recording medium of Comparative Example 1 had a lubricating layer formed using the compound (4A). The compound (4A) had the same x. R¹ and R⁴ in Formula (1) as the compounds (1B), (3A), and (3B) used in the lubricating layer of Examples 2, 31, and 32. However, unlike the compounds (1B), (3A), and (3B), the compound (4A) contained a secondary hydroxy group in the linking group corresponding to R. Therefore, it was speculated that, in Comparative Example 1, the secondary hydroxy group in the linking group corresponding to R³ in Formula (1) was not bonded to the protective layer, PFPE chains corresponding to R² arranged on both sides of R³ rose from the protective layer, and flying stability deteriorated. In addition, it was speculated that, in Comparative Example 1, chemical substance resistance deteriorated due to contamination substances adhered to the secondary hydroxy group in the linking group corresponding to R³ in Formula (1) risen from the protective layer.

The magnetic recording media of Comparative Examples 2 and 6 had a lubricating layer formed using the compounds (4B) and (4F. Like the compound (4 Å), the compounds (4B) and (4F) contained a secondary hydroxy group in the linking group corresponding to 1W in Formula (l). Therefore, it was speculated that, like Comparative Example 1, in Comparative Examples 2 and 6, a secondary hydroxy group in the linking group corresponding to R³ in Formula (1) was not bonded to the protective layer, and the flying stability and chemical substance resistance deteriorated.

The magnetic recording medium of Comparative Example 5 had a lubricating layer formed using the compound (4E). The compound (4E) contained one primary hydroxy group and two secondary hydroxy groups in the linking group corresponding to R¹ in Formula (l). Therefore, it was speculated that, in Comparative Example 5, a secondary hydroxy group in the linking group corresponding to R³ in Formula (1) was not bonded to the protective layer, and the flying stability and chemical substance resistance deteriorated.

The magnetic recording medium of Comparative Example 3 had a lubricating layer formed using the compound (4C). In the compound (4C), two hydroxy groups contained in the linking group corresponding to R³ in Formula (1) were bonded to adjacent carbon atoms. Therefore, one of the two hydroxy groups in the linking group corresponding to R³ was less likely to adhere to the protective layer. As a result, it was speculated that the magnetic head flying stability result was poor, contamination substances caused by the hydroxy groups that were not adhered to the protective layer were entrained, and the chemical substance resistance result was poor.

The magnetic recording medium of Comparative Example 4 had a lubricating layer formed using the compound (4)). In the compound (4D), the linking group corresponding to R³ had a main chain moiety that forms the chain structure of the fluorine-containing ether compound and a side chain moiety branching from the main chain moiety and having a primary hydroxy group arranged at the tip. However, in the compound (4I), in the linking group corresponding to R³, an ethyl group (—CH₂CH₃) was also bonded to a carbon atom in the main chain moiety to which a side chain moiety having a primary hydroxy group arranged at the tip was bonded. Therefore, it was speculated that the bond between the primary hydroxy group of the side chain moiety and the protective layer was inhibited by steric hindrance of the carbon atom in the main chain moiety to which an ethyl group was bonded, and the flying stability test was evaluated as D. Furthermore, the compound (4D) had two secondary hydroxy groups in the linking group corresponding to R³. Therefore, it was speculated that two secondary hydroxy groups in the linking group corresponding to R³ risen from the protective layer without bonding to the protective layer, the chemical substance resistance and flying stability deteriorated.

The magnetic recording media of Comparative Examples 2 to 6 and 10 had a lubricating layer formed using the compounds (4B) to (4F), and (4J). All of the compounds (4B) to (4F), and (4I) had a structure in which the terminal groups corresponding to R¹ and R⁴ were the same, and hydroxy groups were bonded to adjacent carbon atoms. Since the two hydroxy groups bonded to adjacent carbon atoms had opposite orientations, one of the two hydroxy groups was less likely to adhere to the protective layer. As a result, it was speculated that hydroxy groups that were not adhered to the protective layer were easily generated, and the chemical substance resistance deteriorated.

The magnetic recording medium of Comparative Example 7 was evaluated as B in the flying stability test and evaluated as C in the chemical resistance test. The magnetic recording medium of Comparative Example 7 had a lubricating layer formed using the compound (4G). The compound (4G) had the same x, R¹ and R⁴ in Formula (1) as the compound (1A) used in the lubricating layer of Example 1. Furthermore, the compound (4G) had only one primary hydroxy group in the linking group corresponding to R³. Therefore, it was speculated that, in Comparative Example 7, due to adhesion to the protective layer, a lubricating layer that could maintain a state in which it did not rise from the protective layer was formed, and favorable flying stability was obtained.

In addition, in the compound (4G), the linking group corresponding to R³ had a main chain moiety that formed the chain structure of the fluorine-containing ether compound and a side chain moiety branching from the main chain moiety and composed of —CH₂CH₂OH with a primary hydroxy group arranged at the tip. However, in the linking group corresponding to R³ of the compound (4G), a side chain moiety composed of —CH₂CH₂OH was directly bonded to a carbon atom in the main chain moiety. Therefore, the flexibility of the side chain moiety was insufficient, and —CH₂CH₂OH was less likely to be adhered to the protective layer. As a result, it was speculated that hydroxy groups that were not adhered to the protective layer were easily generated, contamination substances caused by the hydroxy groups that were not adhered to the protective layer were entrained, and the chemical substance resistance result was poor.

The magnetic recording medium of Comparative Example 8 was evaluated as C in the flying stability test and evaluated as C in the chemical resistance test. The magnetic recording medium of Comparative Example 8 had a lubricating layer formed using the compound (4H). The compound (4H) had the same x. R¹ and R⁴ in Formula (1) as the compound (2A) used in the lubricating layer of Example 16. However, unlike the compound (2A), the compound (4H) contained a secondary hydroxy group in the linking group corresponding to R³. Therefore, it was speculated that, in Comparative Example 8, a secondary hydroxy group in the linking group corresponding to R¹ in Formula (1) was not bonded to the protective layer. PFPE chains corresponding to R¹ arranged on both sides of R¹ risen from the protective layer, and the flying stability deteriorated. In addition, it was speculated that, in Comparative Example 8, contamination substances adhered to a secondary hydroxy group in the linking group corresponding to R¹ in Formula (1) that had risen from the protective layer and thus the chemical substance resistance deteriorated.

The magnetic recording media of Comparative Examples 9 and 10 had a lubricating layer formed using the compounds (4I) and (4I). Like the compound (4H), the compounds (4I) and (4J) contained a secondary hydroxy group in the linking group corresponding to R¹. Therefore, it was speculated that, in Comparative Examples 9 and 10, like Comparative Example 8, a secondary hydroxy group in the linking group corresponding to R³ in Formula (1) was not bonded to the protective layer, and the flying stability and chemical substance resistance deteriorated.

In the compound (4I) forming the lubricating layer of Comparative Example 9, one terminal was composed of one hydroxy group bonded to a perfluoropolyether chain via a methylene group (—CH₂—), Therefore, it was speculated that, in the magnetic recording medium of Comparative Example 9, the adhesion of the entire lubricating layer to the protective layer was insufficient, and the flying stability test and chemical resistance test were both evaluated as E.

### INDUSTRIAL APPLICABILITY

When the lubricant for magnetic recording medium containing the fluorine-containing ether compound of the present invention is used, it is possible to form a lubricating layer having excellent chemical substance resistance and favorable magnetic head flying stability even if the thickness is thin.

### REFERENCE SIGNS LIST

10 . . . Magnetic recording medium, 11 . . . Substrate, 12 . . . Adhesive layer, 13 . . . Soft magnetic layer, 14 . . . First base layer, 15 . . . Second base layer, 16 . . . Magnetic layer, 17 . . . Protective layer, 18 . . . Lubricating layer

1. A fluorine-containing ether compound represented by the following Formula (1): 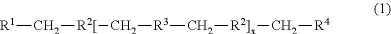
(in Formula (1), R¹ and R⁴ are each independently a terminal group containing two or three polar groups, wherein the polar groups are bonded to different carbon atoms, and carbon atoms to which the polar groups are bonded are bonded via a linking group containing carbon atoms to which no polar group is bonded; x represents an integer of 1 to 2; R² is a perfluoropolyether chain; some or all of two or three R²'s may be the same as or different from each other; R³ is a divalent linking group represented by the following Formula (3-1) or (3-2); and when x is 2, two R³'s may be the same as or different from each other). 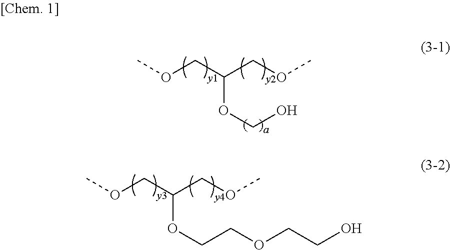
(in Formula (3-1), a represents an integer of 2 to 4; y1 represents an integer of 1 to 3; y2 represents an integer of 1 to 3; at least one of y1 and y2 is 1; and a dotted line bonded to the oxygen atom on the left side indicates a bond that is bonded to the methylene group on the side of R¹, and a dotted line bonded to the oxygen atom on the right side indicates a bond that is bonded to a methylene group on the side of R⁴)
(in Formula (3-2), y3 represents an integer of 1 to 3; y4 represents an integer of 1 to 3; at least one of y3 and y4 is 1; and a dotted line bonded to the oxygen atom on the left side indicates a bond that is bonded to the methylene group on the side of R¹, and a dotted line bonded to the oxygen atom on the right side indicates a bond that is bonded to a methylene group on the side of R⁴).

2. The fluorine-containing ether compound according to claim 1,
wherein, in Formula (1), —R¹ and —R⁴ are each independently any one represented by the following Formulae (4-1) to (4-3): 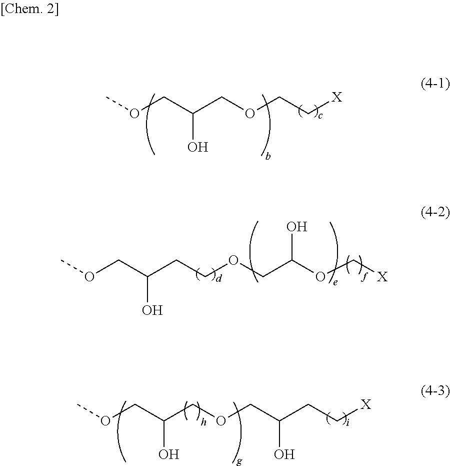
(in Formula (4-1), b is an integer of 1 to 2, and c is an integer of 0 to 3; in Formula (4-1), X is an alkenyl group, an alkynyl group, or a polar group; when b is 1, X is a polar group; and when X is an alkenyl group or an alkynyl group, a carbon atom constituting an unsaturated bond in X is bonded to a methylene group adjacent to X)
(in Formula (4-2), d is an integer of 1 to 3, e is an integer of 0 to 1, and f is an integer of 0 to 3; in Formula (4-2), X is an alkenyl group, an alkynyl group, or a polar group; when e is 0, X is a polar group; and when X is an alkenyl group or an alkynyl group, a carbon atom constituting an unsaturated bond in X is bonded to a methylene group adjacent to X)
(in Formula (4-3), g is an integer of 0 to 1, h is an integer of 1 to 3, and i is an integer of 1 to 3; in Formula (4-3), X is an alkenyl group, an alkynyl group, or a polar group; when g is 0, X is a polar group; and when X is an alkenyl group or an alkynyl group, a carbon atom constituting an unsaturated bond in X is bonded to a methylene group adjacent to X).

3. The fluorine-containing ether compound according to claim 2,
wherein, in Formulae (4-1) to (4-3), X is any of a hydroxy group, a group having an amide bond, a cyano group, and —CH═CH₂.

4. The fluorine-containing ether compound according to claim 1,
wherein, in Formula (1), x is 1, R¹ and R⁴ are the same, and two R²'s are the same.

5. The fluorine-containing ether compound according to claim 1,
wherein, in Formula (1), x is 2, R¹ and R⁴ are the same, three R²'s are the same.

6. The fluorine-containing ether compound according to claim 5,
wherein atoms contained in two R³'s in Formula (1) are arranged symmetrically with respect to R² arranged in the center of a chain structure of a molecule.

7. The fluorine-containing ether compound according to claim 1,
wherein two or three R²'s in Formula (1) are each independently a perfluoropolyether chain represented by the following Formula (5): 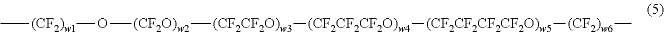
(in Formula (5), w2, w3, w4, and w5 indicate an average degree of polymerization and each independently represent 0 to 20; provided that all of w2, w3, w4, and w5 are not 0 at the same time; w1 and w6 are an average value representing the number of CF₂'s and each independently represent 1 to 3; and the arrangement order of repeating units (CF₂O), (CF₂CF₂O), (CF₂CF₂CF₂O), and (CF₂CF₂CF₂CF₂O) in Formula (5) is not particularly limited).

8. The fluorine-containing ether compound according to claim 1,
wherein two or three R²'s in Formula (1) are each independently any one selected from among perfluoropolyether chains represented by the following Formulae (6-1) to (6-4): 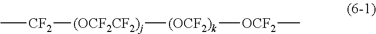
(in Formula (6-1), j and k indicate an average degree of polymerization, j represents 0.1 to 20, and k represents 0 to 20) 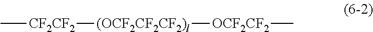
(in Formula (6-2), 1 indicates an average degree of polymerization and represents 0.1 to 15) 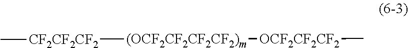
(in Formula (6-3), m indicates an average degree of polymerization and represents 0.1 to 10) 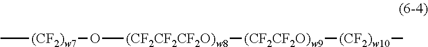
(in Formula (6-4), w8 and w9 indicate an average degree of polymerization and each independently represent 0.1 to 20; and w7 and w10 are an average value representing the number of CF₂'s and each independently represent 1 to 2).

9. The fluorine-containing ether compound according to claim 1, wherein the number-average molecular weight is in a range of 500 to 10,000.

10. A lubricant for magnetic recording medium comprising the fluorine-containing ether compound according to claim 1.

11. A magnetic recording medium in which at least a magnetic layer, a protective layer, and a lubricating layer are sequentially provided on a substrate,
wherein the lubricating layer contains the fluorine-containing ether compound according to claim 1.

12. The magnetic recording medium according to claim 11,
wherein the average film thickness of the lubricating layer is 0.5 nm to 2.0 nm.
